(19) United States
(12) Patent Application Publication
(10) Pub. No.: US 2025/0245803 A1
(43) Pub. Date: Jul. 31, 2025

(54) COMPUTER-AUTOMATED DETERMINATIONS OF PALLET STRUCTURAL INTEGRITY AND CATCH WEIGHT

(71) Applicant: Lineage Logistics, LLC, Irvine, CA (US)

(72) Inventors: Brian D. Leahy, Chicago, IL (US); Caitlin Voegele, San Francisco, CA (US); Haig Avis Atikian, Boston, MA (US); Daniel Thomas Wintz, San Francisco, CA (US); Jose Luis Castañeda Rios, Medllín (CO); Adam Andis Haile, Duram, NC (US); Daniël Walet, Oakland, CA (US); Jillian Schnitzler, Belmont, NC (US); Christopher Scott Huddleston, Smithfield, VA (US); Elliott Gerard Wolf, Oakland, CA (US)

(21) Appl. No.: 18/427,109

(22) Filed: Jan. 30, 2024

(51) Int. Cl. G06T 7/00; B65G 43/08; G06Q 10/08; G06T 7/60; G06V 10/10; G06V 10/774; G06V 10/94; G06V 20/50; G06V 20/70

(52) U.S. Cl. CPC G06T 7/0004; B65G 43/08; G06Q 10/08; G06T 7/60; G06V 10/16; G06V 10/774; G06V 10/95; G06V 20/50; G06V 20/70; B65G 2203/0216; B65G 2203/041; G06T 2207/20081; G06T 2207/20212; G06T 2207/30108; G06T 2207/30242

(57) ABSTRACT

Disclosed are systems, methods, and apparatuses for automatically and optically determining structural integrity and catch weight information for a pallet. The apparatus can include: a conveyor belt to route a pallet having cases in a facility once the pallet is ingested into the facility, a turntable to receive the pallet from the conveyor belt and rotate the pallet, at least one imaging device proximate the turntable to capture optical data of the pallet, a partial enclosure to enclose the turntable, the at least one imaging device, and at least a portion of the conveyor belt, and an edge computing device in network communication with the at least one imaging device. The edge computing device can: receive the optical data from the at least one imaging device, process the optical data to determine structural integrity and catch weight information for the pallet, and determine routing or storage information for the pallet.

### TECHNICAL FIELD

This document describes systems, methods, techniques, and algorithms for computer-automated profiling of objects, such as determining structural integrity and catch weight of pallets of items, as they are ingested into a warehouse environment or other storage facility.

### BACKGROUND

A warehouse or similar storage facility can receive thousands of items a day for storage. Such items can include pallets, crates, bins, or other objects that can be stored in the warehouse. Items entering the warehouse may have unique information that can impact where the items are stored, for how long the items are stored, etc. The items can also have unique identification information that can be used throughout a supply chain. Such information can include information about item type, item storage conditions, item weight, pallet structure, etc.

Items can be stored in the warehouse for short or temporary periods of time. Items can also be stored in the warehouse for longer periods of time. Items can be stored in different warehouse locations depending on characteristics of the items. For example, a storage location can be chosen for an item based on the storage location being able to accommodate a height, weight, and/or size of the item. As another example, a storage location can be designated for all items of a particular customer. As yet another example, a storage location can be chosen for an item that has a temperature storage requirement (e.g., the item needs to be in cold storage).

Storage and other item characteristics can be identified for each item in a variety of ways. For example, the storage characteristics can be received from a previous supply chain user, such as a vendor who delivers the storage items to the warehouse for storage. Sometimes, this information can include human-made errors. Sometimes, this information can be inaccurate once the items arrive at the warehouse, since unexpected events can occur while the items are in transit. A pallet, for example, can arrive at the warehouse damaged, leaning, and/or missing containers or other contents. Information about the pallet that was determined by a vendor before shipment to the warehouse can therefore be inaccurate. The inaccurate information can be used to find a storage location that is less efficient or optimal. Moreover, reliance on the inaccurate information can result in damage going unseen, which can negatively impact the supply chain and customer satisfaction. Changes to the item during shipment or delivery (e.g., dents, a broken pallet, a missing box, etc.) may not be accounted for once the item is in the warehouse and ready to be moved to a storage location. The item may or may not be inspected again once entering the warehouse.

As another example, storage or other item characteristics can be determined by a warehouse worker. The warehouse worker can inspect an item as it enters the warehouse and manually input information about the item into a computing system, such as a warehouse management system. The warehouse worker can also use a handheld scanner, camera(s), or similar device to inspect the item and gather information about the item's storage characteristics. Human inspection can cause a delay in warehouse efficiency and in moving incoming items for storage. The warehouse worker may err in inspecting and/or recording information about the item. Some characteristics may not be readily noticeable to the human eye. The warehouse worker can also be working quickly to be able to inspect a queue of items, so the warehouse worker may not see or record item and storage characteristics. Moreover, the warehouse worker can enter incorrect values into the computing system if rushing to inspect all the items in the queue within a given time period.

Item characteristics can also be identified by cameras or other scanning devices that are positioned throughout the warehouse. For example, as an item moves in the warehouse, cameras can capture images of the item and send those images to a computing system for processing. The cameras may not capture clear images of the item and/or may not capture all sides/angles of the item. The computing system may not be able to adequately identify storage and other item characteristics for that item, which can result in warehouse inefficiencies.

### SUMMARY

This document generally describes systems, methods, apparatus, devices, and techniques for automatically determining structural integrity and/or catch weight of objects as they enter a storage facility, such as a warehouse. The objects can be, for example, pallets having cases of items stacked thereon. The disclosed technology can include a combination of warehouse components and scanning devices configured to capture image data of a pallet from multiple angles when the pallet enters the facility. The captured image data can be processed by a computing system, such as an onsite edge processing device at a pallet profiling station where the pallet enters the facility, to determine structural integrity and/or catch weight information about the pallet and the cases contained thereon. The disclosed technology may also be used to automatically determine other information about the pallet and its items/cases, which can also be used to determine pallet routing instructions and determinations and/or pallet storage instructions in the facility.

More particularly, the image data can be processed on the edge using machine learning, object detection, optical character recognition, and other image processing techniques to determine the information about the pallet and the cases contained on the pallet. The determined information can include catch weight of one or more cases on the pallet, identification of gaps (e.g., chimney stacks) between one or more cases on the pallet, and/or detection of damage to one or more cases on the pallet. Other information can also be determined. If such information can be determined with a sufficient amount of clarity and/or confidence for a threshold quantity of the cases on the pallet, then the pallet can be identified as successfully profiled (e.g., processed upon entering the facility) for purposes of routing the pallet to storage in the facility.

Determinations about structural integrity and/or catch weight can be performed on the edge when the pallet is imaged upon arrival to the facility so that a determination can be quickly and efficiently made about whether the pallet should be routed into long-term storage in the warehouse or another type of storage location. Additional processing of the pallet image data can be performed at another time and/or remote from where the pallet is initially imaged upon arrival to determine additional information about the pallet and the cases stacked thereon. If, on the edge, information is determined for less than the threshold quantity of cases on the pallet (or the information determined for cases on the pallet is not of sufficient clarity and/or confidence), then one or more of the cases may be flagged for manual review (e.g., checking) by a human operator in the warehouse. The pallet can then be routed to a human-checking station. The human operator may review only those cases that have been flagged, rather than having to review all cases on the pallet, which can reduce an amount of time, labor, and other resources that may otherwise be consumed to check and fix the pallet before routing to storage in the facility.

In the facility, an inbound pallet can be imaged at a processing station that can include on and off conveyor belts, a rotating turntable, and a vertical pole having one or more stationary cameras. The vertical pole can be positioned a threshold distance away from the rotating turntable so as to permit a sufficient field of view for each camera to capture images of the pallet (e.g., image capturing entire width of pallet). The vertical pole can remain stationary, such that the one or more cameras configured thereto capture images of the pallet from a same distance, angle, and field of view (FOV). A photo booth or similar light-neutralizing structure can be positioned around the rotating turntable to provide consistent and uniform lighting for capturing images of pallets regardless of the lighting conditions in the ambient environment (e.g., dock area in warehouse). One or more lights (e.g., red lights, strobe lights) can be positioned inside the photo booth and/or to the vertical pole to illuminate the rotating turntable and pallet thereon, and particular lighting configurations (e.g., wavelength of emitted light from light source, polarized filter, strobe duration, light intensity) and/or camera configurations (e.g., shutter speed, polarized lens filter) can be used to achieve consistent and reliable images in spite of highly variable pallet conditions (e.g., frost, layers of transparent and semi-transparent plastic wrap). For example, the lighting can be offset and angled from the vantage point of the cameras (e.g., approximately 45 degree offset) to reduce glare in captured images. The photo booth and lighting can provide for brighter, clearer images of the pallet to be captured by the cameras.

One or more computing systems, such as an onsite edge processing device or system, can control operation of components of the disclosed technology that are used to image and process the pallet (e.g., the cameras, the turntable, the on and off conveyor belts, the lights, etc.). The pallet can be loaded onto the on conveyor belt (e.g., upon first entering the warehouse). The pallet can be automatically aligned as it moves down the on conveyor belt, and then automatically moved onto the turntable. The one or more computing systems can control the turntable to center the pallet thereon, which can permit images of the pallet to be captured from a same/similar distance from around the pallet as the pallet is rotated on the turntable. The turntable can rotate at a predetermined speed, and can include pauses at various angles of rotation (e.g., pause ever 15, 30, 45, 60, or 90 degree rotation) to capture images of the pallet at those orientations relative to the cameras. Alternatively and/or additionally, the pallet may be continuously rotated and images can be captured at various orientations, without pausing the turntable's rotation. The one or more computing systems can receive image data from the cameras and, using image analysis techniques and/or machine learning models, identify information about the pallet and the cases positioned thereon, as described herein. For example, the one or more computing systems can identify and determine a structural integrity of the pallet. The one or more computing systems can identify and determine catch weights of cases on the pallet, including those cases that are visible and not visible upon visual inspection of the pallet. The one or more computing systems can also identify and determine other information about the pallet, including but not limited to one or more labels, other unique identifiers, or encoded information associated with the pallet and/or its cases. The one or more computing systems can determine the dimensions of the pallet (e.g., height, width, depth), types of items on pallet, quantities of those items, information on those specific items (e.g., date, origin, expiration), catch weights of the cases on the pallet, lean and/or chimney stacks (e.g., structural integrity) of the pallet, case count, and other details about the pallet.

The one or more computing systems can use the determined pallet information to direct subsequent treatment of the pallet, such as for inbound pallets into a warehouse to identify a specific storage location in the warehouse for the pallet. A specific storage location that is identified and used for long-term storage of the pallet can depend on various information determined about the pallet using the disclosed techniques. In instances where some or all of those details may not be able to be discerned by the computer system with at least a threshold confidence level, the one or more computing systems can direct the pallet to a temporary storage location within a warehouse pending manual profiling of the pallet, which can be performed by a remote user via the images and other information captured of the pallet. For example, for pallets that are not able to be automatically identified, such as in the instance where there are significant visual impediments to identifying the contents of the pallet (e.g., frost, several layers of plastic wrap), the pallets can be directed to temporary storage and can be added to a queue for manual review. Similarly, if encoded information associated with one or more cases on the pallet are not discernible with sufficient confidence/clarity, those cases can be flagged for manual review. A manual reviewer can use a computing device to review the images and other details captured of the pallet, and can identify the pallet and its contents, which the one or more computing systems can then use to redirect the pallet into a specific, organized storage location, such as a long-term storage area. The manual reviewer can also perform a manual review of the flagged cases to identify information about the cases that otherwise may not be discernible from the image data or by the one or more computing systems.

The image data, or at least a portion of the image data, associated with the pallet can be stored for additional processing remote from a location of imaging the pallet. The image data, or at least some of the image data, can be processed in real-time to perform some operations in the warehouse, such as routing the pallet to a long-term storage location or routing the pallet to a manual reviewing station. Pallet information identified by the computing system using the disclosed techniques can be compared to pallet information that was manually inputted into a warehouse management system (WMS) and/or warehouse control system (WCS) by a warehouse worker or otherwise stored by the WMS/WCS or retrieved from another computing system (such as a manifest of pallet information from a relevant stakeholder who sent the pallet to the warehouse. Comparing the pallet information can be advantageous to determine an accuracy of the information identified by the computing system and/or to confirm that the correct pallet was received at the warehouse.

One or more embodiments described herein can include an apparatus for automatically and optically determining structural integrity and catch weight information for a pallet in a facility, the apparatus including: a conveyor belt that can be configured to route a pallet having a group of cases in a facility once the pallet is ingested into the facility, a turntable that can be configured to receive the pallet from the conveyor belt and to rotate the pallet, at least one imaging device positioned proximate the turntable and that can be configured to capture optical data of the pallet as the turntable rotates the pallet, a partial enclosure that can be configured to enclose the turntable, the at least one imaging device, and at least a portion of the conveyor belt, and an edge computing device in network communication with the at least one imaging device. The edge computing device can be configured to: receive the optical data from the at least one imaging device, process the optical data to determine structural integrity information for the pallet, process the optical data to determine catch weight information for each of the group of cases on the pallet, and determine, based on the structural integrity information and the catch weight information, routing or storage information for the pallet.

The embodiments described herein can optionally include one or more of the following features. For example, the apparatus can also include a vertical structure in a stationary position proximate to a side of the turntable. The vertical structure can be laterally spaced apart from the conveyor belt and the turntable such that the vertical structure may not hang over any of the conveyor belt and the turntable, and the at least one imaging device can be configurably mounted to the vertical structure. The vertical structure can also be a pole. The vertical profiling structure can be positioned a working distance between 1.7 meters and 1.9 meters from the turntable. The vertical structure may include at least one light source that can be vertically aligned with and offset from the at least one imaging device.

In some implementations, the at least one imaging device can include a group of cameras mounted to the vertical structure at a group of different locations, where the optical data captured by the plurality of cameras may include image data that can provide multiple different views of the pallet from a group of different vantage points provided by the group of cameras being mounted to the vertical structure at the group of different locations. The group of cameras can be arranged along a same vertical plane along the vertical structure with each camera having a substantially horizontal angle. As another example, the partial enclosure can include (i) sides and a top that may prevent ambient light from entering the partial enclosure and (ii) a light source to cast light on the pallet as the pallet rotates on the turntable.

Sometimes, processing the optical data to determine structural integrity information for the pallet can include: selecting an image from the optical data that represents a top-down view of the pallet, processing the selected image to identify each case at the top of the pallet, performing a gap detection process between one or more of the identified cases to identify at least one gap, the gap detection process including applying a model to the selected image of the top of the pallet, the model having been trained to identify gaps between cases, determining whether the at least one gap exceeds one or more threshold size criteria, and responsive to determining that the at least one gap exceeds the one or more threshold size criteria, generating and returning instructions to cause an automation computing system to automatically route the pallet to a profile checking station in the facility using the conveyor belt. Processing can further include, responsive to determining that the at least one gap does not exceed the one or more threshold size criteria, generating and returning instructions to cause the automation computing system to automatically route the pallet to a predetermined storage location for the pallet in the facility using the conveyor belt.

In some implementations, processing the optical data to determine catch weight information for each of the plurality of cases on the pallet can include: processing the optical data to identify, for each case on the pallet, encoded case information, determining a count indicating a number of cases on the pallet, determining whether the encoded case information, for each case, is identifiable with sufficient certainty, and responsive to determining that the encoded case information is identifiable with sufficient certainty, determining a catch weight for each case based on the encoded case information. Sometimes, the processing can also include determining a quantity of the plurality of cases having determined catch weight information and a quantity of the plurality of cases having undetermined catch weight information, determining whether the quantity of the plurality of cases having determined catch weight information satisfies a threshold quantity of cases on the pallet, and generating and returning the routing information, based on a determination that the quantity of the plurality of cases having determined catch weight information satisfies the threshold quantity, to an automated computing system that can automatically control the conveyor belt to route the pallet to a predetermined storage location in the facility. Sometimes, processing can also include, responsive to determining that the encoded case information is not identifiable with sufficient certainty, flagging at least one case for manual checking and indicating a location of the flagged at least one case on the pallet, and generating and returning a notification to check the flagged at least one case at the indicated location on the pallet to an automation computing system that can be configured to control the conveyor belt to automatically route the pallet to a pallet checking station in the facility.

In some implementations, processing the optical data to determine structural integrity information for the pallet or catch weight information for the pallet can include: detecting a label on the pallet, identifying the pallet based at least in part on processing the identified label, and determining whether a physical structure of the pallet satisfies one or more safety criteria to move the pallet in the facility using the conveyor belt. Sometimes, the edge computing device can also be configured to: locally maintain a first portion of the optical data and results from processing the optical data, and transmit, to a remote computing system in network communication with the edge computing device, a second portion of the optical data and the results, where the remote computing system can be configured to process the second portion of the optical data and the results to perform pallet profiling operations while the pallet is routed, on the conveyor belt, to one or more locations in the facility.

In some implementations, the edge computing device may also: apply a model to the optical data of the pallet to identify at least one damaged case on the pallet, determine whether the identified at least one damaged case satisfies one or more threshold damage criteria, and responsive to determining that the identified at least one damaged case satisfies the one or more threshold damage criteria, generate and return instructions to an automation computing system to control the conveyor belt to automatically route the pallet to a profile checking station in the facility. The edge computing device may also, responsive to determining that the identified at least one damaged case does not satisfy the one or more threshold damage criteria, generate and return instructions to the automation computing system to control the conveyor belt to automatically route the pallet to a predetermined long-term storage location in the facility. Sometimes, the model was trained by a remote computing system using a process that may include: receiving sets of image data of pallets taken from different viewpoints, annotating a subset of the sets of image data with labels indicating damaged cases on the pallets, training the model to identify instances of the damaged cases on the pallets in the sets of image data from the different viewpoints using the annotated subset, and returning the model for runtime use. Sometimes, the partial enclosure may include (i) a first opening on a first side of the partial enclosure through which the pallet can be received from the conveyor belt onto the turntable and (ii) a second opening on a second side of the partial enclosure opposite the first side through which the pallet can be moved from the turntable to another conveyor belt that can be configured to automatically route the pallet to one or more locations in the facility. Sometimes, the optical data can include image data of sides, top, and bottom surfaces of the pallet. The edge computing device can further be configured to: apply one or more machine learning trained models to the image data to stitch together the image data of the sides, the top, and the bottom surfaces of the pallet, and determine, based on processing the stitched-together image data of the pallet, at least one of: a height of the pallet, damage to the pallet, lean of the pallet, contents of the pallet, number of rows on the pallet, and quantity of items on the pallet.

In some implementations, the system can also include an API system in network communication with the edge computing device, the API system being configured to perform operations that can include: continuously receiving, from the edge computing device, the optical data, providing the continuously received data to a backend cloud processing system, which can be configured to execute one or more algorithms using the continuously received data to generate pallet information for the pallet, and writing the generated pallet information to one or more of a warehouse management system and a pallet review system. The warehouse management system can be configured to (i) update a data record in a data store for the pallet with the generated pallet information and (ii) provide pallet handling instructions, based on the generated pallet information, to an automated warehouse system or a manual warehouse operation system. The pallet review system can be configured to, based on the generated pallet information, generate and provide instructions to a user at a user device to review the optical data and determine whether the pallet can be routed to a storage location in the facility. The operations performed by the API system can also include reconciling the structural integrity information, the catch weight information, and the generated pallet information using one or more heuristics to identify pallet identification information, writing the pallet identification information to a cache data store, and providing the pallet identification information from the cache data store to the edge computing device, the edge computing device being configured to determine the routing or storage information for the pallet based on at least the pallet identification information from the cache data store. The API system can be configured to reconcile results generated by the edge computing device and the generated pallet information during each of a group of phases, in which a next phase amongst the group of phases can be executed in response to the API system reconciling the results and the generated pallet information. The API system can further be configured to determine that a current phase amongst the group of phases may be complete based on a determination that a sufficient quantity of information for the pallet has been identified by the edge computing device or the backend cloud processing system to perform an action with the pallet in the facility. The action may include generating, printing, and applying a label to the pallet after the pallet is imaged while on the turntable in the partial enclosure and before the pallet can be routed out of the partial enclosure by the conveyor belt.

In some implementations, the API system can further be configured to, during a pallet data collection process: receive the optical data, the structural integrity information, and the catch weight information from at least the edge computing device, identify pallet identification information for the pallet based on selecting results amongst the received optical data, the structural integrity information, and the catch weight information having highest corresponding confidence values, cache the pallet identification information for the pallet, and iteratively perform the receiving, the identifying, and the caching until a determination that a first milestone has been met for the pallet. In response to a determination that the first milestone has been met for the pallet, the API system can also generate and return instructions, to the edge computing device, for generating, printing, and applying a label for the pallet.

As another example, in response to a determination that the first milestone has been met for the pallet, the API system can transmit the cached pallet identification information for the pallet to the warehouse management system, and the warehouse management system can (i) receive the cached pallet identification information for the pallet, (ii) extend the received information for the pallet based on aggregating the received information for the pallet with other data associated with the pallet and stored in one or more data repositories, and (iii) create the data record for the pallet in the data store with the extended information for the pallet. The transmitting, the receiving, the extending, and the creating can be performed until a determination that a second milestone for the pallet has been met. In response to a determination that the second milestone has been met for the pallet, the API system can: determine whether the pallet is sufficiently identifiable based on information stored in the data record for the pallet, and return information indicating that the sufficient information was collected to identify the pallet. Based on a determination that the pallet may be sufficiently identifiable, the API system can generate and return a notification to the edge computing device to cause the edge computing device to determine the storage information for the pallet.

In some implementations, the optical data can include a group of images of the pallet that can be captured at predetermined deltas of degree movement of the pallet as the pallet is rotated on the turntable. Processing the optical data can include: processing each of the group of images to determine a confidence level for reading a unique identifier on the pallet, selecting an image amongst the group of images having the highest confidence level, and determining the structural integrity information and the catch weight information for the pallet based on processing the selected image. Sometimes, the processing can also include selecting the image amongst the group of images having checksums that may satisfy one or more checksum rules.

Determining structural integrity information for the inbound pallet can be used to make quick and accurate determinations about moving the pallet safely around the facility as well as efficiently storing the pallet in available storage location space(s). The disclosed technology can allow for automated, onsite, lightweight edge processing to determine the structural integrity when the pallet enters the facility. Using the disclosed technology can reduce or otherwise eliminate a need of warehouse workers to manually and visually inspect the entire pallet of cases, which can sometimes reach a height that exceeds the height of a human. Traditionally, the warehouse worker may have to stand on a ladder or use other equipment to see a top of the pallet of cases and then visually inspect the top to determine whether there are gaps between cases or other structural integrity concerns. If there are, then the worker would also have to guess whether the structural integrity concerns are big enough to instruct other workers to disassemble the pallet and reassemble the pallet into a safe structure for movement around the facility and storage therein. This can be a time-consuming process riddled with potential for human error. The disclosed technology, on the other hand, can provide for quickly and efficiently processing image data captured of all angles of the pallet when the pallet enters the facility to determine and identify the structural integrity of the pallet. Onsite edge processing can be used to determine, in seconds or less, whether the pallet is structurally sound (e.g., according to predetermined thresholds or other computer-automated rules and algorithms), and if not, then instructions to route the pallet to a temporary location where it can be disassembled and reassembled to improve its structural integrity. The disclosed technology can reduce or otherwise eliminate human error and save on labor resources as well as computer processing resources to accurately and efficiently determine pallet structural integrity information.

Similarly, onsite edge processing to determine information such as the catch weight of cases on the pallet can be used to accurately and efficiently determine information about the pallet that can also be used for safely moving the pallet around the facility and storing the pallet. Traditionally, the warehouse worker may visually inspect and/or scan each label/barcode on a case on the pallet to determine the corresponding catch weight. Sometimes, the worker may disassemble the whole pallet (or an automated device/vehicle such as a layer picker or forklift may disassemble and assemble the pallet) to identify the catch weights of every case thereon. Other times, the worker may guess the catch weight of cases that may not be visible when the pallet is assembled, which can result in human error. Inspection of the pallet to determine case catch weight information can consume significant amounts of time and manual labor and can be erroneous, which may increase safety concerns when routing the pallet in the facility and/or result in inefficient storing of the pallet. The disclosed technology, on the other hand, may remove the need for labor and time to manually inspect the pallet by optically and accurately determining the catch weight information of all the cases on the pallet on the edge and without requiring disassembly or human guesswork.

The disclosed techniques may also provide one or more of the following advantages. For example, the disclosed technology provides for efficiently determining pallet information when a pallet is first ingested into a warehouse. As a result, the pallet can be quickly routed to either a long-term storage location in the warehouse (e.g., when sufficient information can be determined about the pallet from processing image data of the pallet at time of ingestion) or a manual reviewing station in the warehouse (e.g., when one or more information about the pallet is unknown). The disclosed techniques can therefore provide for reducing or otherwise eliminating potential bottlenecks in the flow of pallets in the warehouse, thereby improving and optimizing warehouse efficiency.

Similarly, the disclosed technology provides for processing some image data of the pallet on the edge, around a time of imaging the pallet, to quickly make a determination of where to route the pallet in the storage facility. Edge processing can efficiently utilize available processing power and avoid clogging network bandwidth, thereby making decisions quicker and faster to improve and optimize warehouse efficiency as well as movement of pallets in the storage facility. Some of the image data can then be transmitted to a remote computing system for additional processing. The additional processing can be performed at a later time, such as while the pallet is being routed to a storage location and/or once the pallet is in the storage location. The additional processing may require additional processing power and thus can be deployed at the remote computing system so as to avoid clogging network bandwidth for real-time decisions to be made about routing pallets throughout the warehouse. Such efficient use of available compute resources and network bandwidth can advantageously improve decision-making processes performed in real-time or near real-time in the storage facility.

Moreover, a combination of a rotating turntable and stationary cameras attached to a vertical pole proximate to the turntable provides for continuous capturing of images from a uniform working distance when the pallet is ingested into the storage facility. Image data that is captured in uniform conditions can be more efficiently and quickly processed using the disclosed techniques to make accurate determinations and identifications of pallet information. Moreover, image data captured in uniform conditions can be more quickly and efficiently stitched together to be used in additional processing and pallet profiling techniques. Similarly, images can be captured of every side of the pallet, including a top and bottom of the pallet, thereby providing a more complete view of the pallet and its contents for profiling the pallet and making accurate real-time determinations for routing the pallet throughout the storage facility.

The captured images can provide more comprehensive profiling of the pallet, thereby eliminating or otherwise reducing the need for manual human review of the pallet and/or reducing or eliminating potential human error in reviewing the pallet and contents stacked thereon. Since images can be captured of every side of the pallet, labels, text, damage, missing contents, lean, and other characteristics can be more easily identified using image processing techniques. A human worker may oversee a portion of any side of the pallet when performing a manual inspection, thereby missing information that can be critical for profiling and storing the pallet. For example, the human worker may not be able to get under the pallet to inspect a wood frame for damage. As a result, the pallet can be improperly stored based on an assumption from the human worker that the bottom of the pallet is not damaged. This can cause inefficiencies in the storage facility as well as increased costs throughout the supply chain.

Pallet information can also be identified more accurately and efficiently with the automated disclosed technology. Manual human inspections of every pallet that enters the warehouse can be time-consuming, inefficient, and can result in error when identifying pallet characteristics. The disclosed technology can provide for automatically profiling each pallet as it enters the warehouse and identifying at least some encoded information associated with the pallet, the information being used to automatically and quickly determine whether the pallet should be routed to long-term storage and/or routed to a checking station for manual review. Additional pallet information and characteristics can be identified from the image data of the pallet at a later time (e.g., as the pallet is being routed to an organized storage location). A warehouse worker who checks a pallet may only be required to check specific cases or portions of the pallet, based on the initial analysis of the image data of the pallet, rather than having to undergo a time-consuming process of checking the entire pallet and its contents. As a result, pallet processing through the storage facility can be streamlined and performed more efficiently to optimize the storage facility.

The disclosed technology may also be less expensive to implement in a warehouse environment or other storage facility in comparison to existing profiling systems. The vertical pole described herein can include few cameras. The pole can be positioned anywhere in the warehouse and easily moved around the warehouse. The cameras may also be easily serviceable and maintained since they are in one location. Standalone cameras may not need to be purchased and positioned throughout the warehouse and/or affixed to components of the warehouse to perform the techniques described herein. Existing profiling systems can use many cameras positioned throughout the warehouse. These cameras may not adequately capture every angle and side of the pallet as the pallet moves throughout the warehouse, thereby causing inefficiencies in the warehouse and poor pallet profiling results. Moreover, setting up, maintaining, and/or fixing cameras that are positioned throughout the warehouse can be timely and costly. The disclosed technology, on the other hand, can provide for a space-efficient, centrally located profiling system, the vertical pole. Setting up the vertical pole with the cameras can be quick and efficient. Maintenance can also be performed quickly and easily. Finally, the central location of the cameras at the vertical pole can take up less floor space in the warehouse, which can optimize space efficiency in the warehouse.

As another example, the disclosed technology can provide for offsetting lights from the cameras at the vertical pole to reduce glare. As a result, clearer images can be captured. One or more red lights can also be used to eliminate wavelengths of light other than red. By eliminating those wavelengths, image analysis techniques can be more accurately performed. The clearer the images, the easier, faster, and more accurately the computing system can identify a label in the images and other pallet characteristics. Similarly, the disclosed technology can provide for using positioning a photo booth around the rotating turntable to provide uniform lighting. The photo booth can help reduce or otherwise eliminate ambient lighting, which can be advantageous to capture clearer images of the pallet with minimal to no glare. As mentioned above, the clearer the images, the more accurate and quickly the computing system can identify the label of the pallet and route the pallet for storage.

As another example, the disclosed technology can provide for maximizing throughput. Image processing and analysis can be performed at staggered time intervals. At a minimum, a determination of whether a pallet's label is identifiable can be performed and completed by or before a first time objective (e.g., in real-time or near real-time). If there is still time remaining, additional processing and analysis can be performed to identify additional information about the pallet. Otherwise, the pallet can be routed to some storage location in the warehouse as another pallet is ingested and profiled. The additional processing and analysis for the pallet can then be performed remote from the warehouse at a later time to avoid clogging network bandwidth and compute resources on the edge. Thus, the disclosed technology can provide for quickly moving ingested pallets along through the profiling process and into storage. In so doing, warehouse efficiency may not be compromised by the profiling of pallets.

The details of one or more embodiments are set forth in the accompanying drawings and the description below. Other features and advantages will be apparent from the description and drawings, and from the claims.

### BRIEF DESCRIPTION OF DRAWINGS

FIG. 1A is a conceptual diagram of a system for automatically and optically determining structural integrity and catch weight information for pallets in a facility, such as a warehouse environment.

FIG. 1B is a conceptual diagram of a system for profiling items in a warehouse environment.

FIG. 1C depicts an example pallet of cases that can be profiled in the warehouse environment.

FIG. 1D depicts example encoded information for cases on a pallet that can be identified using the disclosed techniques.

FIG. 2 depicts a perspective view of a photo booth of the system for profiling pallets in the warehouse environment.

FIG. 3A is a top view of an example configuration of the system for profiling pallets in the warehouse environment.

FIG. 3B is a top view of another example configuration of a system for profiling pallets in the warehouse environment.

FIG. 3C is a top view of another example configuration of a system for profiling pallets in the warehouse environment.

FIG. 4A depicts a camera configuration for profiling pallets.

FIG. 4B depicts another camera configuration for profiling pallets.

FIGS. 4C, 4D, and 4E depicts another camera and lighting configuration for profiling pallets.

FIG. 5A is a block diagram of a process for profiling a pallet.

FIG. 5B is a timeline of the process for profiling a pallet in reference to FIG. 5A.

FIG. 6 is a flowchart of a process 600 for identifying pallet information from image data of a pallet.

FIGS. 7A, 7B, and 7C is a flowchart of a process for determining catch weight of cases on a pallet based on processing image data of the pallet.

FIG. 8A is a flowchart of a process for identifying gaps between cases, on a pallet based on processing image data of the pallet.

FIGS. 8B and 8C illustrate example image data of pallets having gaps between cases and image data of pallets without gaps between cases.

FIGS. 9A and 9B is a flowchart of a process for detecting damage to cases on a pallet based on processing image data of the pallet.

FIG. 9C illustrates example image data of a pallet having damaged cases.

FIG. 10A is a system diagram depicting system components that perform the techniques described herein.

FIG. 10B is a conceptual diagram of a computing system for performing some pallet profiling techniques on the edge as well as some pallet profiling techniques remotely.

FIGS. 11A and 11B are swimlane diagrams of an example process for profiling a pallet.

FIG. 12 is a block diagram of computing devices that may be used to implement the systems and methods described herein.

FIG. 13 is a conceptual diagram of a system for continuous, real-time processing of data for pallet identification.

FIG. 14 is a conceptual diagram of a process for collecting and processing data to perform pallet identification.

### DETAILED DESCRIPTION

This document describes systems, methods, and techniques for automatically and optically determining information about items such as pallets as they enter a warehouse environment. More specifically, the disclosed technology can be used to determine a catch weight of each case on the pallet, whether any of the cases are damaged, whether the pallet is dangerous to be routed around the warehouse as-is (e.g., presence of gaps, chimney stacks), and/or other structural integrity information about the pallet, which can be used to automatically and efficiently determine pallet routing and storage information/instructions in the warehouse (e.g., storage facility).

The pallet and/or case information can be determined using a combination of components, such as cameras and computing systems. The computing systems making catch weight and/or structural integrity determinations can be onsite, edge-processing devices that allow for quick, lightweight, and accurate determinations to be made upon arrival of the pallet in the warehouse. A vertical pole having stationary cameras can be set up in the warehouse environment with a rotating turntable to provide for continuous and uniform image capturing of inbound pallets. The vertical pole can take up minimal space in the warehouse and can be moved around to desired locations in the warehouse. Lights, such as and/or including red lights, can be offset from the stationary cameras and provide uniform lighting, which can result in clearer images to be captured without glare. The captured images can be received and processed by the onsite edge processing device to determine the information about the pallet and the cases stacked thereon. Some processing and/or determinations can be performed remote and/or at another time, such as while the pallet is being routed to long-term storage in the warehouse. As a result, available compute resources and processing power can be optimized for purposes of efficiently and safely routing pallets in the warehouse without requiring manual labor and time.

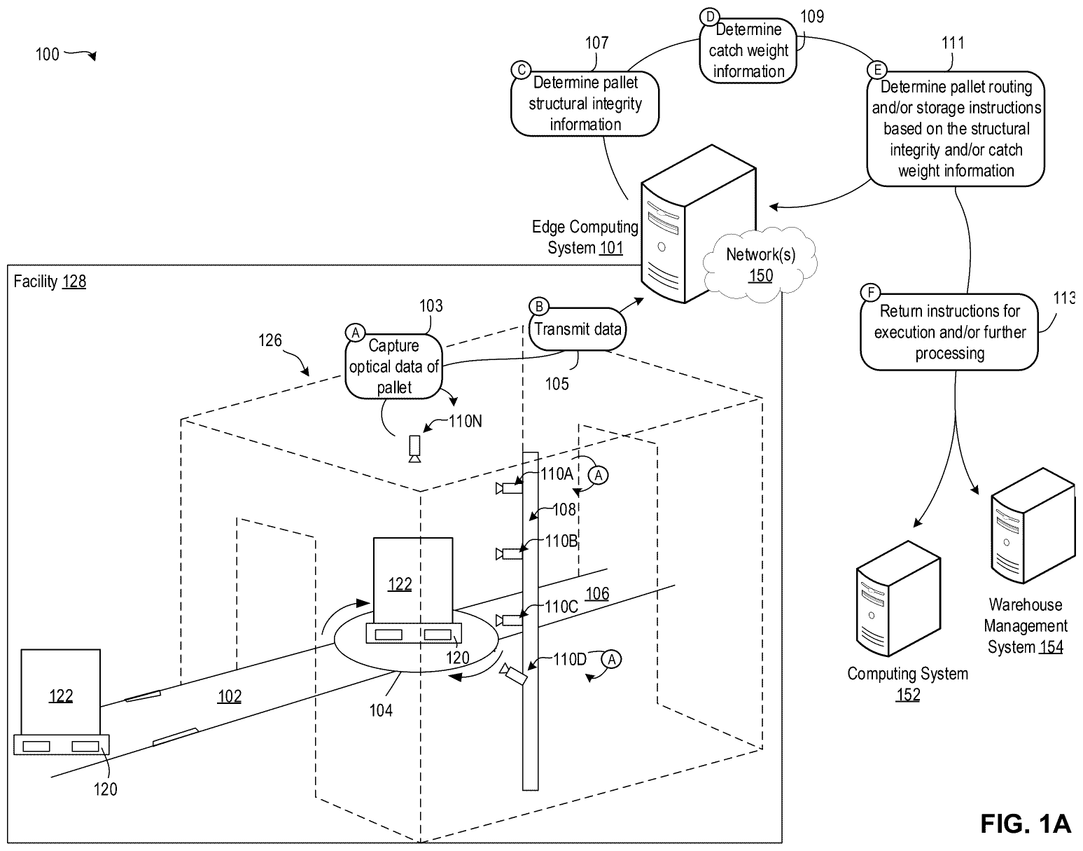

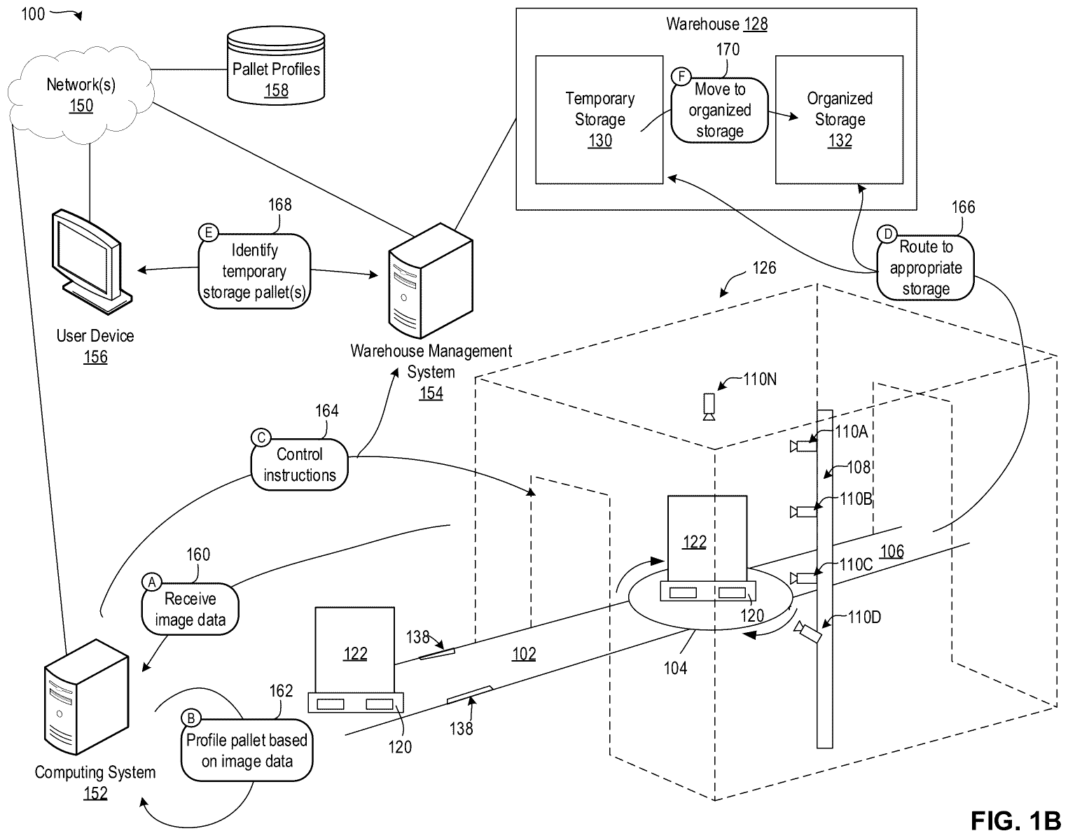

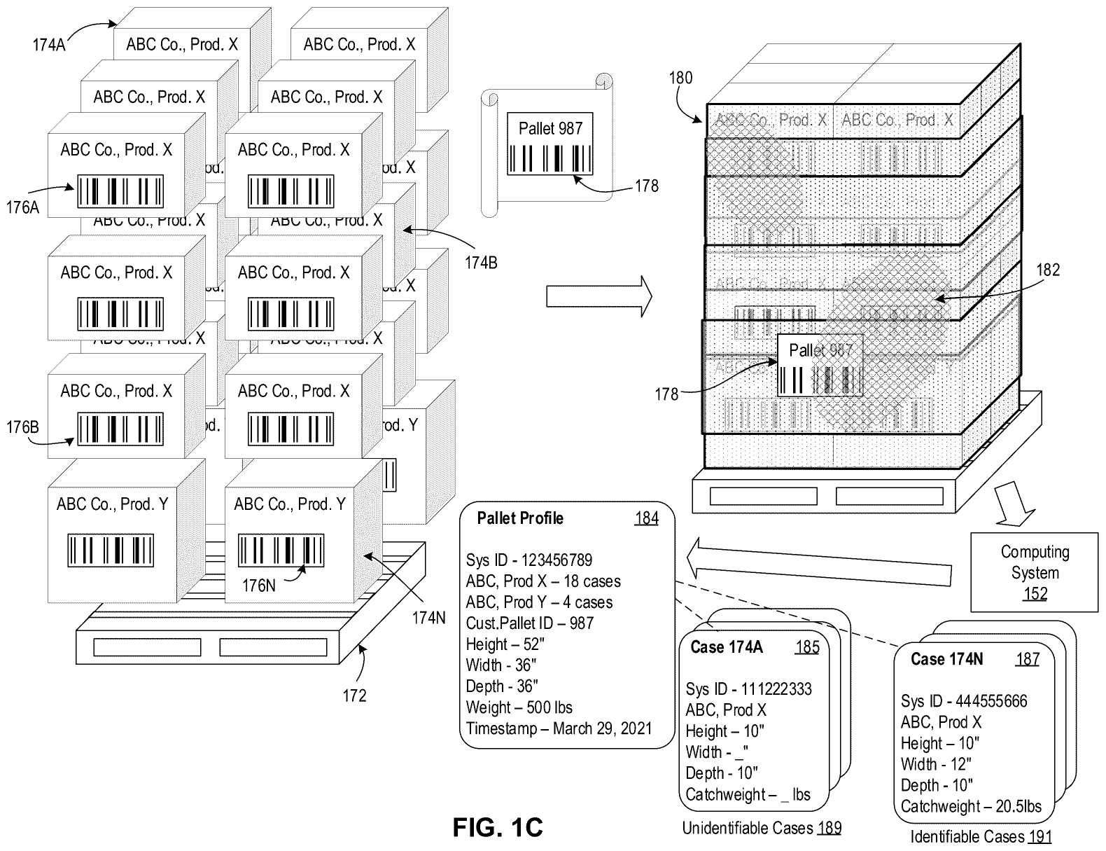

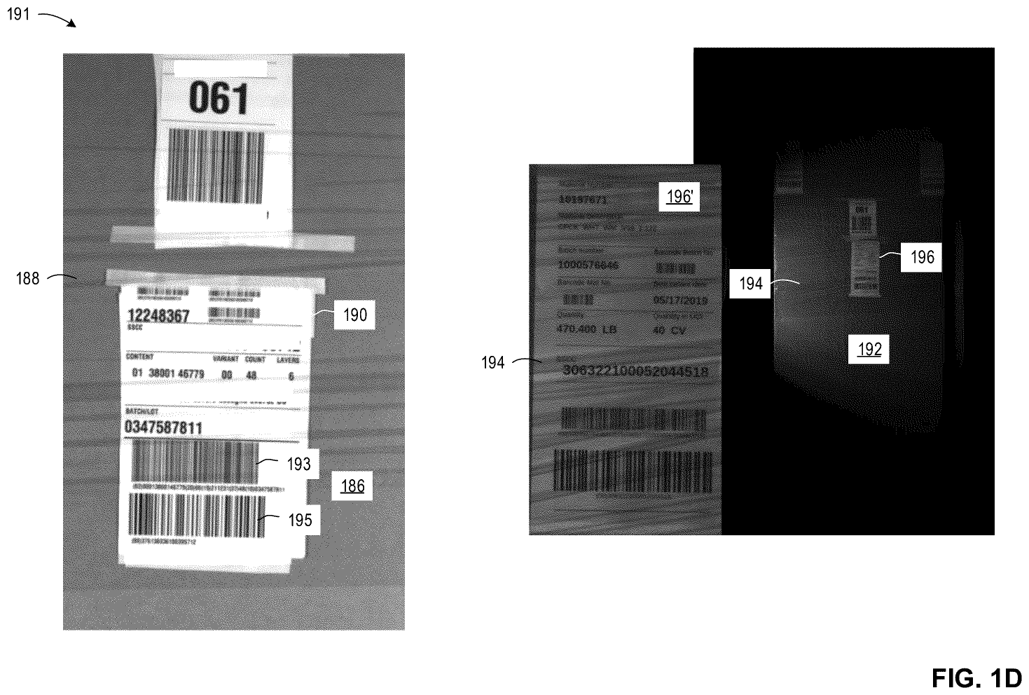

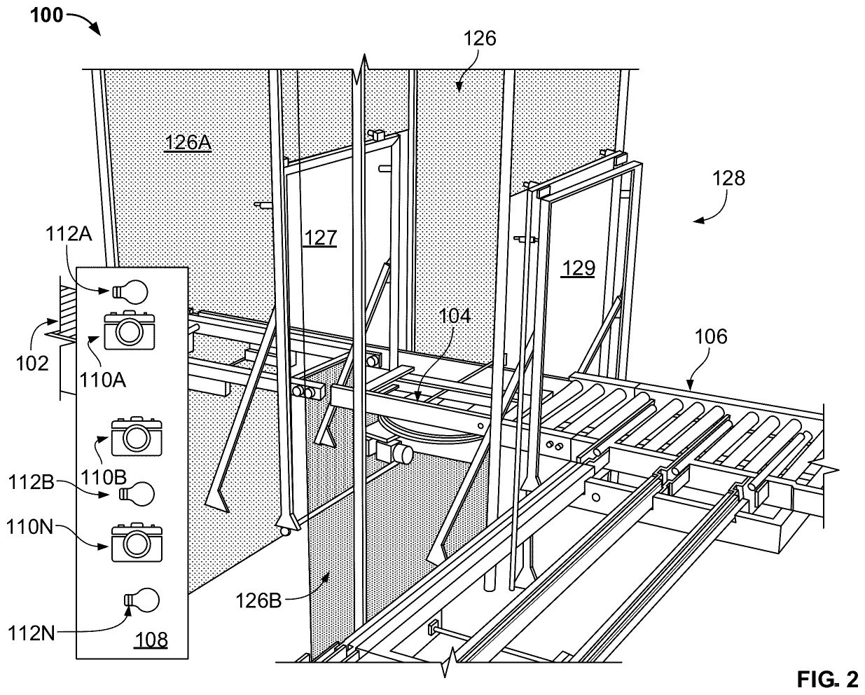

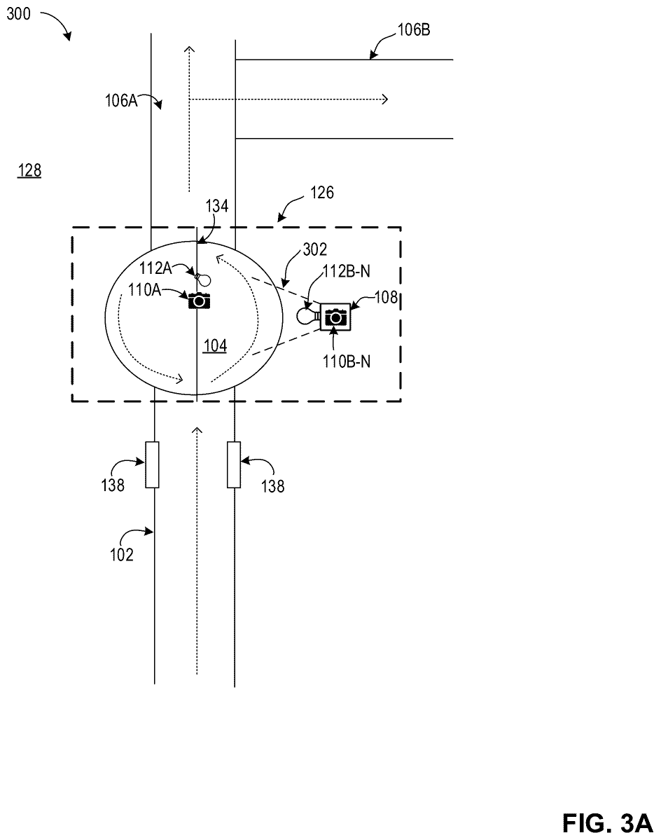

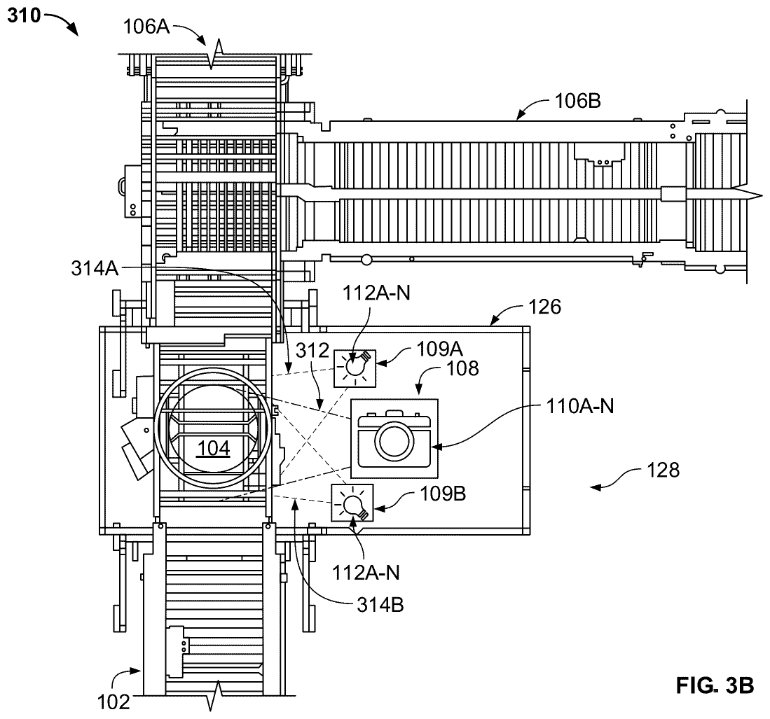

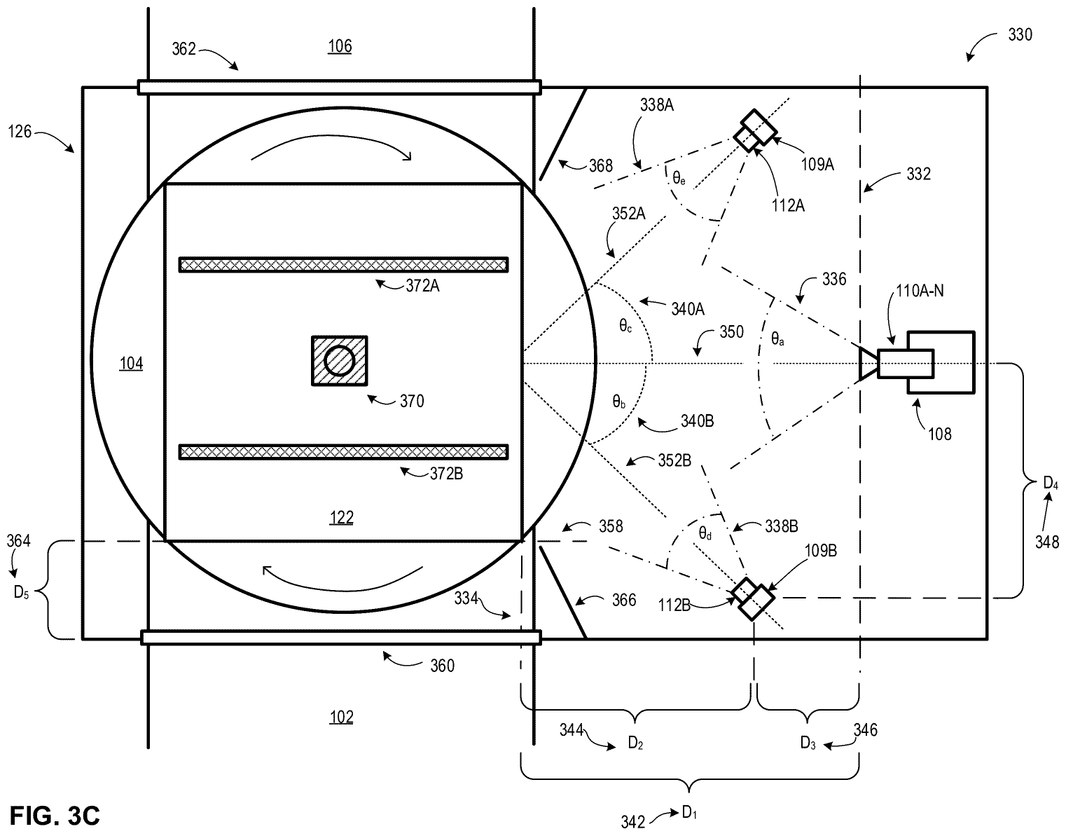

Referring to the figures, FIG. 1A is a conceptual diagram of a system 100 for automatically and optically determining structural integrity and catch weight information for pallets 120 in a facility 128, such as a warehouse environment. The system 100 can include an on conveyor belt 102, an off conveyor belt 106, a turntable 104, a vertical pole 108 (e.g., profiling structure), and a photo booth 126. The photo booth 126 can be used to provide uniform lighting conditions for better and clearer image captures, as described further in reference to FIGS. 2-3. In some implementations, the system 100 may not include the photo booth 126. The on conveyor belt 102 can be configured/attached to the turntable 104 such that a pallet 120 having an item 122 (e.g., boxes, containers, etc.) positioned on the belt 102 can be automatically moved onto the turntable 104. The vertical pole 108 can include one or more cameras 110A-N, which can be configured to capture image data of the pallet 120 from various angles. Refer to at least FIG. 1B for further discussion about the components described in the system 100.

The system 100 can include an edge computing device 101, which can communicate (e.g., wired, wirelessly) via network(s) 150 with components of the system 100, such as the cameras 110A-N, and other computing systems, such as a computing system 152 and a warehouse management system 154. Refer to at least FIG. 1B for further discussion about the computing system 152 and the warehouse management system 154. In some implementations, the edge computing system 101 can be the same as the computing system 152 and/or the warehouse management system 154.

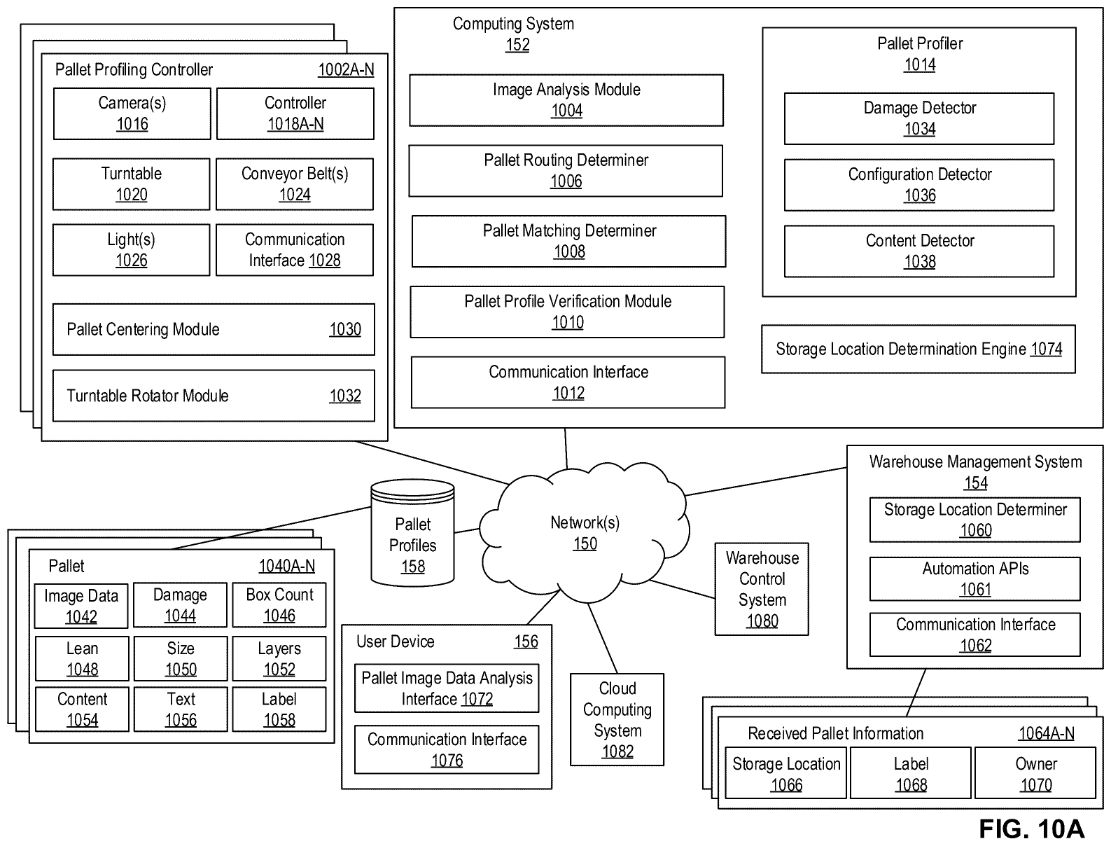

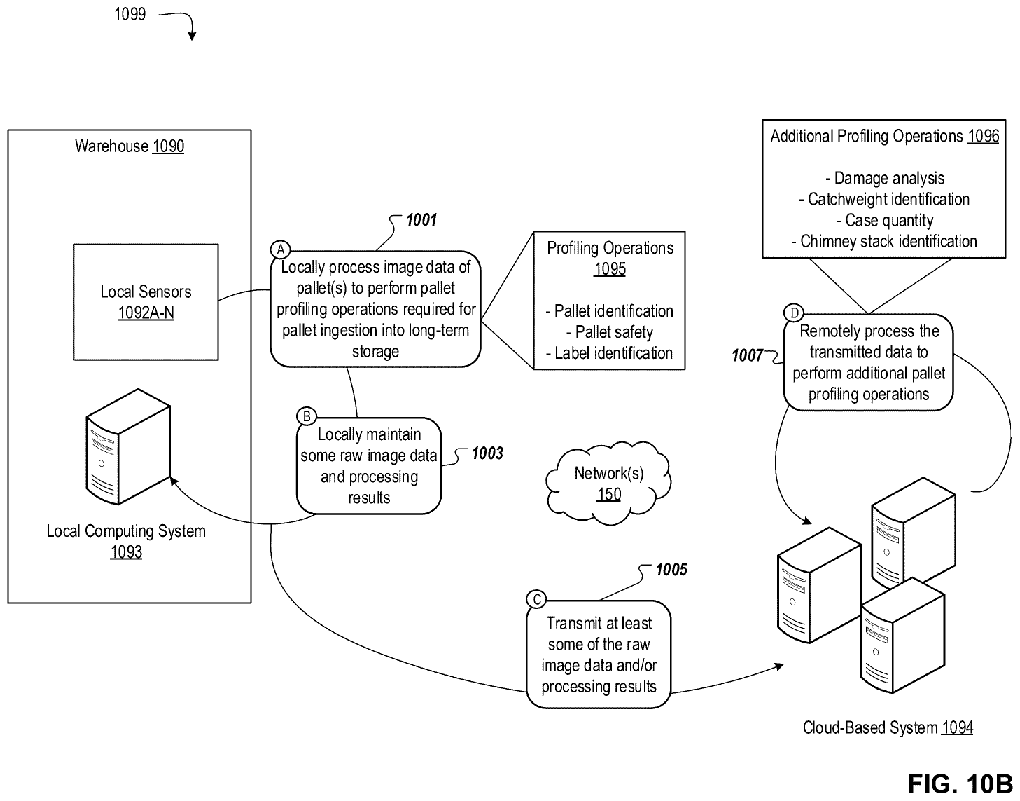

The edge computing system 101 can be an onsite edge processing device in the facility 128. For example, the edge computing system 101 can be configured to the vertical pole 108. In some implementations, the edge computing system 101 can be part of one or more of the cameras 110A-N. The edge computing system 101 can be configured to perform one or more determinations in real-time in the facility 128, as the pallet 120 is routed on the conveyor belt 102, rotated on the turntable 104, and/or imaged by the cameras 110A-N. As a result, efficient, quick, and lightweight determinations can be made about whether and where the pallet 120 should be routed in the facility 128 upon arrival to the facility 128. The edge computing system 101 can perform operations such as determining a structural integrity of the pallet 120 and/or catch weight of the items 122 thereon. The edge computing system 101 can also determine whether the pallet 120 is structurally sound to safely be moved in the facility 128 to a desired storage location or whether the pallet 120 should be moved to a pallet checking station. One or more other determinations can also be performed on the edge. Refer to at least FIG. 10B for further discussion about the onsite edge processing versus remote processing.

Still referring to FIG. 1A, the one or more cameras 110A-N can capture optical data of the pallet 120 when the pallet 120 comes into a field of view (FOV) of the cameras 110A-N (block A, 103). The optical data can include images (e.g., 2D, 3D) of the pallet 120 from various different angles. The optical data may also include other types of data described herein. Refer to at least FIG. 1A for further discussion about controlling the cameras 110A-N to capture the optical data of the pallet 120. The cameras 110A-N can transmit the data to the edge computing system 101 (block B, 105).

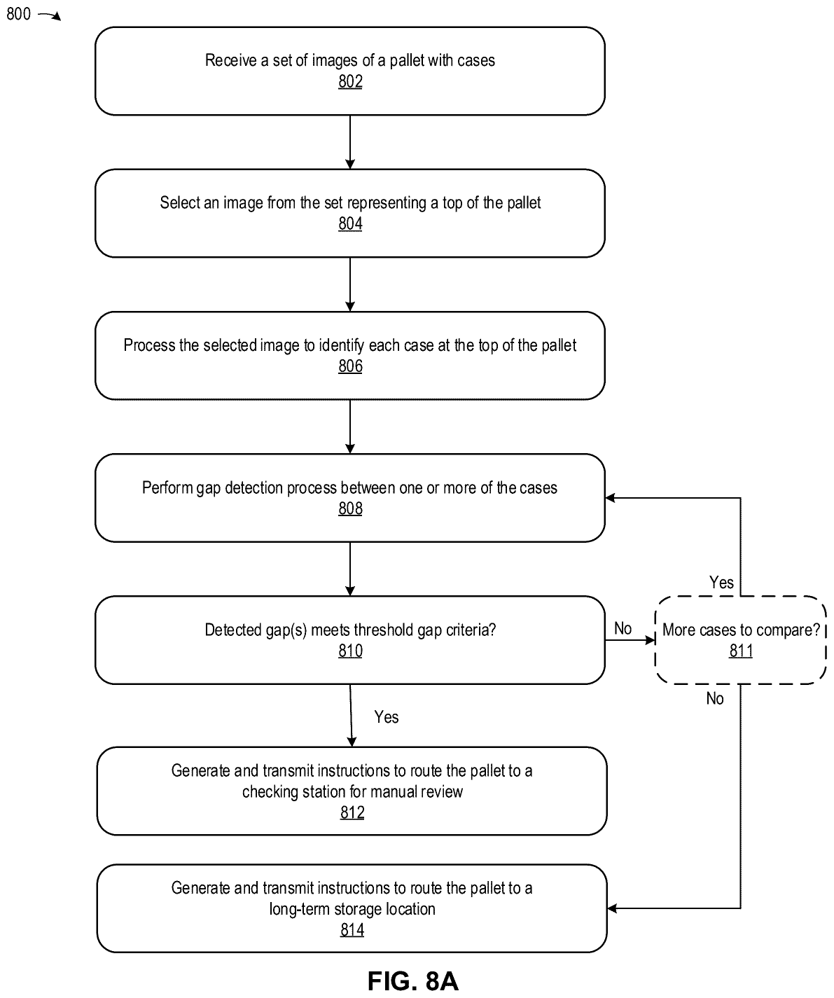

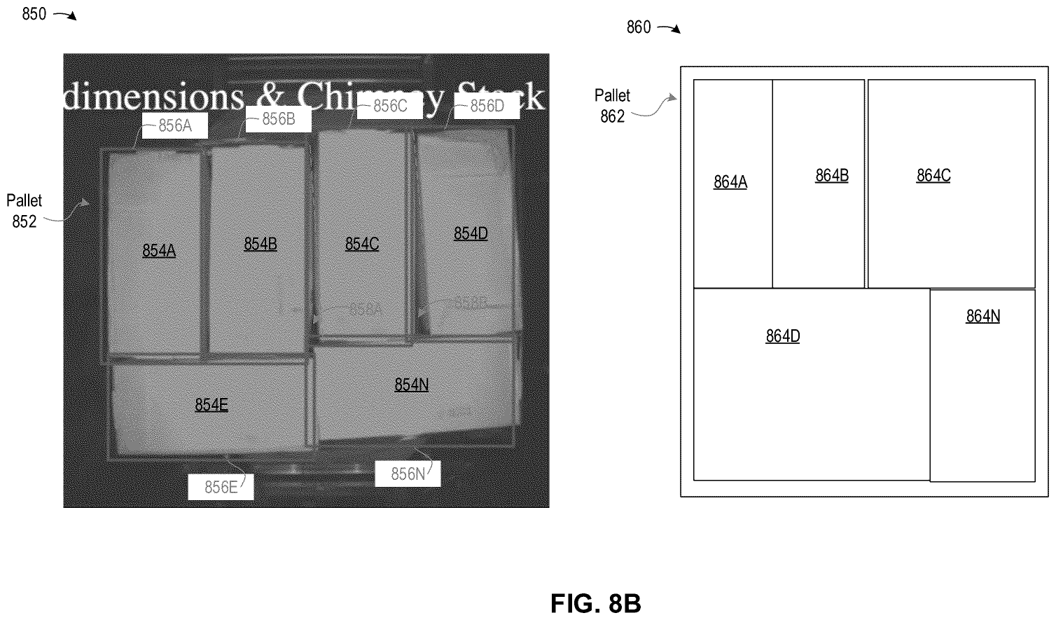

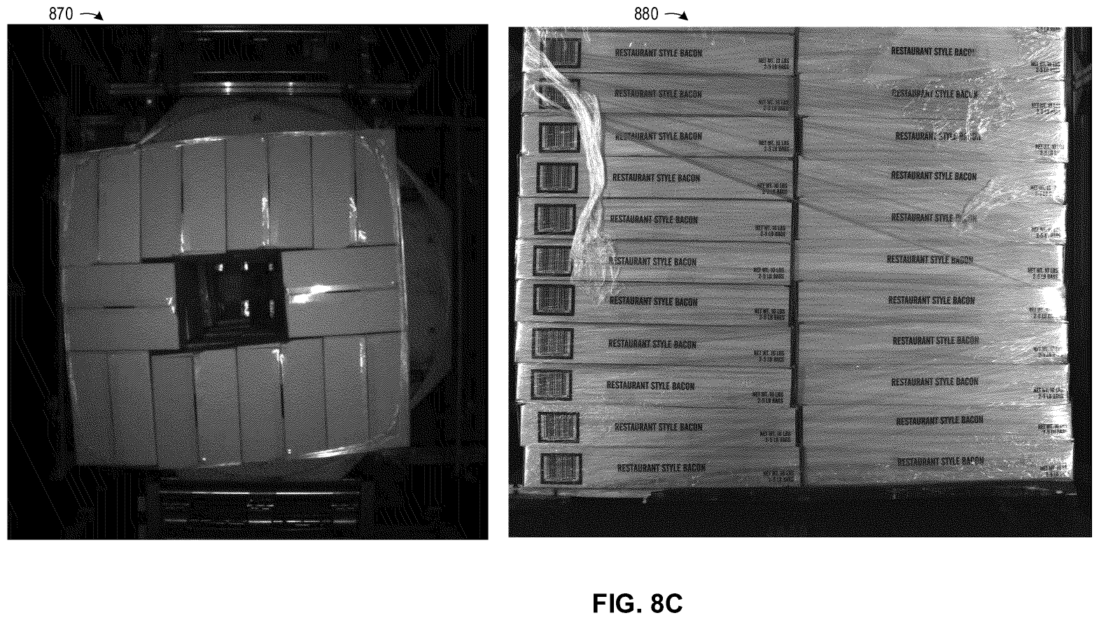

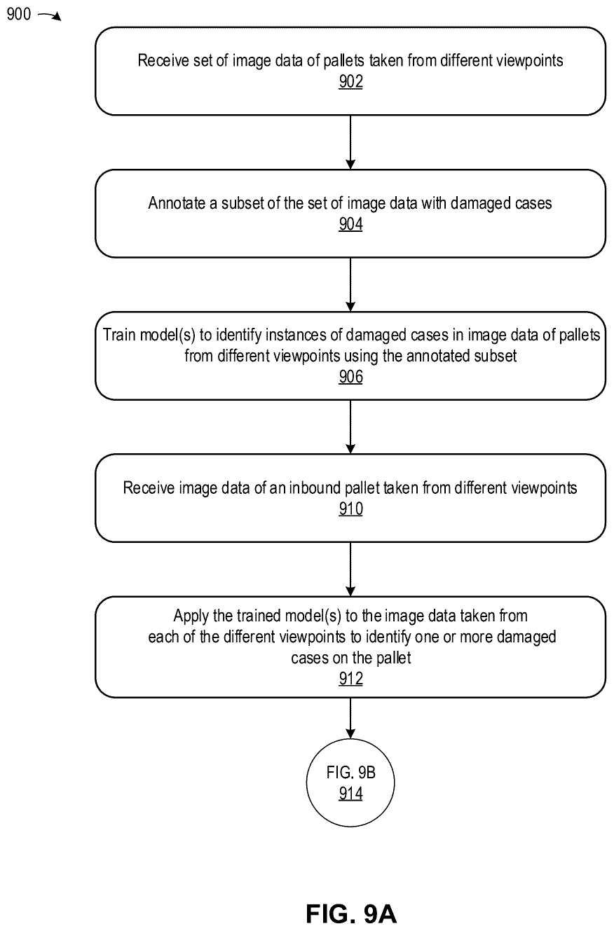

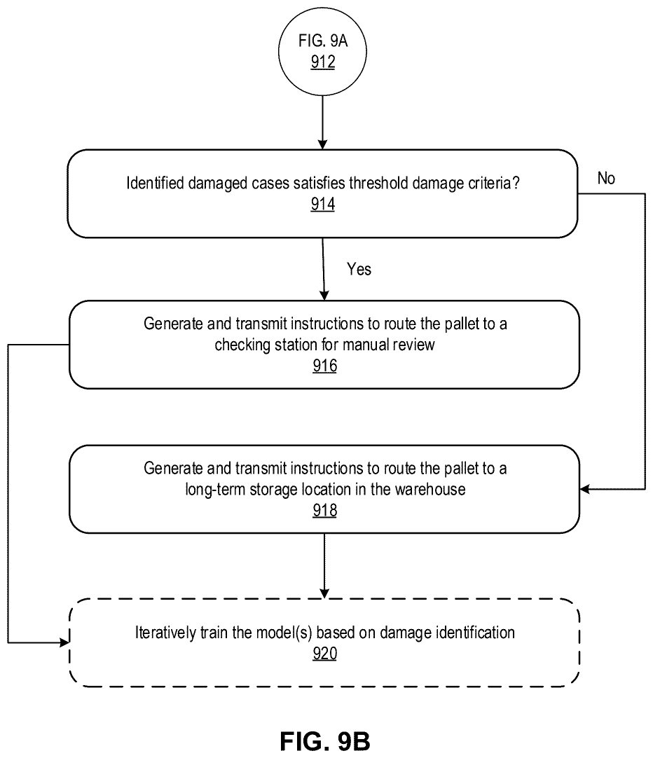

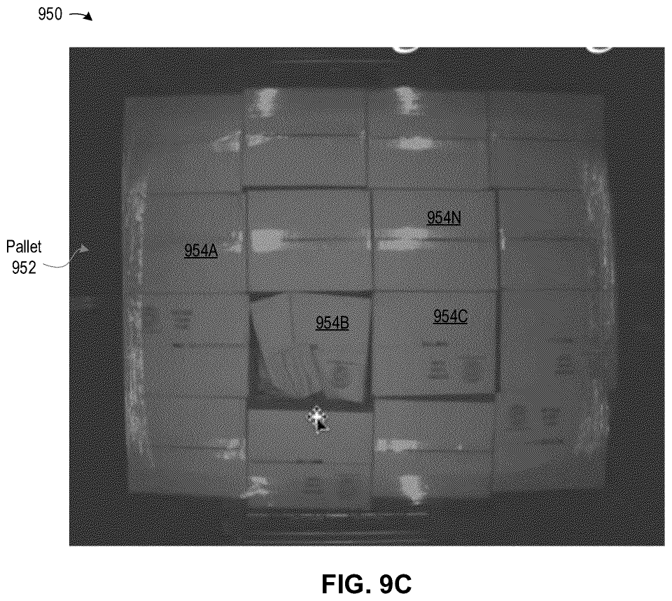

The edge computing system 101 can determine pallet structural integrity information based on processing the received data (block C, 107). The determination can include identifying gaps between one or more of the items 122 stacked on the pallet 120, damage to one or more of the items 122, a lean of the items 122 on the pallet 120, damage to pallet boards, etc. Determining the structural integrity information can also include determining a score or other value indicating a safety risk of any identified structural conditions of the pallet 120 and/or items 122. A higher the score, for example, the less safe the structure of the pallet 120 may be, which can indicate that the pallet 120 should be routed to a temporary location in the facility 128 for additional checking and/or potential disassembly and reassembly. Refer to FIGS. 8-9 for further discussion about determining the structural integrity information.

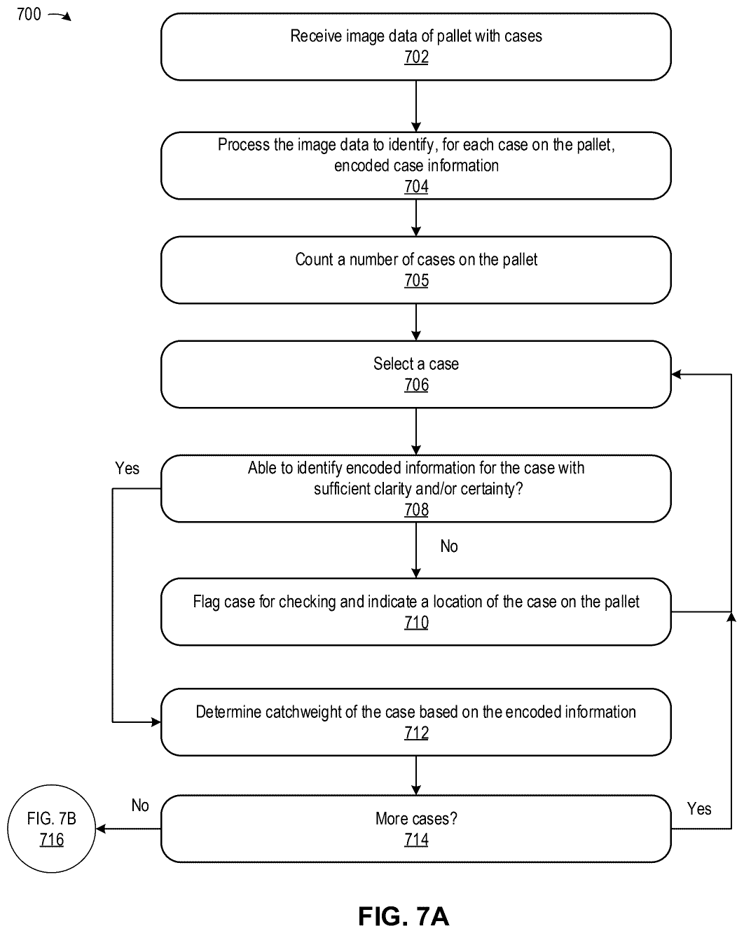

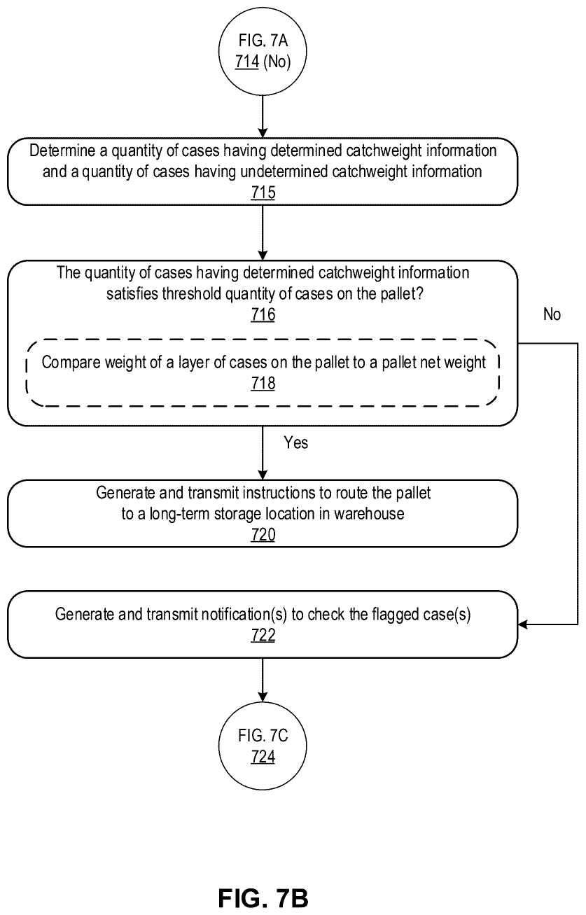

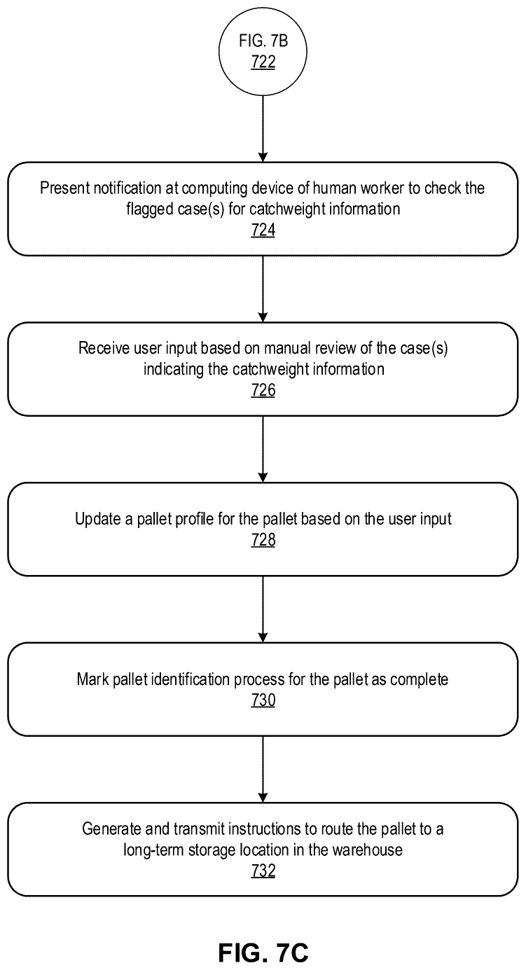

The edge computing system 101 can determine catch weight information for the pallet 120 (block D, 109). The edge computing system 101 can process the received data to determine, identify, and/or verify a catch weight for each of the items 122 on the pallet 120. The edge computing system 101 can perform one or more mathematical operations to determine catch weights for items that may not be visible in the optical data of the pallet 120. The edge computing system 101 can also generate one or more scores indicating accuracy of the determined catch weight information and/or confidence that the catch weight information has been determined for at least a predetermined threshold quantity of the items 122 on the pallet 120. A higher score can indicate greater confidence that the catch weight information is accurate and/or that a sufficient amount of catch weight information has been determined/identified. Refer to at least FIGS. 7A-C for further discussion about determining the catch weight.

The edge computing system 101 can determine pallet routing and/or storage instructions based on the structural integrity information and/or the catch weight information (block E, 111). For example, if the structural integrity information has a score that exceeds some predetermined threshold value or range, the edge computing system 101 can generate instructions and/or a recommendation to move the pallet 120 to a checking station and flag one or more particular items on the pallet 120 to be checked. As another example, if the score is less than the predetermined threshold value or range, the edge computing system 101 can generate instructions and/or a recommendation to move the pallet 120 to a designated storage location in the facility 128. Refer to FIG. 1B for further discussion.

The edge computing system 101 can then return the instructions for execution and/or further processing to the computing system 152 and/or the warehouse management system 154 (block F, 113). The computing system 152 can include a controlled configured to control operations of the components in the system 100. The computing system 152 can accordingly execute the instructions by controlling the off conveyor belt 106 to route the pallet 120 out of the photo booth 126 and along a particular conveyor path to a determined storage location or checking station in the facility 128. As another example, the computing system 152 and/or the warehouse management system 154 can receive the instructions, the optical data, and/or the determinations made by the edge computing system 101 and perform additional pallet profiling operations or other determinations described throughout this disclosure.

FIG. 1B is a conceptual diagram of the system 100 for profiling items in a warehouse environment 128. The warehouse environment 128 can be any type of storage facility or other environment for moving, routing, and/or storing items for different lengths of time. Example warehouse environments include cold storage facilities, distribution centers, and general warehouses.

The conveyor belts 102 and 106 can be any types of conveyor belts, rollers, or other mechanisms used in a warehouse environment to move (e.g., automatically, semi-autonomous, and/or manually) and route items throughout the warehouse environment 128. The turntable 104 can be a rotatable platform. The on conveyor belt 102 can receive the pallet 120 when it arrives at the warehouse 128. For example, the on conveyor belt 102 can be in or proximate to a docking bay area of the warehouse 128. The pallet 120 can be loaded off of a truck at the docking bay and automatically or manually placed (e.g., injected) onto the conveyor belt 102 (e.g., by a warehouse worker, forklift, etc.). The conveyor belt 102 can automatically move the pallet 120 towards the turntable 104.

Before the pallet 120 is moved onto the turntable 104, adjustment device(s) 138 configured to the on conveyor belt 102 can align and/or center the pallet 120 on the belt 102. As a result, the pallet 120 can be delivered onto the turntable 104 at a center or midpoint of the turntable 104. In some implementations, the pallet 120 can also be automatically centered at the midpoint of the turntable 104. Centering and aligning the pallet 120 can be advantageous to capture uniform images of the pallet 120, as described further below.

Still referring to FIG. 1B, the off conveyor belt 106 can be configured/attached to the turntable 104 such that the pallet 120 can be automatically moved onto the belt 106 once images are captured of the pallet 120, as described further below. The off conveyor belt 106 can include one or more branches for routing the pallet 120 to organized storage locations 132 and/or temporary storage locations 130 in the warehouse 128. The pallet 120 can be moved along the conveyor belts 102 and 106 and/or the turntable 104 at a constant speed. In some implementations, the speed can be 2 in/sec. The pallet 120 can be moved at a faster or slower speed based on a configuration and performance of components described herein in the system 100.

The turntable 104 can be configured to rotate the pallet 120 around a z axis, in a clockwise and/or counterclockwise direction. In some implementations, the turntable 104 can rotate the pallet 120, in one direction during a first scan (e.g., pass-through) of the pallet 120 and then rotate in an opposite direction during a second scan of the pallet 120. The turntable 104 can have a slow but fluid rotation, such that images can be captured of the pallet 120 from every side/angle. For example, the turntable can rotate at a speed of 2 in/sec. One or more other rotation speeds can be used. In some implementations, a speed and/or direction of rotation can be adjusted based on a pallet that is being scanned. For example, the turntable 104 can rotate at a faster speed for a large pallet having more surface area versus a pallet that is half the size of the large pallet, thereby having less surface area.

The vertical pole 108 can include one or more cameras 110A-N. Optionally, the vertical pole 108 can also include one or more light sources, as depicted and described in reference to FIGS. 2-4. As shown in FIG. 1B, a camera 110N can also be positioned within the photo booth 126 above the turntable 104. The camera 110N can be configured to capture images of a top surface of the pallet 120. In general, the cameras 110A-N can be configured to continuously capture image data of the pallet 120 as it is rotated on the turntable 104. One or more of the cameras 110A-N can be angled at a 90 degree offset from the turntable 104. The cameras 110A-N can also be positioned at other angles offset and/or relative to the turntable 104.

The pole 108 can be a uniform height to accommodate for any size pallet that may be placed on the turntable 104. In some implementations, the pole 108 can be adjusted in height depending on a size of a pallet that is being scanned. The pole 108 can be stationary and placed a working distance away from the turntable 104. Since the pole 108 is stationary, the cameras 110A-N attached thereto can capture images of the pallet 120 from all sides based on a constant distance, field of view (FOV), and angle(s).

In some implementations, the pole 108 can include a camera positioned at a top of the pole 108 to capture images of a top of the pallet 120. The pole 108 can also include a camera positioned at a bottom of the pole 108 to capture images of a bottom of the pallet 120. Placement of such cameras can be advantageous to provide for capturing images of parts of the pallet 120 that otherwise may be difficult for a warehouse worker to inspect or see. Thus, the images can provide a more complete view of the entire pallet 120 for profiling.

The cameras 110A-N can be attached to the pole 108 at predetermined angles such that images can be captured of every side of the pallet 120 from multiple angles. The images can therefore be stitched together to generate a comprehensive image model of the pallet 120 for further processing (e.g., identifying characteristics of the pallet 120). In some implementations, one or more of the cameras 110A-N can be other types of sensing or imaging devices, including but not limited to LIDAR, 3D stereoscopic cameras, thermal sensors, and/or scanners (e.g., barcode, RFID, QR code). In yet other implementations, the pole 108 can include the one or more cameras 110A-N in addition to one or more LIDAR sensors, thermal sensors, and scanners. Locating all the cameras, sensors, and/or scanners on the single pole 108 can provide for more efficient use of space in the warehouse environment 128, as well as more time-saving, efficient, and accurate scanning and profiling of pallets.

In some implementations, the vertical pole 108 can include one camera 110A. The camera 110A, for example, can have a large FOV to capture the pallet 120 from top to bottom. The pole 108 with the one camera 110A can be positioned farther away from the turntable 104 (e.g., a greater working distance) in order to capture the pallet 120 from top to bottom. This configuration can be advantageous since it can be less costly to implement than multiple cameras. Moreover, the one camera 110A can be a high resolution camera. Profiling the pallet 120 would not require stitching together images from multiple cameras, which can reduce processing time and use less computational resources. Thus, profiling by image processing can become more efficient.

In some implementations, the vertical pole 108 can include two cameras 110A-B. The cameras 110A-B can have large FOVs and can be high resolution cameras. Profiling the pallet 120 can require stitching together images from both cameras 110A-B, which can use less processing power and computational resources than having to stitch together images from more than two cameras. As an example configuration, the pole 108 can be positioned a working distance of 1.9 m away from the turntable 104. The pole 108 can have a maximum height of 2.75 m (e.g., 108 inches). A first camera 110A can be positioned 1.6 m (e.g., 63 inches) from the bottom of the pole 108. A second camera 110B can be positioned 1.6 m from the top of the pole 108. As a result, the cameras 110A-B can have a FOV overlap of approximately 0.225 m (e.g., 8.9 inches). This FOV overlap can be advantageous to more easily, quickly, and accurately stitch together images captured by the cameras 110A-B.

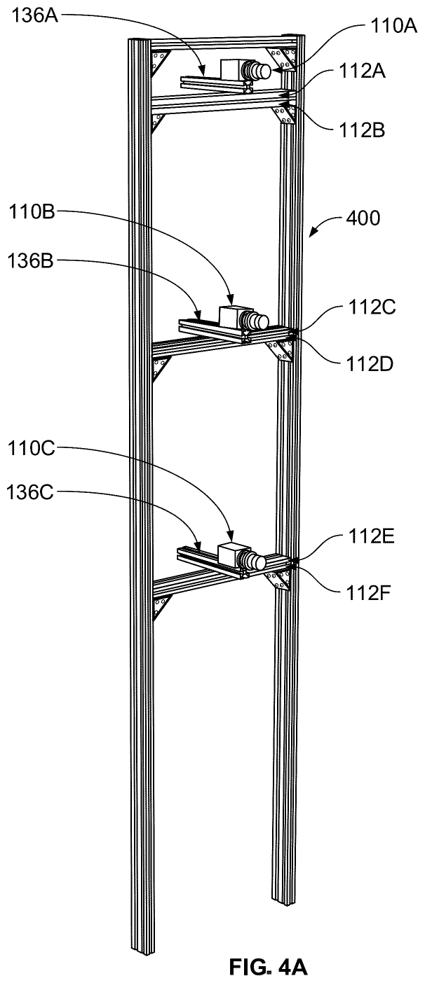

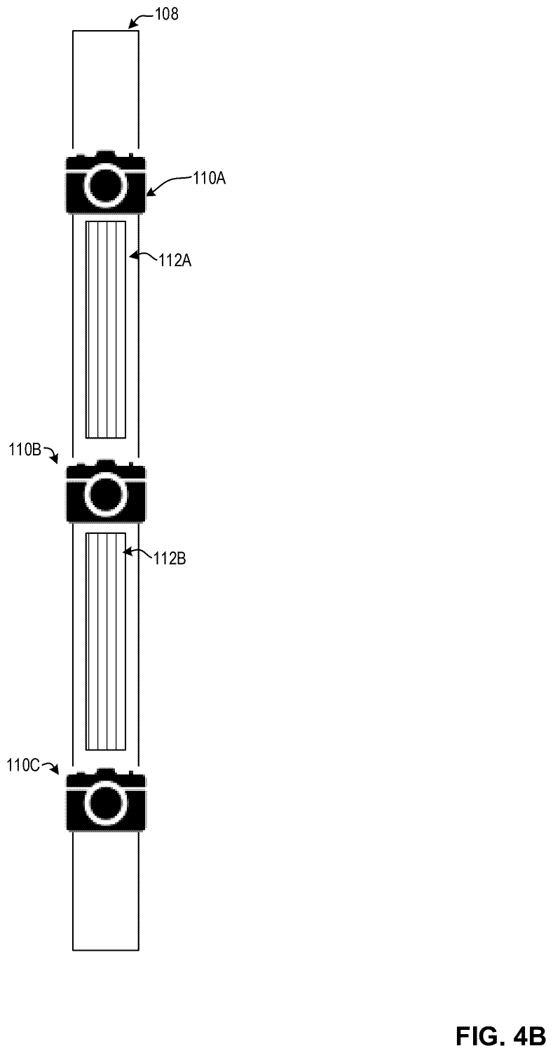

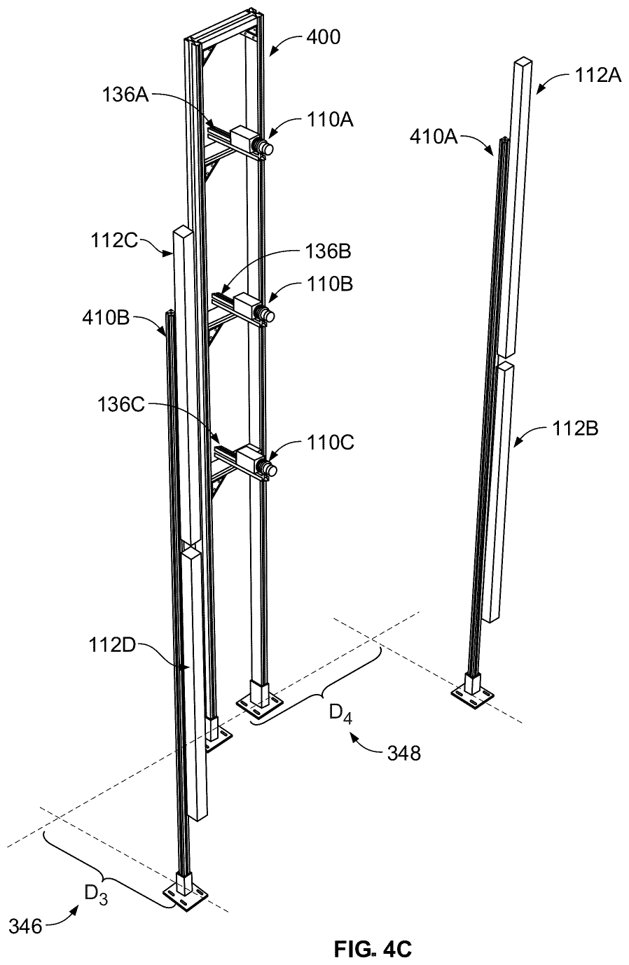

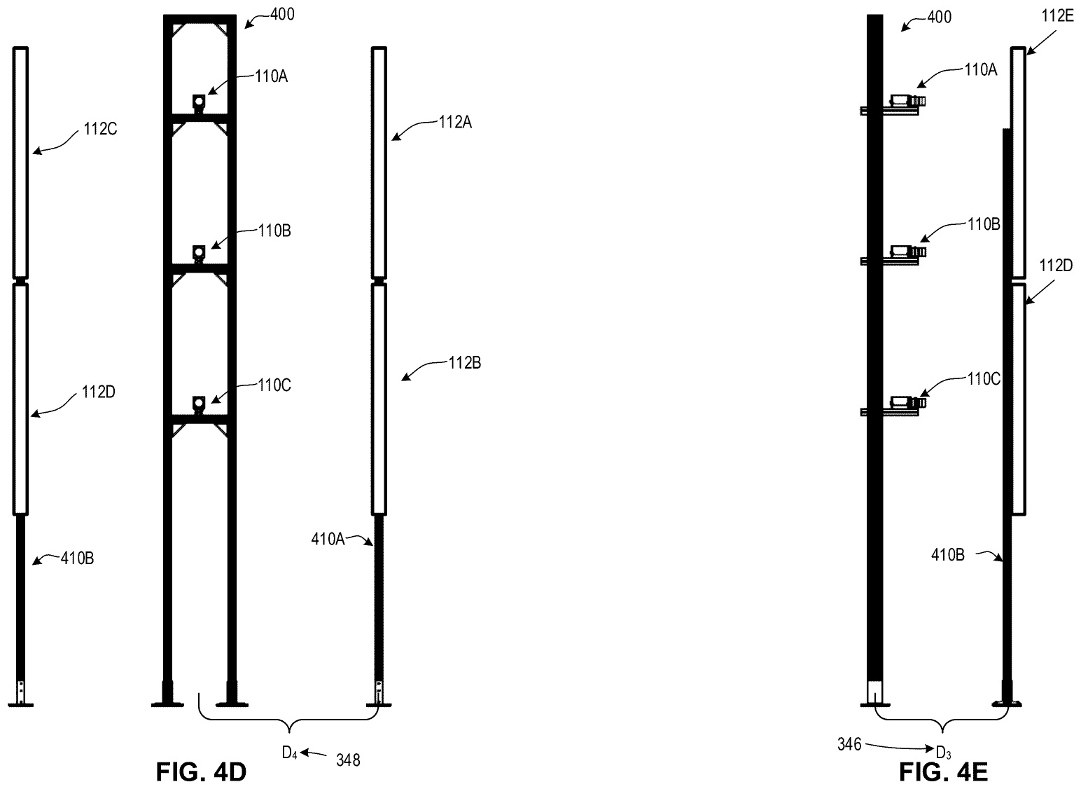

In yet other implementations, the vertical pole 108 can include three cameras 110A-C, as described in reference to FIGS. 4A-B. The pole 108 can also include additional cameras 110D-N or other sensors or imaging devices.

The vertical pole 108 configuration can be advantageous because it uses less space in the warehouse environment 128 and also prevents potential imaging and profiling discrepancies that may occur when cameras rotate around a pallet. When cameras rotate around a stationary pallet, each image that is captured may be taken from different angles and/or at unequal distances from the pallet. For example, a rotating camera may move up and down around each side of the pallet. By moving up and down, the rotating camera may inherently reposition at differing distances from the pallet to capture each image. This can result in distorting the images once they are stitched together. Stitching together such images can require additional processing power and computational resources, and can result in inaccurate imaging and pixilation. As a result, pallet characteristics can be inaccurately identified or otherwise not identified.

The pole 108 configuration, on the other hand, ensures that all images are captured from an equal distance (e.g., the working distance) to the pallet 120 while the pallet 120 rotates on the turntable 104. The equally distanced images can be more easily stitched together to generate a comprehensive image of the pallet 120 for profiling and characteristic identification.

The system 100 can optionally include one or more sensors, cameras, and/or scanners that are configured to the turntable 104. For example, one or more sensors can be configured to the turntable 104 to detect and determine a weight of the pallet 120. As another example, one or more cameras, scanners, or other imaging devices can be attached to a top surface of the turntable 104 to capture one or more images or other information that is located on a bottom of the pallet 120 (e.g., damage to a bottom of a wood frame). As yet another example, the turntable 104 can have one or more motion sensors to determine a speed and/or angle at which the turntable 104 is rotated.

Still referring to FIG. 1B, the system 100 includes a computing system 152, a warehouse management system (WMS) 154, a user device 156, and a pallet profiles data store 158 in communication (e.g., wired and/or wireless) via network(s) 150. The computing system 152 can control one or more components of the system 100 to profile the pallet 120. In some implementations, the computing system 152 can be a combination of one or more computing systems, including the WMS 154. Although the disclosed operations are described from the perspective of the computing system 152, one or more of the disclosed operations may also be performed by one or more other computer systems and/or devices. As an illustrative example, the turntable 104 can be controlled by another computing device that passes rotation signal to the computing system 152. Using those rotation signals, the computing system 152 can trigger one or more of the cameras 110A-N to capture images of the pallet 120. As another illustrative example, the computing system 152 can determine, based on processing the images of the pallet 120, whether some or all details of the pallet 120 are discernable within at least a threshold confidence level. The computing system 152 can transmit information regarding this determination to another computing system, such as an automation API, which can route the pallet 120 to one or more different locations in the warehouse based on the determination (e.g., route the pallet 120 to a temporary storage location based on the computing system 152's determination that the details are not discernible within the threshold confidence level).

The computing system 152 can also perform image processing techniques to identify information about the pallet 120. For example, the computing system 152 can receive image data from the cameras 110A-N (step A, 160). In some implementations, the computing system 152 can instruct the cameras 110A-N when to capture images of the pallet 120 (e.g., once the pallet 120 is sensed or otherwise detected on the turntable 104). The computing system 152 can receive image data as images are captured by the cameras 110A-N. The computing system 152 can also receive image data after the pallet 120 is rotated a full 360 degrees by the turntable 104.

The computing system 152 can profile the pallet 120 based on the image data (step B, 162). As described throughout this disclosure, the computing system 152 can perform image processing and analysis techniques to identify a label or other unique identifier associated with the pallet 120. As an example, the computing system 152 can be trained to identify labels that have x dimensions ranging from 0.495-1.016 mm, height of 31.75, a quiet zone left of at least 10 times the x dimensions, and a quiet zone right of at least 10 times the x dimensions. The computing system 152 can also be trained to identify labels of different sizes. The computing system 152 can also identify information or characteristics about the pallet 120 from the image data. The computing system 152 can profile the pallet 120 as the image data is received. The computing system 152 can also profile the pallet 120 once all the image data is received (e.g., the pallet 120 was rotated a full 360 degrees on the turntable 104).

The computing system 152 can generate control instructions based on profiling the pallet 120 (step C, 164). The control instructions can be implemented by the computing system 152 to control one or more components of the system 100. For example, the control instructions can cause the pallet to be automatically moved from the turntable 104 onto the off conveyor belt 106. The pallet 120 can then be routed to an appropriate storage location (step D, 166). The control instructions can indicate the appropriate storage location. As described further below, the appropriate storage location can be determined based on whether the computing system can accurately identify the label of the pallet 120 when profiling the pallet 120 (step B, 162). If the label can be accurately identified, the pallet 120 can be routed (step D, 166) to the organized storage location 132. If the label cannot be accurately identified, the pallet 120 can be routed (step D, 166) to the temporary storage location 130.

The computing system 152 can also transmit the control instructions to the WMS 154 (step C, 164). Instructions can be sent to the WMS 154 when the label of the pallet 120 cannot be identified from the image data. When the instructions are sent to the WMS 154, the pallet 120 can also be automatically routed to the temporary storage 130 (step D, 166). The WMS 154 can communicate with the user device 156 to identify the pallet 120 that is placed in the temporary storage 130 (step E, 168). As described further below, a warehouse worker can inspect the image data of the pallet 120 in the temporary storage 130 to identify the label of the pallet 120 and an organized storage location for that pallet 120. The warehouse worker can also manually inspect the pallet in the temporary storage location 130. The user device 156 can identify or otherwise profile pallets that were previously unable to be identified. In other words, the user device 156 can receive image data of the pallet 122, wherein this image data can be provided to the WMS 154 by the computing system 152. The WMS 154 can use the image data to determine the organized storage location 132 for the pallet 122. The user device 156 can present the image data in a graphical user interface to the warehouse worker. The warehouse worker can view such image data and use the image data to perform manual and/or visual inspections of the pallet 122.

Once the pallet 120 is identified by the warehouse worker and/or the WMS 154 (step F, 170), the pallet 120 can be moved to the organized storage location 132 for that pallet 120 (step F, 170). The pallet 120 can be automatically moved from temporary storage 120 to the organized storage location 132, for example, by automated mechanical conveying system (e.g., conveyor belt), cranes, or other autonomous vehicles. The pallet 120 can also be manually moved, for example, by a warehouse worker and/or a forklift.

FIG. 1C depicts an example pallet 172 of cases 174A-N that can be profiled in the warehouse environment. The cases 174A-N can be stacked on the pallet 172. The cases 174A-N can include quantities of products (e.g., items). Each of the cases 174A-N can have corresponding labels 176A-N (e.g., barcodes, SKUs). The labels 176A-N can identify the cases 174A-N and contents of the cases 174A-N. The labels 176A-N can also include other encoded information about the respective cases 174A-N, such as a catch weight of the case. Each of the cases 174A-N can also have text identifying contents of the cases 174A-N, customers, and other information related to the cases. As shown, the cases 174A-N can be stacked in multiple layers on the pallet 172. Each layer on the pallet 172 can have a different quantity, type, and/or size of the cases 174A-N. Thus, each layer of cases 174A-N can be different from each other. For example, a bottom layer can include 4 large cases 174A-N that contain Product Y. A top layer can include 6 small cases 174A-N that contain Product X. Sometimes, as shown in FIG. 1C, some of the cases 174A-N may be in internal layers on the pallet 172 and therefore may not be visible to a camera or other imaging system described herein. As a result, some of the labels 176A-N are also interior and may be obstructed by other cases 174A-N from being imaged. Information about the interior cases 174A-N may, in some implementations, be inferred by the computing system 152 rather than determined by simply processing image data of the interior cases' labels.

The cases 174A-N can also be wrapped together with plastic wrap 180 (e.g., transparent, semi-transparent) on the pallet 172. The pallet 172 can have its own identifier 178 (e.g., barcode, label, SKU). However, as shown in FIG. 1C, when the cases 174A-N are wrapped together, the wrap 180 can obscure one or more labels 176A-N and/or marks/text on the cases 174A-B. The wrap 180 can also obscure the pallet identifier 178. Environmental obstructions 182 (cross-hatching areas), like frost, dust, scuffs, etc., can also occur, further obstructing a clear view of the pallet identifier 178 and/or any of the labels 176A-N of the cases 174A-N. The wrap 180 and/or the environmental obstructions 182 can pose challenges for positively identifying the cases 174A-N on the pallet 172, especially when the plastic wrap 180 can reflect light to obscure the cases 174A-N beneath. Thus, as described herein, the computing system 152 can be adapted to deal with such obstructions when profiling the pallet.

Using the techniques described herein, the computing system 152 can determine a pallet profile 184 for the illustrative example pallet 172 depicted in FIG. 1C. The pallet profile 184 can include information that is determined by the computing system 152 while profiling the pallet 172. For example, the profile 184 can include information such as a system ID, a name and/or quantity of each type of product and/or case on the profile, a customer pallet ID, a height, width, depth, weight, and timestamp for when the pallet 172 was profiled. One or more additional or other pieces of information can be determined for the pallet 172 and stored in the pallet profile 184. As described throughout this document, the computer system 152 can use any of a variety of image analysis techniques to identify and determine this information from the pallets, such as OCR techniques, machine learning models, other techniques, and/or combinations thereof.

The pallet profile 184 can also include information that has been determined or identified for the cases 174A-N stacked thereon. For example, the computing system 152 can identify information 185 for the case 174A and information 187 for the case 174N. The computing system 152 may also identify information for the other cases stacked on the pallet 172 based on processing image data captured of the pallet 172 from a variety of angles and viewpoints. More particularly, the computing system 152 can process the image data to identify the respective label 176A-N or other encoded information on each of the cases 174A-N. Using the identified respective label 176A-N, the computing system 152 can determine information about the respective case 174A-N, such as a catch weight of the case. If the label cannot be identified, then the computing system 152 may not be able to determine some information about the corresponding case.

Accordingly, in the example of FIG. 1C, the computing system 152 was able to identify the label 176N on the case 174N, primarily because the label 176N is unobstructed and visible to imaging devices, such as cameras used for profiling the pallet 172. Since the label 176N was identified, the computing system 152 identified/determined various information about the case 174N, such as an ID associated with the case, product(s) in the case, a height, width, depth, and a catch weight. Since this information was identified for the case 174N, the computing system 152 can identify, label, or otherwise group the case 174N into a category of identifiable cases 191 in the pallet profile 184. Any other cases that are successfully identified with sufficient clarity/accuracy may also be identified as the identifiable cases 191 in the pallet profile 184.

On the other hand, cases whose labels are obstructed or otherwise not sufficiently visible/identifiable can be labeled as unidentifiable cases 189 in the pallet profile 184. In the example of FIG. 1C, the case 174A has been identified as an unidentifiable case 189. Although some information 185 was identified about the case 174A using the disclosed techniques, the computing system 152 was not able to identify information such as a width of the case 174A and/or a catch weight of the case 174A. As a result, the computing system 152 labeled the case 174A as an unidentifiable case 189 in the pallet profile 184. One or more other cases may be labeled as unidentifiable, for example, any cases that are on interior layers or otherwise obstructed from a vantage point of the cameras described herein.

The computing system 152 can determine a count of cases that have been identified as unidentifiable 189 and a count of cases that have been identified as identifiable 191. If the count of unidentifiable cases 189 satisfies or exceeds some threshold value, then the computing system 152 may determine that the pallet 172 should be checked by a human worker. The computing system 152 can generate instructions that cause the pallet 172 to be automatically routed to a checking station in the warehouse environment. A warehouse worker at the checking station can receive instructions from the computing system 152 indicating which of the cases to manually check (e.g., just the unidentifiable cases 189 or a portion of the unidentifiable cases 189). The instructions can also indicate locations of the cases to manually check, such as a row and/or layer that each of the unidentifiable cases 189 are part of/on.

If the count of unidentifiable cases 189 does not satisfy the threshold value or less than the threshold value, then the computing system 152 can determine that the cases on the pallet 172 have been sufficiently identified for purposes of routing the pallet 172 to a long-term storage location. Sometimes, for example, the computing system 152 can perform additional computing techniques to infer information about some cases, such as the unidentifiable cases 189. For example, as described further below, the computing system 152 can compare a net weight of the pallet 172 to known catch weights for some of the cases 174A-N in order to determine catch weights for one or more of the unidentifiable cases 189. By inferring some of the case information, the computing system 152 can advantageously save labor costs (e.g., warehouse workers would not be required to receive the pallet 172 at a catch weight station and unload every case 174A-N from the pallet 172 in order to scan or otherwise identify catch weight information for each case, then restack the cases 174A-N on the pallet 172 before routing the pallet 172 to long-term storage in the warehouse environment) and increase efficiency in profiling inbound pallets and routing such pallets throughout the warehouse environment.

FIG. 1D depicts example encoded information for cases on a pallet that can be identified using the disclosed techniques. A case 186 can include a product identifier 190. The case 186 can also be wrapped in plastic wrap 188, which can cover a part or all of the product identifier 190. The case 186 can also include a case identifier 193 and a catch weight label 195. The case 186 can include one or more additional, fewer, or different labels and/or identifiers. Any of the labels described in reference to FIG. 1D can include encoded information about the particular case 186. Therefore, when the case 186 is imaged, any of the labels 190, 193, and/or 195 can be identified and processed using the disclosed techniques to determine information about the case 186. For example, identifying and processing the label 195 can cause a computing system as described herein to determine and/or verify a catch weight of the case 186. The catch weight can be information that is encoded in the label 185.

Accordingly, an image 191 of the case 186 having the labels 190, 193, and/or 195 can be captured by one or more of the cameras described herein (e.g., refer to the cameras 110A-N in FIG. 1A). The cameras can include red light filters. Moreover, one or more red strobe lights can be positioned near the case 186 to help illuminate the labels 190, 193, and/or 195 and reduce glare from the plastic wrap 188. The cameras can be set to capture 10 decibels gain (dB), with 5 millisecond (ms) exposure and red strobe light. The cameras can also be configured with 630 nanometer (nm) bandpass filters. The image 191 results, which shows a clear image of the labels 190, 193, and/or 195. The plastic wrap 188 may not cause glare or otherwise obstruct an ability to read the product identifier in the image 191 using the techniques described herein.

On the other hand, case 192 is set in different lighting and exposure conditions. The case 192 includes a product identifier 196, which can be beneath a layer of plastic wrap 194. The cameras can be set to capture 10 dB gain, with 2 ms exposure and red strobe light. The cameras can also have 630 nm bandpass filters. As shown, image 196′ has a less clear depiction of the product identifier 196. Moreover, portions of the product identifier are obscured by the plastic wrap 194 in the image 196′. In some implementations, the computing system described herein can still profile the pallet 192 based on the image 196′ of the product identifier 196. However, the camera and lighting conditions can be adjusted such that the cameras can be exposed for a longer period of time. As a result, a clearer, well-lit image can be captured of the product identifier, as shown with regards to the image 191, using the techniques described herein. This image can be used by the computing system to more accurately profile the pallet and identify information about the pallet.

In some alternative embodiments, a camera lens can be configured with a polarizing filter. Moreover, an LED light source can be positioned offset from the camera lens to reduce glare in the lens, as described throughout this disclosure. The LED light source can shine a red light on a pallet. In some implementations, the LED light source can shine a white light and a polarizing film can be applied to the light source to filter out all wavelengths except for those that correspond to red light. The polarizing film can therefore be configured to the LED light source. By using the polarizing filter on the camera lens, the LED light source, and the polarizing film, wavelengths of light other than red light can be filtered out. Under red light settings, the camera can generate clearer images of the pallet with reduced or no glare. The images can be easier to analyze by the computing system, as described herein.

Using the polarizing filter, the LED light source, and the polarizing film can result in the camera capturing light having wavelengths between 620-650 nm. These wavelengths can be correspond to red light. Thus, the pallet can be imaged under red light settings, which can provide for easier and more accurate image analysis as performed by the computing system.

FIG. 2 depicts a perspective view of a photo booth 126 of the system 100 for profiling pallets in the warehouse environment 128. The photo booth 126 depicted in FIG. 2 is an example configuration. A variety of other configurations can be utilized, as described throughout this disclosure. The photo booth 126 can be made from a dark material (e.g., cloth) that may be used in other photography settings. The dark material can be advantageous to prevent ambient light from entering the enclosed area and/or obstructing the cameras 110A-N from capturing clear, uniformly lit images of a pallet.

As shown in the example configuration of FIG. 2, the photo booth 126 can enclose an area around the turntable 104. The booth 126 can be formed with two walls 126A and 12B. The wall 126A can include an opening 127 that a pallet can pass through when moving from the conveyor belt 102 onto the turntable 104. The wall 126B can include an opening 129 that the pallet passes through when moving from the turntable 104 to the off conveyor belt 106. The openings 127 and 129 may not be covered by materials, such as fabrics, plastic, flaps, or doors. In fact, the openings 127 and 129 can be sized to match a vertical height and a width of a largest pallet that may go through the photo booth 126, in some implementations. The openings 127 and 129 can otherwise be sized to match sizing of pallets that enter the photo booth 126. Thus, the size of the pallet can block out any light that may come through the openings 127 and 129 as the pallet rotates on the turntable 104. In some implementations, the booth 126 can also include a top portion that connects the walls 126A and 126B. The booth 126 can also include side walls such that the booth 126 can form a completely enclosed area around the turntable 104, thereby allowing no ambient light to enter the enclosed area.

In the example of FIG. 2, the vertical pole 108 can be positioned a set working distance away from the turntable 104 between the walls 126A and 126B. The cameras 110A-N can be vertically aligned along the pole 108. Moreover, lights 112A-N can be vertically aligned along the pole 108. The lights 112A-N can be offset from the cameras 110A-N to reduce or otherwise avoid glare in lens of the cameras 110A-N and to provide uniform lighting on the turntable 104.

FIG. 3A is a top view of an example configuration of a system 300 for profiling pallets in the warehouse environment 128. In this example, the off conveyor belt comprises belts 106A and 106B. The belt 106A can route a pallet to an organized storage location in the warehouse 128. The belt 106B can route the pallet to a temporary storage location in the warehouse 128. Moreover, in this example system 300, the photo booth 126 is a full enclosure around the turntable 104. The booth 126 has sides and a top to prevent ambient light from entering the full enclosure.

The booth includes a bar 134 positioned over and across a center of the turntable 104. The bar can include one or more overhead cameras 110A and one or more overhead lights 112A. The overhead camera 110A can be configured to capture images of a top of a pallet as it rotates on the turntable 104. The light 112A can also provide uniform lighting of the top of the pallet. The vertical pole 108 (e.g., frame, vertically oriented support structure) can include one or more cameras 110B-N and one or more lights 112B-N for capturing images of sides of the pallet as it rotates on the turntable 104. As depicted in this example, the cameras 110B-N and the lights 112B-N can be mounted to the pole 108 and oriented toward the turntable 104 (and pallet to be illuminated and imaged while on top of the turntable 104), resulting in the same or similar orientation and field of view/illumination 302 for the cameras 110B-N and lights 112B-N. The lights 112B-N can be mounted to the pole 108 in an arrangement so that they are vertically and/or horizontally spaced from the cameras 110B-N, and can be provided in any of a variety of ratios relative to the cameras 110B-N (e.g., each camera can have two lights around it to provide uniform lighting from perspectives of each camera). As mentioned above, the lights 112A-N can also be offset from the cameras 110A-N to minimize or otherwise avoid glare in the lens of the cameras 110A-N, as described in the examples below in FIGS. 3B-C.

FIG. 3B is a top view of another example configuration of a system 310 for profiling pallets in the warehouse environment 128. Like the other examples discussed above, the photo booth 126 can enclose an entire area around the turntable 104, and can include a top surface providing full enclosure of the area around the turntable 104 (and cameras 110A-N and lights 112A-N). Here, the vertical pole 108 includes the cameras 110A-C. The lights 112A-N can be attached to a separate vertical light support structures 109A-B (e.g., poles, post, structure) and laterally offset from the vertical pole 108 having the cameras 110A-N. The light support structures 109A-B can also be arranged at an angle and/or working distance that is different from the angle and/or working distance of the pole 108, which can result in the cameras 110A-N having a field of view 312 that is different from the field of illumination 314A-B for the lights 112A-N. The example system 310 can include a top down camera and lights (not depicted) that are located above the turntable 104, similar to the description above with regard to FIG. 3A. By offsetting the lights 112A-N to have fields of illumination 314A-B with different angles relative to the turntable 104 from the field of view 312 for the cameras 110A-N, the system 310 illuminate the turntable 104 while minimizing glare in the lens of the cameras 110A-N, which can increase the fidelity and clarity of images of pallets captured by the cameras 110A-N and, as a result, the accuracy of pallet profiling performed by the system 310.

FIG. 3C is a top view of another example configuration of a system 330 for profiling pallets in the warehouse environment. The system 330 is depicted with the photo booth 126, but it may be possible to use the system 330 without a photo booth. The system 330 further includes cameras 110A-N mounted on the vertical pole 108. The cameras 110A-N can be modularly mounted to the vertical pole 108 such that the cameras 110A-N can be moved up and down and/or left and right on the vertical pole 108. Changing camera positioning can be advantageous to accommodate different configurations of cameras 110A-N (i.e., different fields of view) and for capturing image data of different sized pallets. For example, when a shorter pallet is rotated on the turntable 104, the cameras 110A-N can be moved closer together on the vertical pole 108 and/or lower on the vertical pole 108. As another example, when a taller pallet is rotated on the turntable 104, the cameras 110A-N can be moved to have greater vertical distances between them along the pole 108 such that a top to a bottom of the pallet can be captured by the cameras 110A-N. Other variations and/or configurations of the camera 110A-N mounting on the pole 108 are also possible.

Lighting elements, 112A and 112B, are positioned at offset angles from the cameras 110A-N. Each of the lighting elements 112A and 112B, which can each include one or more individual lighting units (e.g., one or more light bars) can be mounted to light poles 109A and 109B, respectively. For example, two vertically oriented light bars can be mounted to each of the light poles 109A and 109B. In some implementations, one or more of the light poles 109A and 109B can have additional or fewer light bars mounted thereon. A quantity of light elements per pole 109A and 109B can be based on any of a variety of factors, such as camera settings, size of the pallet 122, one or more distances between the light poles 109A and 109B and the pallet 122, each other, and/or the cameras 110A-N, and/or one or more angles of the light poles 109A and 109B relative to the pallet 122 (discussed further below).

Although the lighting elements 112A-B are shown mounted to the poles 109A-B, they can alternatively be mounted to a frame of the photo booth 126.

The cameras 110A-N on the vertical pole 108 can be positioned a distance D₁ (342) from a front plane 334 of the pallet 122 that is facing and being imaged by the cameras 110A-N. The distance D₁ (342) can be selected based on a variety of factors, such as an expected size range for pallets 122 being imaged (e.g., height, width), a quantity of cameras 110A-N on the vertical pole 108, a type of camera lens used with the cameras 110A-N, and/or camera settings, such as field of view (FOV) 336 of the cameras 110A-N. The cameras 110A-N can be oriented toward the pallet 122 along a vertical plane 350 that bisects at or near the midpoint of the turntable 104 and/or pallet 122, and that extends in a substantially orthogonal direction from the turntable 104 and/or pallet 122. The FOV 336 can be oriented along the plane 350 and can have angle θₐ that can be selected in combination with the distance the D₁, to ensure that the entire pallet 122 can be captured by the cameras 110A-N. For example, the vertical pole 108 can be moved to different distances D₁ to accommodate for one or more changes to the system 330, such as cameras 110A-N being changed and the resulting angle θₐ for the FOV 336 changing.

Each of the lighting elements 112A and 112B can be positioned a distance D₂ (344) from the plane 334 of the pallet 122. The lights 112A and 112B can also be positioned a distance D₃ (346) in front of a plane 332 corresponding to the lens of the cameras 110A-N. In some instances, the lighting elements 112A-B can be positioned behind the plane 332, resulting in the distance D₂ being greater than the distance D₁. Each of the lighting elements 112A-B can also be positioned a distance D₄ (348) away and offset from the cameras 110A-N and the plane 350. The lights 112A and 112B can be oriented along planes 352A-B that are different from and offset from by plane 350 of the cameras 110A-N at angles θ_{b} and θ_{c} (340A-B), which can be the same or different for each of the lighting elements 112A-B. The angles θ_{b} and θ_{c} can be selected, for example, to provide for ample illumination for the cameras 110A-N to reliably capture clear images of the pallet 122 within the photo booth 126 while at the same time minimizing glare. The lighting elements 112A-B can have fields of illumination 338A-B that are oriented along the planes 352A-B with angles θ_{d} and θₑ across which light is emitted/cast by the lighting elements 112A-B. The positioning and angles of orientation for the lighting elements 112A-B can be offset from the position and orientation of the cameras 110A-N (e.g., offset distances D₃ and D₄, and offset angles θ_{b} and θ_{c}), which can assist in improving the quality of images captured by the cameras 110A-N (e.g., reducing glare in the images). The lighting elements 112A-B can be positioned to be outside of the FOV 336 for the cameras 110A-N, and to be distanced and oriented relative to the pallet 122 so that the fields of illumination 338A-B, either individually or collectively, adequately illuminate the entire width of the pallet 122. For example, each lighting element 112A-B can be positioned and oriented so that they each cast light across the entire width of the pallet 122 (based on their field of illumination 338A-B). In another example, each lighting element 112A-B can be positioned and oriented to only illuminate a portion of the width of the pallet 122 so that, collectively, they provide full illumination of the entire width of the pallet 122. The offset angles θ_{b} and θ_{c} (340A-B) based on the orientation 352A-B of the lighting elements 112A-B can be any of a variety of angles between 0° and 90°, such as 15°, 30°, 45°, 60°, 75°, less than 45°, greater than 45°, any of a variety of ranges (e.g., 1°-15°, 15°-30°, 30-45°, 45°-60°, 60°-75°, 75°-89°, or any combinations thereof), and/or other angles or ranges between 0° and 90°.

The lighting elements 112A-B can have the same field of illumination 338A-B, and same positioning and orientation reflected across and on opposing sides of the plane 350. For example, the distance D₄ can be equidistant for both the lights 112A and 112B. In other instances, one of the lights 112A can have a different field of illumination 338A, a different orientation 352A with a different angle 340A, and/or can have a shorter distance D₃ and/or D₄ away and offset from the cameras 110A-N than the other light 112B.

The distances D₂ and D₃ can be equal. For example, the lights 112A and 112B can be equidistant from both the plane 332 of the cameras 110A-N and the plane 334 of the pallet 122. In some instances, the distance D₂ can be greater than the distance D₃. In other instances, the distance D₃ can be greater than the distance D₂. Moreover, as described throughout, the lights 112A and 112B can readily be moved (e.g., backwards or forwards) and/or rotated at different angles.

The lighting elements 112A-B are depicted in FIG. 3C as being positioned outside of the width of pallet 122 (i.e., distance D₄ is greater than half of width of pallet 122), as indicated on one side by the plane 358, which can assist with increasing the angles 340A-B achieved and with reducing the potential glare for images captured by the cameras 110A-N. Alternatively, the lighting elements 112A-B can be positioned at or on the perimeter/width of the pallet 122 (i.e., distance D₄ is set to approximately half of width of pallet 122), and/or can be positioned inside of the perimeter/width of the pallet 122 (i.e., distance D₄ is less than half of width of pallet 122). Such adjustments of the lighting elements 112A-B at or inside of the plane 358 can permit, for example, for the dimensions of the photo booth 126 to be reduced and to be more compact.

The photo booth 126 can include openings 360 and 362 through which the pallet 122 can be received into the photo booth 126 for imaging via conveyor 102, and transported out of the photo booth 126 after imaging is completed via conveyor 106. The openings 360 and 362 can be sized and shaped so as to accommodate the maximum dimension for the pallet 122 within a threshold margin (e.g., 5% dimension margin, 10% dimension margin, 20% dimension margin) so as to minimize the amount of ambient light received through the openings 360 and 362 into the photo booth 126. Additionally, the dimensions and configuration of the photo booth 126 relative to the turntable 104, the conveyors 102/106, and the openings 360/362 can be configured to minimize a distance D₅ between the edge of the pallet 122 (plane 358) and the openings 360/362. By minimizing this distance D₅, the sides of the pallet 122 facing the openings 360 and 362 can serve to block much of the ambient light that would otherwise be received into the photo booth 126, and which could otherwise interfere with imaging of the pallet 122 by the cameras 110A-N. In some instances, the photo booth 126 can additionally include opaque light shields 366 and 368 adjacent to the openings 360 and 362 that can substantially fill a space between the pallet 122 and the openings 360 and 362 (i.e., span most, all, or more of distance D₅), to further block ambient light that is not blocked by the pallet 122 itself. The light shields 366/368 can extend a vertical span within the photo booth 126, such as the height of the pallet 122, the full height of the photo booth 126, and/or other vertical spans. The light shields 366/368 can be configured to block the ambient light without interfering with or otherwise contacting the pallet 122 on the conveyors 102/106, and/or the turntable 104. The light shields 366/368 can additionally be made of and/or coated with a non-reflective material or color, which can reduce inadvertent light reflections during the image capturing process.

Although the openings 360 and 362 are shown as overlapping the conveyors 102 and 106, respectively, so that the entirety of the turntable 104 is contained within the photo booth 126, other configurations are also possible, such as portions of the openings 360 and 362 overlapping portions of the turntable 104 while still permitting for full rotation of the pallet 122 without obstruction/contact between the walls of the openings 360/362 and the pallet 122. Such a configuration could further reduce the distance D₅ and also reduce the ambient light received into the photo booth 126 via the openings 360/362. The photo booth 126 is configured in the depicted example without doors at the openings 360 and 362, which can help to increase throughput of pallets via the system 330 by not having to wait for delays associated with opening and closing doors, and can also make the system 330 more robust by reduces potential points of failure (e.g., failure from automated doors malfunctioning/breaking). In some instances, though, the photo booth 126 may be configured to include automated doors at the openings 360 and 362 that can additionally shield ambient light from entering the photo booth 126.

Also depicted in FIG. 3C is an example overhead camera 370 and overhead lighting elements 372A-B, which can be mounted to and suspended from a top surface/ceiling of the photo booth 126. The overhead camera 370 can be considered to be part of the cameras 110A-N, and can be centered over the pallet 122 and/or turntable 104. Although one overhead camera 370 is depicted, more than one overhead camera can be used and spaced apart so as to cover the top surface of the pallet 122, such as with the cameras 110A-N mounted to the post 108. The overhead lighting elements 372A-B can be spaced apart and offset from the camera 370, similar to the cameras 112A-B with regard to the cameras 110A-N. The lighting elements 372A-B may be mounted to a common mounting structure as the camera 370, and may have the same distance from the top surface of the pallet 122 and the same orientations as the camera 370. Alternatively, the discussion above with regard to positioning and orienting the lighting elements 112A-B to be offset from the cameras 110A-N can apply to the overhead lighting elements 372A-B with regard to the overhead camera 370.

Any of a variety of lighting elements and lighting settings can be used for the lights 112A-B and 372A-B. For example, the lights 112A-B and 372A-B can be configured to emit light within the visible spectrum, such as monochromatic light within the visible spectrum (i.e., red light with a wavelength between 610 nm-750 nm, orange light with a wavelength between 595 nm-610 nm, yellow light with a wavelength between 580 nm-595 nm, and/or others) and/or polychromatic light combining multiple different wavelengths (e.g., “white” light combining light from the visible spectrum, other combinations of polychromatic light). For example, the lights 112A-B and 372A-B can be configured to emit red light with a wavelength of approximately 610 nm, 615 nm, 625 nm, 650 nm, 675 nm, 700 nm, 725 nm, 750 nm, and/or other variations of red light. The lights 112A-B and 372A-B may additionally and/or alternatively be configured to emit light outside of the visible spectrum, such as infrared light (e.g., wavelength above 750 nm), ultraviolet light (e.g., between 100 nm and 400 nm), and/or other portions of the non-visible spectrum. The lights 112A-B and 372A-B can emit light in pulses and/or strobes that coincide with images being captured by the cameras 110A-N and 370. For example, the pulse duration may include, for example, 50 μs, 100 μs, 200 μs, 250 μs, 500 μs, 750 μs, 1 ms, 2 ms, 5 ms, 25 ms, 50 ms, 100 ms, 500 ms, 750 ms, 0.01 s, 0.05 s, 0.10 s, 0.5 s, 0.75 s, 1.0 s, 1.5 s, and/or other durations. The shutter speed used by the cameras 110A-N and 370 can correspond to (or be shorter or longer than) the pulse duration used for the lights 112A-B and 372A-B, such as being the same as the pulse duration. The cameras 110A-N and 370 can use any of a variety of aperture settings, such as f/2, f/4, f/6, f/8, f/12, f/16, f/22, and/or other aperture settings. The greater the f-stop number (i.e., “f/8”) the smaller the aperture, the less light that is let into the camera's image sensors, and the greater the depth of field for the image captured (i.e., the more items of varying depths that are captured in focus). The converse is true for smaller f-stop numbers. The aperture settings and/or shutter speed can be selected to reliably capture clear images of the pallet 122 (i.e., images with contents of pallet 122 that are in focus and without blurring/glare) based on, for example, any one or more of the distances D₁, D₂, D₃, and D₄ as well as the angles 340A and 340B of the lights 112A and 112B.

The cameras 110A-N can be positioned at least a threshold distance away from the pallet 122 and the turntable 104, such as being positioned such that the distance D₁ is at least 0.5 m, 0.75 m, 1.0 m, 1.2 m, 1.4 m, 1.5 m, 1.7 m, 1.8 m, 2 m, and/or other threshold distances away. Such greater distances may, for example, permit for the cameras 110A-N to capture images of the entire surface of the pallet 122 facing the cameras 110A-N with camera settings (i.e., aperture, shutter speed) that provide for greater image reliability and usability across a group of pallets that will vary in their size, shape, makeup, condition, materials, and/or other details. For example, a mid-level aperture (e.g., f/6, f/8, f/11) can be used to permit for a faster shutter speed (e.g., μs, 100 μs, 200 μs, 250 μs, 500 μs) to be used while also capturing images with a greater depth of field (i.e., greater range of depth away from camera is captured in focus).

For high contrast imaging, which can provide for better machine vision and automated analysis, the lights 112A-B and 372A-B can illuminate the turntable 104 and pallet 122 with a single wavelength (e.g., red light instead of white light). For example, red lighting elements and/or red light filters can be applied to the lights 112A-B and 372A-B to reject all other wavelengths but red, thereby emitting monochromatic light that may bring into focus details of interest, such as labels, barcodes, and other product identifiers. Such red lights can, for example, be advantageous to avoid glare that might occur from the lighting reflecting on plastic wrap or other parts of the pallet and items thereon, and/or to remove ambient lighting that otherwise can interfere with details in an image. In one example, the lights 112A-B and 372A-B can be red light-emitting diodes (LEDs) with any of a variety of configurations, such as being 225 mm in length, positioned approximately 1.7 m (e.g., 67 in) away from the turntable 104, and having a 45 degree emission angle with an approximate light coverage of 1.4 m (field of illumination). When the emission angles are sharp enough with respect to FOVs of the cameras 110A-N and 370, glare can be avoided or otherwise mitigates in the lens of the cameras 110A-C. While polarizers can be used for the lights 112A-B and 372A-B and/or for the cameras 110A-N and/or 370, they may not be needed with the lights 112A-B and 372A-B having greater angles relative to the orientation of the cameras 110A-N and/or 370. With the configurations described herein, the cameras 110A-C can use any of a variety of lens lengths, such as a 35 mm lens length, and/or any of a variety of focal lengths, such as f/4. The lights 112A-B and 372A-B can also be flood lights that can be, for example, approximately 330 mm in length. In some configurations, the r lights 112A-B and 372A-B can be strobe lights that are placed in front of the pallet 120. The cameras 110A-C can also have polarizers and/or wide angle lens. The lights 112A-B and 372A-B can have a 10 dB gain, and/or other dB of gain. The cameras 110A-N and 370 can be set to any of a variety of exposure lengths (e.g., 0.5 s-5.0 ms) and/or with a bandpass filter (e.g., 600 nm bandpass filter, 630 nm bandpass filter, 800 nm bandpass filter).

A bandpass filter can also be applied to the cameras 110A-N and/or 370 to reduce different types of wavelengths that are captured by the cameras 110A-N and/or 370. The bandpass filter can be advantageous, for example, with high contrast imaging techniques, such as black and white imaging techniques. Such filters can provide for illuminating sensors of the cameras 110A-N and/or 370 to capture clearer, sharper images of a pallet on the turntable 104. Polarizing optics can also be applied to the lights 112A-B and/or 372A-B, and/or the cameras 110A-N and/or 370. Polarizing optics can help reduce or eliminate glare from the wrappings on the pallets. Polarizing optics can also improve contrast of labels, such as barcodes.

Any one or more of the systems 300, 310, and 330 in FIGS. 3A-C can be combined to perform the techniques described herein. Moreover, FIGS. 3A-C depict example configurations of the photo booth 126. The photo booth 126 can include one or more other alternative implementations, as described throughout this disclosure.

FIG. 4A depicts a camera configuration for profiling pallets. In this example, a structure 400 can have the cameras 110A-C aligned on horizontal poles 136A, 136B, and 136C, respectively. Two lights can be horizontally positioned below each of the cameras 110A-C. In some implementations, one light can be horizontally positioned above a camera and one light can be horizontally positioned below the camera. As show, lights 112A-B are horizontally positioned below the camera 110A, lights 112C-D are horizontally positioned below the camera 110B, and lights 112E-F are horizontally positioned below the camera 110C. In some implementations, the lights 112A-F may not be on the structure 400. Instead, as depicted in FIGS. 4C-E, the lights 112A-F can be positioned on a separate vertical pole structure than the structure 400. Moreover, in some implementations, the lights 112A-F can be attached to a frame of a photo booth structure that can enclose an area where a pallet is imaged, as described herein.

The cameras 110A-C can be set to one or more different configurations. For example, 65 MP cameras can be used. 65 MP cameras can have a 65 MP sensor with 9344×7000 resolution. Using 18 mm lens, the cameras can be positioned 1 m away from the turntable (e.g., working distance). The cameras can have FOVs of 1.661 m×1.244 m, thereby capturing 2.81 pixels of a pallet label per 0.5 mm. If the cameras are positioned 1.5 m away, the FOVs can be 2.491 m×1.244 m. If the cameras are positioned 1.7 m away, as described throughout this disclosure, the cameras can have FOVs of 2.823 m×. 2.115 m, thereby capturing 1.65 pixels of the pallet label per 0.5 mm. Using 21 mm lens, the cameras can be positioned 2 m away from the turntable. The FOVs can be 2.847 m×2.133 m, thereby capturing 1.65 pixels of the pallet label per 0.5 mm.

As another example, 127 MP cameras can be used. 127 MP cameras can have a 127.6 MP sensor and 13400×9528 resolution. Thus, such cameras can generate high resolution images and/or be placed at farther working distances from the turntable than 65 MP cameras. Using 55 mm lens, the cameras can be positioned 3.5 m away from the turntable. The cameras can have FOVs of 2.941 m×2.091 m, thereby capturing 2.28 pixels of the product label per 0.5 mm. When the cameras are positioned 1.7 m away, the FOVs can be 1.47 m×1.05 m, thereby capturing 4.56 pixels of the product label per 0.5 mm. Using 21 mm lens, the cameras can be positioned 1.5 m away from the turntable. The cameras can therefore have FOVs of 2.135 m×1.6 m. When the cameras are positioned 2 m away, the FOVs can be 2.847 m×2.133 m. Thus, the cameras can capture 1.65 pixels of the product label per 0.5 mm.

FIG. 4B depicts a camera configuration for profiling pallets. In this example configuration of the pole 108, three cameras 110A, 110B, and 110C can be positioned vertically along the pole 108. As described herein, the cameras 110A-C can be moved up and down and/or left and right on the pole 108. Placement of the cameras 110A-C can depend on a working distance of the pole 108 from the turntable described herein. Placement of the cameras 110A-C can also depend on size of a pallet being imaged and/or placement, positioning, and/or distances of one or more separate lighting structures, as described throughout this disclosure. The pole 108 can also include light bars (e.g., strobe lights) 112A-B that are vertically along the vertical pole 108. As shown, the light bar 112A can be positioned between the camera 110A and the camera 110B. The light bar 112B can be positioned between the camera 110B and the camera 110C. One or more additional or fewer light bars can be positioned along the vertical pole 108. Moreover, as described in reference to FIGS. 4C-E, one or more light bars can be positioned along a separate vertical pole that can be offset and positioned a certain distance away from the cameras 110A-C. The lights 112A-B can be positioned around the cameras 110A-C as shown in FIG. 4B to provide uniform lighting for FOVs of the cameras 110A-C.

As described in reference to FIG. 3C, one or more of the lights 112A-F can be red lights. Moreover, red filters or bandpass filters can be applied to the cameras 110A-C as described herein.

In some implementations, one or more of the cameras 110A-C can be tilted at certain angles. For example, one of the cameras 110A-C can be tilted at a 30 degree angle. One or more or all of the cameras 110A-C can be tilted at 90 degree angles. In some implementations, the cameras 110A-C can also be positioned at varying heights along the vertical pole 108.

In some implementations, the pole may have only two cameras, 110A-B. The cameras 110A-B can have 65 MP sensors. The cameras 110A-B can have 1.375 m×1.22 m FOVs with 33 mm lens. When the pole 108 is placed a working distance of 1.9 m from the turntable, the cameras 110A-B can have FOVs of 1.6 m×1.22 m. Pallet label dimensions from this working distance can be 2.86 pixels per 0.5 mm. When the pole 108 is placed a working distance of 1.7 m from the turntable, the cameras 110A-B can have FOVs of 1.45 m×1.09 m

FIGS. 4C-E depicts another camera and lighting configuration for profiling profiles, with FIG. 4C showing a perspective view, FIG. 4D showing a front view (from the perspective of the turntable and/or pallet being imaged), and FIG. 4E showing a side view. In this example, the vertical profiling structure 400 (e.g., the vertical pole 108 described throughout) includes 3 cameras 110A-C. The cameras 110A-C can be mounted along the horizontal mounting structures 136A-C, as described in reference to FIG. 4A. In this example, vertical light mounting structures 410A-B (e.g., the light pole 109 described throughout) can be positioned and offset at distances D₃ (346) and D₄ (348) from the vertical profiling structure 400, as described above with regard to FIG. 3C. The vertical structures 410A-B can each include two light bars 112A-112B and 112C-D that can be vertically aligned along the vertical structures 410A-B. In some implementations, the light bars 112A-D can be affixed at positions along the vertical structures 410A-B so that they span the height of the pallet when it is positioned on top of the turntable 104 and/or the conveyors 102/106. As a result, the light bars 112A-D can provide light along an entire vertical height of a tallest pallet. As an illustrative example, if the biggest pallet is 49 inches tall, then the vertical structure can be 48-50 inches tall such that the light bars 112A-D positioned thereon can provide uniform lighting from a top to a bottom of the pallet.

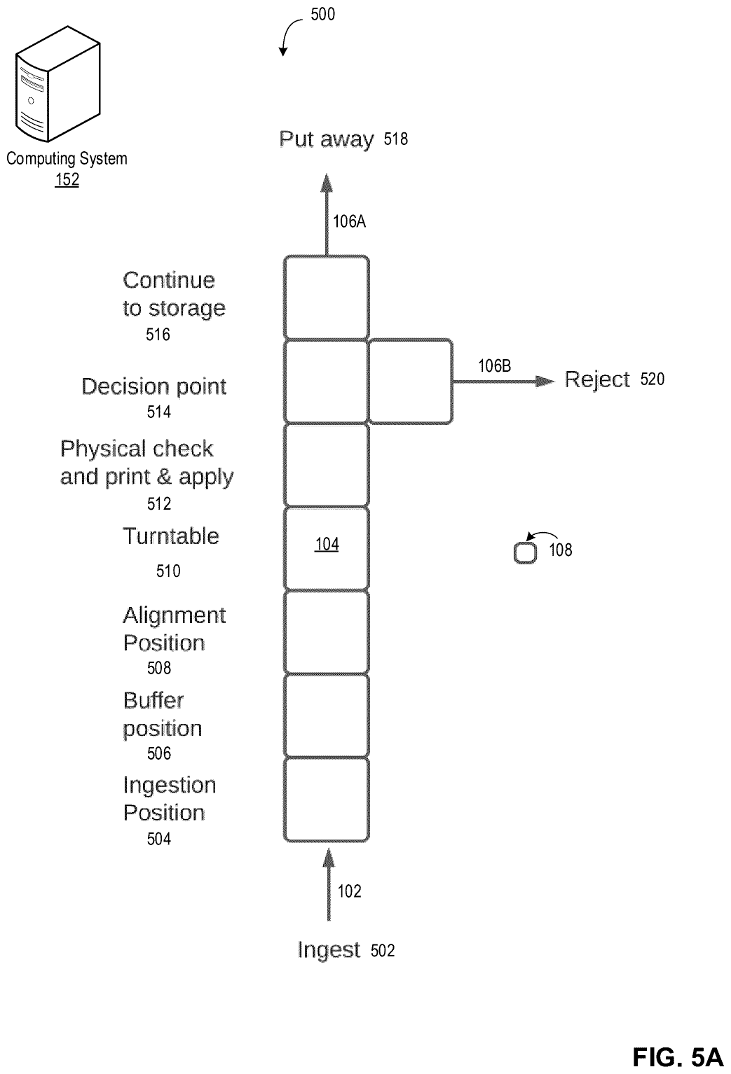

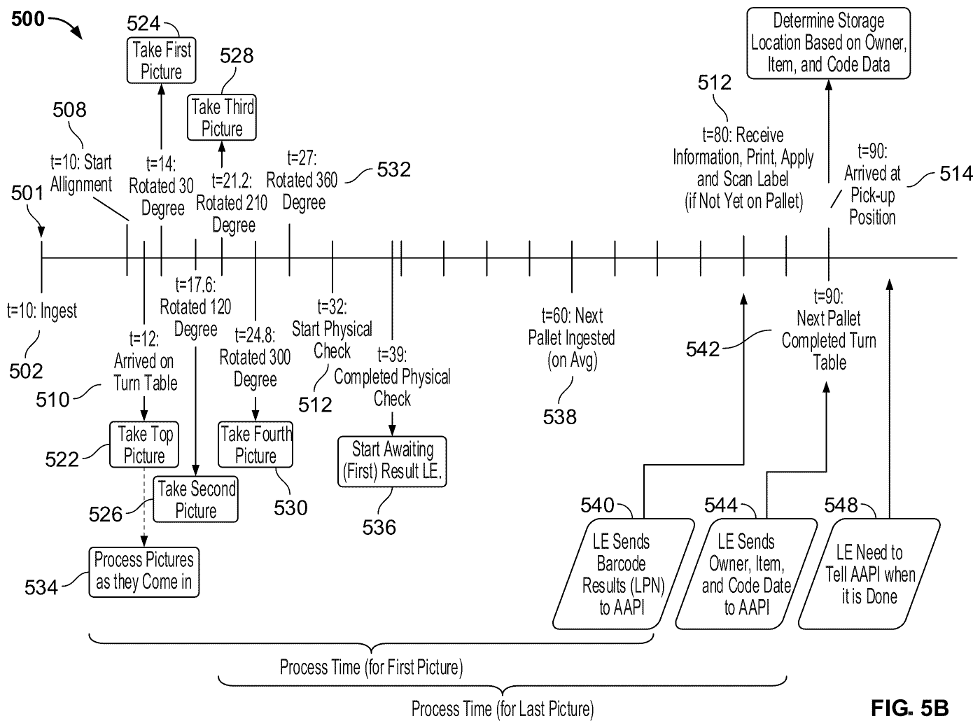

FIG. 5A is a block diagram of a process 500 for profiling a pallet using the techniques described herein. FIG. 5B is a timeline 501 of the process 500. The timings described in FIG. 5B are merely illustrative examples and are not intended to be limiting. Due to varying physical layouts of warehouses, one or more of the timings described in FIG. 5B can be different, such as longer or shorter than the times illustrated in the timeline 501. One or more blocks of the process 500 can be performed by the computing system 152. The process 500 can also be performed by one or more other computing systems, computers, servers, remote servers, and/or computing devices. For simplicity and illustrative purposes, the process 500 is described from the perspective of the computing system 152.

Referring to the process 500 in both FIGS. 5A-B, a pallet can be ingested (502) at an ingestion position 504. As described throughout this disclosure, the pallet can be put on the on conveyor belt 102. As soon as the pallet is ingested (502), the computing system 152 can start a clock or timer. The clock or timer can operate in seconds. In some implementations, the clock or timer can operate in milliseconds.

For a predetermined length of the conveyor belt 102, the pallet can be in a buffer position 506. The buffer position 506 can provide a window of time for one or more of the components described herein to reset and/or for computational resources to be reallocated such that the components can be ready to profile the pallet.

At an alignment position 508, the pallet can be aligned or otherwise straightened on the conveyor belt 102. As a result, the pallet can enter the turntable 104 at a turntable position 510 without being angled in a particular direction. Alignment devices (e.g., refer to FIG. 1B) can be positioned along sides the conveyor belt 102 at the alignment position 508. Such devices can align or straighten the pallet on the conveyor belt 102. Alignment can start after the buffer position 506, at a time of t=10 seconds.

Once aligned, the pallet can be routed onto the turntable 104. In the turntable position 510, cameras on the vertical pole 108 can capture images of the pallet as it is rotated. The pallet can arrive at the turntable position at t=12 seconds. At this point, a top picture of the pallet can be taken (522). As the pallet is rotated, additional pictures of different sides of the pallet can be captured. For example, at time=14, the pallet can be rotated 30 degrees and a first side picture can be taken of the pallet (524). At t=17.6, the pallet can be rotated 120 degrees and a second side picture can be taken (526). At t=21.2, the pallet can be rotated 210 degrees and a third side picture can be taken (528). At t=24.8, the pallet can be rotated 300 degrees and a fourth side picture can be taken (530). By t=27 seconds, the pallet can be rotated a full 360 degrees (532). The captured pictures can be transmitted to the computing system 152 and processed as they are received by the computing system 152 (534). In some implementations, the images can be processed once all of the images of the pallet are captured (e.g., by t=27 seconds, once the pallet has been fully rotated and images of every side of the pallet have been captured). The point at which a first picture of the pallet is processed can begin a timer indicating a processing time of that picture. For example, as depicted in the timeline 501, the first picture can be processed beginning at t=12 seconds and can complete processing by t=80 seconds. As another example, the last picture can be processed beginning at t=24.8 seconds (e.g., when the picture is captured) and can complete processing by t=90 seconds. Processing of pictures individually and/or together can be completed in one or more different timeframes based on computational resources that are available and processing power.

It should be realized that additional pictures can be taken of the pallet during a full rotation. It should also be realized that pictures can be taken at different intervals of degrees. For example, a first picture can be taken at a 30 degree interval. Subsequent pictures can then be captured at 90 degree offsets until the pallet completes a full rotation. As another example, each of the images can be captured at 90 degree offsets until the pallet completes a full rotation.

Still referring to the process 500 in FIGS. 5A-B, a physical check and print & apply can be performed (512) after the pictures of the pallet are captured and being processed. The physical check of the pallet can begin, for example, at t=32 seconds. The physical check can be performed by one or more automated warehouse devices. The devices can be configured to review the pallet and ensure that it can be safely put in a location in the warehouse. For example, the devices can check whether wooden boards of the pallet are damaged and/or whether the pallet has a lean. Damage and/or lean can comprise an ability to safely move the pallet throughout the warehouse and also to store the pallet therein.

In some implementations, the physical check can be completed by t=39 seconds. The physical check can take longer or less time, depending on a size of the pallet and/or items that are being reviewed during the physical check. Moreover, at t=39 seconds, results for processing the first picture can start to be expected (536). The results can also be expected any time before or after t=39 seconds.

In some implementations, the physical check may not be performed. Rather, the images captured as the pallet is rotated on the turntable can be processed to determine whether the pallet is physically sound to be safely routed to a storage location in the warehouse. For example, the computing system 152 can perform image processing techniques to identify a potential lean of cases on the pallet, gaps or chimney stacks between cases on the pallet, damages cases, and/or damage to the wooden boards of the pallet. Based on this image processing, if the computing system 152 determines that the pallet is physically sound (e.g., the pallet has no lean or a lean that is less than a threshold lean value, the pallet has no gaps or one or more gaps that are less than a threshold gap size, the pallet has no damaged cases or less than a threshold quantity of damaged cases, the pallet has no damaged wooden boards or less than a threshold quantity or severity of damaged wooden boards), then the pallet can be routed to the storage location in the warehouse.

Another pallet can be ingested at approximately t=60 seconds (538). On average, a new pallet can be ingested (502) every minute. One or more other timeframes can be used for ingesting pallets and profiling such pallets in the process 500.

The computing system 152 can also perform the print & apply process in 512. This process can occur at a later time, such as t=80 seconds. The print & apply process can, for example, be performed only upon the computing system 152 determining that a pallet label cannot be identified from the pictures/images of the pallet that are processed. The computing system 152 can thus receive or determine barcode results (540). This can include applying image processing techniques to the pictures to determine whether the barcode or other unique identifier, such as the label described herein, can be identified from any of the pictures.

The print & apply process can include checking whether the label is in an exact position on the pallet that is preferred or otherwise required by the warehouse for storage. Therefore, even if the computing system 152 can identify the label from the images, the label may still be in an undesirable position/location on the pallet. Thus, the computing system can print a copy of the identified label and the printed copy can be applied to the pallet in the desired, exact position. The label can be required to be in the exact position to facilitate faster and accurate scanning of the label to identify the pallet and move the pallet around the warehouse.

If the label is identified and it is in the exact, desired position, then the computing system 152 may not have to generate, print, and apply a new label. If, on the other hand, the label cannot be identified, then the computing system 152 can automatically generate a label as a placeholder. The generated label can be assigned to the pallet, printed, and then automatically attached to the pallet in the exact, desired position. The label can be attached to the pallet by an automated warehouse device.

In some implementations, the print and apply process can additionally or alternatively be performed for one or more cases on the pallet. For example, by processing the image data of the pallet, the computing system 152 can determine whether labels for each of the cases on the pallet are identifiable and/or viewable. If a label for a case is not identifiable and/or not viewable, then the computing system 152 can generate instructions to generate, print, and apply a placeholder label for the particular case, similarly as described above in reference to the label for the entire pallet.

At t=90 seconds, the pallet can be moved to a decision point 514. At the decision point 514, the computing system 152 can determine where the pallet can be routed in the warehouse. Thus, the computing system 152 can determine a storage location of the pallet (546). The computing system 152 can determine the storage location based on receiving (e.g., from a WMS) or retrieving (e.g., from a pallet profiles data store) information associated with the pallet (544). The information can include owner information, item information, and a code date.

At this point, the computing system 152 can determine whether the label was accurately identified in the pictures. If, for example, the label was accurately identified and in the exact, desired position or the label was accurately identified but not in the exact desired position, then the computing system 152 can still determine that the label was accurately identified. The pallet can be routed to continue to storage (516) along the conveyor belt 106A, such as a long-term storage location in the warehouse. Thus, the pallet can be put away (518) in an organized storage location.

At this point, the computing system 152 can additionally or alternatively determine whether the pallet is physically sound to be safely routed to storage. For example, the computing system 152 can process the pictures of the pallet to identify potential damage, lean, and/or gaps in the pallet and the cases stacked thereon. If the computing system 152 identifies damage, lean, and/or gaps that do not satisfy threshold safety criteria, the computing system 152 can determine that the pallet is not physically sound to be routed to storage. The pallet can accordingly be rejected (52) and transmitted to another location, such as a checking station, to be manually reviewed/inspected by a warehouse worker.

Furthermore, at this point, the computing system 152 may or may not have identified additional information about the pallet from the pictures/image data. The computing system 152 can identify the additional information at any time between receiving the pictures/image data of the pallet, routing the pallet to the organized storage location, and/or once the pallet is stored at the organized storage location. Thus, the pallet can be routed to the organized storage location for put away (516) even if additional characteristics about the pallet have not yet been identified. As a result, warehouse efficiency can improve and the computing system 152 can continue to identify other pallets as they are ingested (502). Similarly, any of the additional information about the pallet can be determined using remote computing systems while the pallet is being routed for put away (516). Available compute resources on the edge, such as the processing power of the computing system 152, can therefore be leveraged for performing immediate processes such as identifying a pallet label so that the pallet can be quickly and efficiently ingested and routed to storage.

Referring back to the decision point 514, the organized storage location can be selected by the computing system 152 based on the pallet information that was received, accessed, or retrieved (544). For example, the pallet information can indicate a particular storage location where all pallets of this same owner are to be stored. The pallet information can also indicate storage conditions that must be met for the pallet (e.g., the pallet must be stored in a cold storage area). The computing system 152 can also use the pallet information to automatically determine an optimal storage location for the pallet (e.g., height information about the pallet can limit locations where the pallet can be stored while optimizing on available space in the warehouse).

As another example, if the label was not accurately identified (e.g., the label is on the pallet but the label cannot be read from the pictures of the pallet) or a label had been generated for the pallet as a placeholder (e.g., none of the pictures indicate that a label is present on the pallet), then the computing system 152 can determine at the decision point 514 that the pallet is rejected (520). A rejected pallet is one that cannot be routed for put away (516) to an organized storage location. After all, it is uncertain where the pallet is supposed to be stored in the warehouse. The pallet can be routed down the off conveyor belt 106B to a temporary storage location, such as a checking station. As described further below, once in temporary storage, the pallet can be manually inspected by a warehouse worker to identify the label or other characteristics about the pallet and/or cases stacked thereon that can then be used to determine an organized storage location for the pallet (or otherwise used to profile the pallet). Once in temporary storage, the warehouse worker can also determine the organized storage location for the pallet based on analyzing the pictures that were captured and previously processed by the computing system 152. In some implementations, the pallet can be automatically inspected by one or more warehouse devices once in temporary storage.

At time=90 seconds, the second pallet that was ingested at t=60 seconds, can be completed a full rotation on the turntable 104 (542). At some later time in the timeline 501, the computing system 152 can determine when images are no longer being captured of a pallet and/or no more pallets are being ingested (548). The computing system 152 can also stop the clock or timer at this point. As described throughout this disclosure, the process 500 can be performed for each pallet that is entering the warehouse.

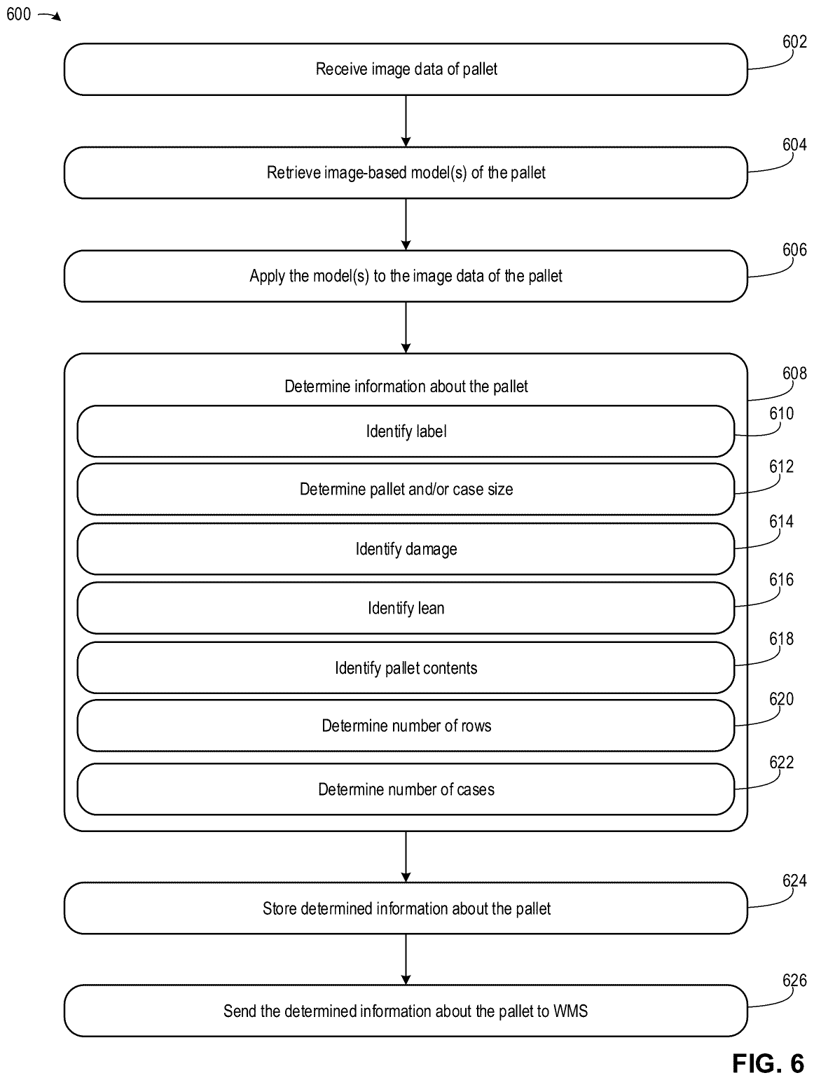

FIG. 6 is a flowchart of a process 600 for identifying pallet information from image data of a pallet. One or more blocks in the process 700 can be performed by the computing system 152. The process 600 can also be performed by one or more other computing systems, computers, servers, remote servers, and/or computing devices. For simplicity and illustrative purposes, the process 600 is described from the perspective of a computing system.

Referring to the process 600, the computing system can receive image data of a pallet in block 602. Sometimes, the process 600 can be performed while images are being captured of the pallet and transmitted to the computing system. In some implementations, the process 600 can be performed during different stages of profiling the pallet, as described in reference to FIGS. 5A-B (e.g., once all the images are captured and transmitted to the computing system, during physical check and print & apply 512, the decision point 514, between times t=12 seconds and t=90 seconds, etc.).

The computing system can retrieve image-based models of the pallet (block 604). The image-based models can be stored in a pallet profile data store. The models can also be stored in one or more other data stores, databases, cloud servers, or other remote data stores and/or servers. The models can be trained using machine learning techniques. The models can be trained to identify different characteristics of the pallet and cases on the pallet from the image data. The models can be generated using different training sets of data. The models can also be trained and/or refined using image data and analysis that was performed in real-time to profile different pallets. The computing system can retrieve the model(s) once (when a first pallet comes into the warehouse, when the process 600 starts, etc.) rather than every time that a new pallet enters the warehouse and/or needs to be profiled.

The computing system can apply one or more of the models to the image data of the pallet in block 606. Sometimes, processing the image data in block 606 can include stitching together one or more images that were captured of the pallet from different angles. Sometimes, processing the image data in block 606 can include evaluating the images independently and selecting a best image. As described herein, a plurality of images can be taken of the pallet, such as when the pallet rotates on a turntable. Pictures can be captured of the pallet at 90 degrees, for example, then +−a delta (e.g., 3 images per side, delta can be approximate 5 degrees). Delta and a number of images per side can both be variables, which can be configured based on a facility, a configuration of a profiling station, a size of a pallet, or other pallet specific information. Using the disclosed technology, components in the facility can be instructed (e.g., by the computing system, by one or more other control systems described herein) to rotate the pallet at least based in part on the delta and other components can be instructed to capture images of the pallet at least based in part on the number of images per side. Sometimes, the computing system does not need to stitch together all the images, the computing system simply needs to obtain results, such as a clear depiction and reading of a barcode on the pallet. Each image can be processed and evaluated independently to determine confidence of reading pallet information, such as the barcode. If the barcode is readable in all images with high confidence (e.g., a confidence level exceeding a threshold value), then the computing system can select the image having the highest confidence, or where the barcode is most readable. If only some of the images have high confidence for reading the barcode or otherwise are consistent with each other for identifying/reading the barcode, then the computing system can select those images and identify from among those images an image to use for further processing described herein (e.g., the computing system can select any of those images from random, the computing system can select the image having the highest confidence, the computing system can select the image using checksums). The computing system can utilize checksums to determine which image to select that has a best view of the barcode (or other desired pallet information/results from the imaging). For example, the computing system can select the best image amongst the images based on identifying checksums of the images that satisfy one or more checksum rules.

By applying the models to the image data of the pallet, the computing system can determine information about the pallet in block 608. For example, a label, unique identifier, or other encoded information for the pallet can be identified (block 610). The label can be identified using machine learning trained models and/or optical character recognition (OCR) techniques. OCR techniques can also be used to detect any text that may appear on the pallet. The text and/or label can be further processed (e.g., using machine learning trained models) to identify additional information about the pallet, such as a pallet name, owner information, and an organized storage location for the pallet. Block 610 can also be performed to identify encoded information about one or more cases on the pallet, as described in reference to FIGS. 1C, 2, and 7A-C.

In block 610, the computing system can determine whether the label is identifiable. If the label is identifiable, the computing system can transmit a notification to the WMS or another computing system to determine a long-term storage location for the pallet. The WMS can access a data store to determine where the identified pallet (e.g., based on a customer code, identified owner, etc.) can be stored. The WMS can generate control instructions to automatically move the pallet to the identified storage location. In some implementations, the computing system can determine the storage location for the pallet. Moreover, the computing system and/or the WMS can determine control instructions for automatically routing the pallet to the determined storage location along one or more conveyor belts in the warehouse. If the label is not identifiable, the computing system can transmit a notification to the WMS that further identification of the pallet may be required (e.g., manual review of the label on the pallet to be performed by a human worker in the warehouse). The same label identification process can be performed for labels on cases that are stacked on the pallet. If the label is not identifiable on the pallet, the computing system or the WMS can generate control instructions to automatically route the pallet to a temporary storage location for manual inspection. Sometimes, the computing system and/or the WMS can provide the image data of the pallet to a user device of the warehouse worker. The user device can output the image data at a graphical user interface (GUI) display. The warehouse worker can then review the image data and/or manually inspect the pallet in the temporary storage location in order to identify one or more features or information about the pallet, such as the label.

A size of the pallet and/or a size of one or more cases on the pallet can also be determined in block 612. Since the image data is captured from a uniform offset degree (e.g., 90 degrees), height, and working distance, the computing system can more efficiently and accurately identify information such as pallet height, width, length, and/or depth. Likewise, the computing system can determine height, width, and/or depth of at least one case on the pallet. Using the determined size information about the at least one case and/or the pallet as a whole, the computing system can measure how the cases are stacked on the pallet and decide, as an illustrative example, if the pallet is suitable for layer picking. A machine learning model can be trained to differentiate and identify pixels indicative of a background from pixels indicative of the pallet. The computing system can use known distance information, such as the working distance, and the pixels indicative of the pallet to infer dimensions of the pallet. Height, for example, can be inferred by triangulating pixels from multiple images, wherein those pixels represent a side and a top of the pallet. One or more other computing systems may additionally or alternatively determine height, width, length, and/or depth or other size measurements of the pallet and/or at least one case on the pallet.

The computing system can also identify damage to the pallet in block 614. A model can be trained using machine learning to identify the damage. For example, the model can receive images of pallets with damage and images of pallets without damage. Machine learning techniques and algorithms can be used on the images to determine probabilities that certain features in the test image datasets are indicative of damage. This trained model can then be applied to the image data to identify whether damage appears in any of the image data of the pallet. The model(s) can also be used to identify damage to one or more cases on the pallet, as described in reference to FIGS. 9A-C.

Similarly, a lean of the pallet can be identified in block 616. The lean of the pallet can be identified with models that are trained using machine learning techniques as described in reference to the models that are used for detecting damage.

Contents of the pallet can be identified in block 618. This can include retrieving or otherwise accessing pre-identified information about the pallet, which can indicate what the contents should be for the particular pallet. Machine learning techniques can also be used to determine the contents of the pallet.

Moreover, the computing system can determine a number of rows on the pallet in block 620 and a number of cases on the pallet in block 622. As described herein, machine learning trained models or other computer vision models can be used. The models can be used, for example, to count a number of rows on the pallet as well as a total quantity of cases on the pallet. The models may also be used to discern how many cases are likely interior to an exterior row of cases on the pallet. As a result, the computing system can determine or otherwise approximate a total quantity of cases on the pallet and other identifying information about the pallet and its contents stacked thereon. The computing system can determine the case quantity using top down image data of the cases stacked on the pallet. Additionally or alternatively, the computing system can determine the case quantity using one or more side view image data of the cases stacked on the pallet. Multiplication or other rules, algorithms, and/or formulas may be used to combine values (e.g., counts of visible cases) for each view point of the pallet (e.g. the top down image data and the side view image data) to then determine the total quantity of cases on the pallet.

Any of blocks 612-622 can be performed in combination. In some examples, only one or fewer than all the blocks 612-622 can be performed. Moreover, blocks 612-622 can be performed in any order. In some implementations, some of the blocks 612-622 may be performed in real-time, as the image data is captured of the pallet and/or before the pallet is routed to a storage location in the warehouse environment or other storage facility. For example, blocks 610 and 614 can be performed to identify the pallet and determine whether the pallet has damage that may cause the pallet to be dangerous during transit throughout the warehouse environment. The other blocks 612, 616, 618, 620, and 622 can then be performed at one or more later times, such as when the pallet is being routed to a designated storage location and/or once the pallet is placed in its designated storage location. The other blocks 612, 616, 618, 620, and 622 can then be performed using compute resources that are available at a remote computing system, thereby leaving available resources and network bandwidth on the edge for immediate profiling operations to ingest the pallet efficiently into the warehouse environment.

Still referring to the process 600, the computing system can store the determined information about the pallet (block 624). The information can be stored in a profile associated with the pallet. The association can be made based on the identified label or other unique identifier or encoded information about the pallet. As mentioned in reference to FIGS. 5A-B, if the label cannot be identified for the pallet, then a placeholder label can be generated for the pallet. The placeholder label can then be linked or associated with a new profile for the pallet, which can be populated with pallet information that is determined automatically by the computing system and/or manually by a warehouse worker.

The determined pallet information can also be sent to the WMS described herein (block 726). The WMS can accordingly update the pallet profile with information that is determined by the computing system in blocks 608-622. The WMS can also use the determined pallet information to move the pallet in the warehouse or make other modifications to movement, storage, or other aspects of the supply chain that are associated with this pallet. In some implementations, the computing system can update the pallet profile information and then transmit the updated pallet profile to the WMS.

The process 600 can be repeated for each pallet that enters the warehouse and/or each pallet that is ingested and profiled. Moreover, in some implementations, the process 600 for a first pallet may not finish before the process 600 of a second pallet begins (e.g., refer to FIG. 5B). Starting the process 600 for the second pallet while the process 600 of the first pallet is still being executed can be advantageous to maximize throughput and maintain warehouse efficiency. As an example, the warehouse worker at the user device can be identifying the first pallet during the process 600 while at the same time, the computing system can be profiling the second pallet. As mentioned, performing the process 600 at a same time for multiple pallets can be advantageous to improve warehouse efficiency and to move the pallets to their designated organized storage locations to avoid bottlenecks or other holdups in the warehouse.

Furthermore, various warehouses or other storage facilities can deploy the same or similar machine learning models. For example, one or more particular models can be trained then deployed across all warehouses in a network of warehouses. Sometimes, the models can vary based on conditions specific to each warehouse and/or conditions specific to the types of pallets (or the cases themselves) that are ingested into each warehouse. Therefore, in some implementations, each warehouse can deploy one or more different models unique to conditions and requirements of that warehouse. Sometimes, results from the models deployed across the different warehouses can be compared to determine how well each of the models performed pallet profiling techniques. This comparison can be used to determine which of the models to keep and potentially deploy across other warehouses. This comparison can also be used to periodically retrain one or more of the deployed models. The retrained models can then be re-deployed to the same warehouses and/or to other warehouses where the retrained models may work most efficiently (e.g., or otherwise be aligned with the conditions/requirements of the warehouses(s)).

Any of the models described herein may also be used in the warehouses to determine just enough information, or good enough information, to quickly and efficiently ingest the pallet into long-term storage in the warehouse. The pallet may not be fully or accurately profiled at the point of ingestion (e.g., some profiling decisions can be made with 75% accuracy and yet the pallet can still be routed to long-term storage to maintain and/or improve warehouse optimization/efficiency).

FIGS. 7A-C is a flowchart of a process 700 for determining catch weight of cases on a pallet based on processing image data of the pallet. Customers may desire to know exactly how many pounds of an item are in each case on the pallet and/or the pallet as a whole. The weight of each case and/or the pallet as a whole can also be useful information to relevant stakeholders in the warehouse for purposes of routing and storing the pallet in a long-term storage location. The weight of each case may vary. Typically, a warehouse worker at a catch weight station may be tasked with removing the cases from an ingested pallet, scanning a label on each case to identify the weight, also referred to as catch weight, for the case, and then loading the cases back onto the pallet before the pallet can be routed through the warehouse. This can be a time-consuming and tedious process, thereby reducing efficiency of moving pallets in and around the warehouse. The process 700, on the other hand, provides automatic assessment of case labels using image processing techniques to determine catch weight for each case on the pallet. The process 700 also provides for determining the catch weight of cases on the pallet that may be blocked from view by other cases stacked on the pallet. As a result, the process 700 advantageously provides for efficient and accurate catch weight determinations to be automatically made rather than requiring the pallet to go through a manual human review process at a catch weight station. The process 700 can reduce or otherwise eliminate potential human error in the manual review process at the catch weight station and improve warehouse efficiency in processing ingested pallets.

The process 700 can be performed by any of the computing systems, edge computing devices, or other devices described herein. For illustrative purposes, the process 700 is described from the perspective of a computing system.

Referring to the process 700 in FIGS. 7A-C, the computing system can receive image data of a pallet with cases in block 702. As described herein, the images can be captured by cameras positioned near an ingestion point in the warehouse where an inbound pallet is received. Refer to FIG. 1B for further discussion about the camera and ingestion configuration.

In block 704, the computing system can process the image data to identify, for each case on the pallet (or at least each visible case on the pallet), encoded case information. The encoded case information can include, but is not limited to, text, information embedded in a unique identifier, barcode, label, etc. The computing system can perform image processing techniques to identify the encoded case information. As an illustrative example, each case can include two labels. A first label can be encoded with case-identifying information. A second label can be encoded with catch weight information associated with the case. One or more other variations of labels may also be included on the case and encoded with various information associated with the case.

The computing system can perform image processing techniques and/or object detection techniques to identify each case in the image data and then for each case, identify or detect the first and second labels. Once the labels are identified, the computing system can proceed to block 705. Sometimes, the computing system can determine whether the second label is identifiable. If the second label is identifiable, the computing system can proceed to block 705. If the second label is not identifiable, the computing system can flag the case as having an unidentifiable label corresponding to the case's catch weight.

In some implementations, the computing system can implement one or more machine learning models that are trained to identify each case on the pallet and identify one or more of the first and second labels for each case. The models can also be trained to determine and assign a confidence value to identification of the first and/or second labels. The confidence value can indicate a likelihood that the respective label is identifiable (e.g., can be processed by the computing system to determine the corresponding encoded information).

The computing system can also count a number of cases on the pallet in block 705. Block 705 can be performed before, during, or after one or more other blocks in the process 700. For example, block 705 can be performed before or during block 704. Block 705 can be performed to count a number of cases on a top row of the pallet and around a perimeter of the pallet in each row or layer of cases. The computing system can then use machine learning techniques to estimate a total number of cases on the pallet, including cases that are positioned interior to the outer perimeter of cases, where the interior cases are not visible in the image data.

The computing system can count the number of cases by processing the image data. For example, using object detection techniques, the computing system can identify each case in each row or layer on the pallet, or at least a perimeter of each row or layer on the pallet. The computing system can also identify each case in a top layer of the pallet from a top down view of the pallet using the object detection techniques. The computing system can generate a count of the identified cases. The computing system can then infer a total count of cases on the pallet, including the cases that are not visible in the image data based on a number of rows or layers on the pallet (e.g., pallet height and/or dimensions information) and a number of cases identified in the top layer of the pallet. The computing system can also infer and/or verify the total count of cases on the pallet based on scanned information about the pallet (e.g., by scanning a pallet label on the pallet when the pallet is first ingested), a manifest of pallet information for pallets received at the warehouse, and/or pallet information provided to the computing system by another computing system and/or relevant stakeholder when the pallet is received at the warehouse.

The computing system can select a case in block 706.

In block 708, the computing system can determine whether it is able to identify the encoded information for the case with sufficient clarity and/or certainty. In other words, the computing system can determine whether the identified label on the particular case can be processed by the computing system to determine the encoded information. If the image data containing the identified label is blurry, has poor lighting, and/or isn't sharp (or is a threshold level of blurry, poorly lit, and/or not sharp), for example, then the computing system may not be able to accurately process the image data to determine the information encoded in the identified label. Whether the encoded information can be identified with sufficient clarity and/or certainty can depend on one or more threshold conditions or levels of clarity and/or certainty.

If the encoded information is not identifiable with sufficient clarity and/or certainty, the computing system can flag the case for checking and indicate a location of the case on the pallet (block 710). The location can be a layer or row on the pallet. The computing system can then return to block 706 and select another case on the pallet.

If the encoded information is identifiable with sufficient clarity and/or certainty, the computing system can determine a catch weight of the case based on the encoded information (block 712). For example, the computing system can process the encoded information using image processing techniques. The computing system can then compare the processed information to the manifest of pallet information that is provided to the computing system by a relevant stakeholder. The relevant stakeholder may be a supplier of the pallet, in some implementations. The manifest can include, for example, the catch weight for the particular case that is identifiable by the encoded information.

The computing system can then determine whether there are more cases in block 714. If there are additional cases, the computing system can return to block 706. If there are no more cases to process, the computing system can proceed to block 716.

In block 716, the computing system can determine a quantity of the cases having determined catch weight information and a quantity of the cases having undetermined catch weight information. For example, each time the computing system determines that encoded information for a case cannot be identified in block 708, the computing system can add the case to a count for the quantity of cases having undetermined catch weight information. Likewise, each time the computing system determines that encoded information for a case can be identified in block 708, the computing system can add the case to a count for the quantity of cases having determined catch weight information.

The computing system can determine whether the quantity of the cases having determined catch weight information satisfies a threshold quantity of cases on the pallet (block 716). The computing system may determine how many cases it requires catch weight information for in order to perform other processes/analysis described herein. As an illustrative example, the computing system may require catch weight information for only 2 top layers on the pallet. The computing system can then perform catch weight determinations for cases on 2 top layers of the pallet rather than catch weight determinations for all cases on the pallet or cases in other positions on the pallet. Block 716 can therefore be satisfied once the computing system determines the catch weight information for only the 2 top layers of cases on the pallet. The threshold quantity of cases on the pallet can vary. For example, the threshold quantity of cases can vary depending on a size of the pallet, the total number of cases on the pallet, the height of the pallet, dimensions of the pallet, and/or number of layers on the pallet. The threshold quantity of cases can also be a percentage of the total number of cases on the pallet. As an illustrative example, the threshold quantity of cases can be 95% of all the cases on the pallet. Accordingly, if the computing system determined the catch weight information for at least 95% of all the cases on the pallet, then the computing system can proceed to block 720 described below.

As an example of performing the block 716, the computing system can optionally compare a weight of a layer or row of cases on the pallet to a pallet net weight (block 718). In an illustrative example, if the net weight is known, then the computing system may not have to determine catch weight of one case. However, the computing system may determine the weight of layers rather than individual cases. Therefore, in some illustrative examples, the computing system may (i) skip determining catch weight for one entire layer if the computing system determines the catch weight of the other layers as well as the net weight of the pallet and/or (ii) only determine the catch weight for N layers that will be picked off of the pallet (rather than determining catch weight for all layers on the pallet). The net weight of the pallet can be determined from pallet information identified while processing the image data of the pallet, as received in the manifest of pallet information, and/or by passing the pallet through a weighting station when first received in the warehouse. The computing system can determine an expected weight for each layer (a particular layer, a threshold quantity of layers, etc.) on the pallet based on dividing the pallet net weight by a total number of layers on the pallet. The computing system can then sum the catch weights for all the cases on one layer (e.g., a top layer) and compare the summed catch weights to the expected weight for the layer. If the summed catch weight is less than or greater than the expected weight for the layer by a threshold amount (e.g., a percentage of deviation from the expected weight for the layer, in comparison to summed catch weights for other layers on the pallet), then the computing system can determine that the threshold quantity of cases has not been satisfied, meaning that the computing system still has to determine the catch weight information for more cases on the pallet. Accordingly, the computing system can proceed to block 722, described further below.

If the quantity of the cases having determined catch weight information satisfies the threshold quantity (e.g., the computing system determined the catch weight information for only the 2 top layers of cases on the pallet), then the computing system proceeds to block 720 in which the computing system generates and transmits instructions to route the pallet to a long-term storage location in the warehouse. In other words, the computing system determines that a sufficient amount of information is known about the pallet and the cases stacked thereon in order to safely and efficiently route the pallet to its respective long-term storage location.

If the threshold quantity of cases have not had their respective catch weight information determined in block 716, then the computing system can generate and transmit at least one notification to check the flagged case(s) (block 722). For example, the computing system can retrieve a list of cases that were flagged in block 710. The computing system can return the list of flagged cases in block 722. Returning the list of flagged cases can include transmitting the list to a computing device of a human worker.

The computing system can present the notification(s) at the computing device (e.g., user device) of the human worker to check the flagged case(s) for catch weight information (block 724). The human worker can be at a catch weight station or other checking station where they can manually review one or more cases on the pallet. For example, the pallet can be automatically routed to the catch weight station or other checking station. The list of flagged cases can instructions about the locations of each of the flagged cases. Therefore, the human worker can quickly and efficiently identify which cases need to be checked so that the human worker does not have to remove all the cases from the pallet, manually check one or more of the cases, and then put all of the cases back on the pallet. This is a less labor intensive and more efficient process than other techniques mentioned above.

The computing system can receive user input from the computing device based on a manual review of the case(s) indicating the catch weight information (block 726). For example, the warehouse worker can use a scanning device to scan the encoded information on the flagged case(s). The encoded information about the catch weight of the case that is determined based on this scanning process can then be automatically transmitted to the computing system.

The computing system can update a pallet profile for the pallet based on the user input in block 728. For example, the pallet profile can include information for each case on the pallet. Some of the cases can have completed information, including their catch weight information. For example, when the catch weight is determined for the case in block 710, the computing system can automatically update the corresponding case information in the pallet profile to include that catch weight. Other cases may have incomplete information. For example, if the catch weight cannot be determined for a case in block 708, then the catch weight information for the case in the pallet profile may be left incomplete. Therefore, when the catch weight information is determined based on the manual review performed by the human worker, the information for the case can be completed with the catch weight information. The pallet profile can accordingly be populated with necessary information for the pallet and the cases stacked thereon.

The computing system can also mark a pallet identification process for the pallet as complete in block 730. The identification process can be marked as complete if at least a threshold quantity of information is identified for the cases on the pallet and/or at least a threshold quantity of the cases on the pallet have been identified using the process 700. As another example, the identification process can be marked as complete if the catch weight is determined for all the cases on the pallet and/or a threshold quantity of the cases on the pallet. As another example, the identification process can be marked as complete if a threshold amount of information is identified for the pallet, where the threshold amount of information about the pallet can be used to safely and efficiently ingest the pallet and route the pallet to its respective long-term storage location.

As described herein, additional profiling operations may also be performed at a later time. The additional profiling operations can be performed using remote processing power and compute resources. The additional profiling operations can be performed while the pallet is routed to its long-term storage location. The additional profiling operations may include identifying additional information about the pallet that may not be required to route and store the pallet but may be useful to further identify the pallet and/or provide information about the pallet to relevant stakeholders.

The computing system can also generate and transmit instructions to route the pallet to a long-term storage location in the warehouse (block 732). In some implementations, generating and transmitting the instructions can include generating and transmitting a notification to an automation computing system (or one or more other computing systems) to then route the pallet to the long-term storage location in the warehouse. The automation computing system can determine and generate instructions to automatically control one or more components inside the warehouse to route the pallet to the designated storage location. As described herein, any of the computing systems described herein can generate instructions that cause conveyance systems (e.g., conveyor belts, automated conveyor belts) in the warehouse to automatically route the pallet to its respective long-term storage location. As another example, any of the computing systems described herein can generate instructions to be executed by an automated warehouse vehicle, such as a forklift and/or robot. The automated warehouse vehicle can be tasked with picking up the pallet (from the pallet's current location, a staging area, etc.) and moving the pallet to its long-term storage location. As another example, the computing system can transmit the instructions to a user computing device and/or a computing device of a forklift such that a relevant warehouse worker tasked with moving items in the warehouse can pick up the pallet and move the pallet to its long-term storage location.

FIG. 8A is a flowchart of a process 800 for identifying gaps between cases, on a pallet based on processing image data of the pallet. The gaps can form between cases when the pallet is in transit, from one location to another. Sometimes, the gaps may form if the cases are not properly stacked on the pallet. Improper stacking of items/cases or entire layers on the pallet may cause the items/cases to fall from the pallet if transported while the pallet is unwrapped. The gaps can cause risk to a physical structure and/or integrity of the pallet, thereby making the pallet unsafe to be transported around a warehouse or other storage facility. For example, if gaps exist between cases on the pallet, when an automated layer picker or other automated warehouse vehicle grabs a layer of cases off of the pallet, the layer picker may crush one or more cases on that layer. The layer picker can cause damage to the case(s) on the picked layer or other layers on the pallet. Sometimes, the layer picker may also drop cases in the layer if gaps exist between those cases since the layer picker is unaware of those gaps. Therefore, the process 800 can be performed to identify such gaps from the image data of the pallet, assess whether any identified gaps may risk structural or physical integrity of the pallet for transportation around the warehouse, and based on that assessment, generate instructions for a warehouse worker to check and/or fix the identified gap(s) before transporting the pallet around the warehouse. The process 800 can be performed to determine whether a layer of cases or items on the pallet is suitable for layer picking tasks. The process 800 can provide for improving safety of transporting the pallet around the warehouse, such as to a long-term storage location.

The process 800 can also provide for informed and automated decisions to be made about whether to route the pallet to an automated layer picker or manual layer picking processes, thereby improving and optimizing layer picking processes in the warehouse. Identifying the gaps, or chimney stacks, on the pallet can also be used to determine dimensions, height, and/or other size information about the pallet. This determined information can be useful to optimize automation processes in routing the pallet for storage in the warehouse, picking layers off of the pallet, and storing the pallet, or layers of the pallet, in particular storage locations in the warehouse.

The process 800 can be performed by any of the computing systems, edge computing devices, or other devices described herein. For illustrative purposes, the process 800 is described from the perspective of a computing system.

Referring to the process 800 in FIG. 8A, the computing system can receive a set of images of a pallet with cases in block 802. Refer to block 702 in the process 700 for further discussion.

The computing system can select an image from the set representing a top of the pallet in block 804. In other words, the computing system can select an image that was captured from a top down view of the pallet. Although the process 800 is described from the perspective of identifying chimney stacks or gaps from the top down view of the pallet, the process 800 can also be performed to identify gaps between cases as seen from one or more side views of the pallet.

In block 806, the computing system can process the selected image to identify each case at the top of the pallet. The computing system can employ any of the image processing techniques described herein to identify each case. The computing system can perform object detection techniques to identify each case and establish a bounding box around each case. The computing system can additionally or alternatively apply one or more models to the image of the top of the pallet, the model(s) having been trained to detect and identify pixels in the image data that are representative of each case and establish a bounding box around each of the cases.

The computing system can perform a gap detection process between one or more of the cases to determine whether one or more gaps are identifiable (block 808). For example, the computing system can apply a machine learning trained model (e.g., deep learning models) to the image data that has been trained to identify gaps between cases and generate a score for the identified gap. The score can indicate a size or severity of the gap. For example, a higher score value (or a score value above a threshold value) can indicate that a large gap has been identified between one or more cases. A lower score value (or a score value below the threshold value) can indicate that a small gap has been identified between one or more cases. In some implementations, the computing system may also determine an overall score for the pallet. The overall score for the pallet can provide information about a total number of gaps on the pallet. For example, the overall score can include a numeric value indicating the total number of gaps that have been identified on the pallet. The overall score can additionally or alternatively include a confidence value indicating likelihood that the total number of gaps on the pallet make the pallet less structurally or physically sound/safe. The overall score can additionally or alternatively include a confidence value indicating how safe the pallet is for purposes of transporting the pallet in the warehouse and/or picking layers off of the pallet.

As another example, the computing system can run one or more deep learning models on the image data of one or more sides and/or a top of the pallet to identify gaps at various locations on the pallet. The disclosed techniques can be used to identify gaps on sides of the pallet based on identifying individual cases and their boundaries (expected and actual boundaries).

In some implementations, the computing system can identify, infer, or otherwise predict gaps between one or more layers of cases on the pallet and/or gaps per layer on the pallet. For example, the computing system can use predictive analytics, artificial intelligence, and/or machine learning techniques to infer gaps on one or more layers beneath a top layer of the pallet and based on gaps identified on the top layer of the pallet.

The computing system can perform the gap detection process for each set of adjacent cases that appear in the image data of the top of the pallet. For example, the computing system can perform the gap detection process to identify any gaps between a case on an edge of the layer and an adjacent case to a right of the case on the edge. The computing system can also perform the gap detection process to identify any gaps between the case on the edge of the layer and any other cases that touch or otherwise are parallel to or adjacent one or more sides of the case on the edge. Likewise, the computing system can perform the gap detection process to determine whether any gaps exist between any adjacent or parallel sides of cases on the top layer of the pallet.

As part of performing the gap detection process, the computing system can estimate or determine a size of an identified gap. The computing system can use one or more machine learning techniques to assign a value indicating the size of the identified gap. Moreover, the computing system can identify every gap in the top layer of cases on the pallet. Sometimes, the computing system may only identify and determine the size of a gap if the gap is greater than a threshold gap size and/or the gap satisfies threshold shape criteria. For example, if the gap is narrow and appears as a relatively straight and narrow rectangle between two adjacent cases, then likely the gap is insignificant. Therefore, the gap may not be identified and/or may not be sized. On the other hand, if the gap appears progressively larger and/or has a shape, such as a triangle, the gap likely is significant and can be identified and/or sized using the disclosed techniques.

A model can be trained to identify different types, sizes, and/or shapes of gaps that may exist in a layer on a pallet. For example, the model can be trained with a dataset of training images that have been annotated and labeled with varying information about the gaps that may exist in a layer on a pallet. The model can also be trained with the dataset of training images that have been annotated and labeled with size information for different types of gaps that may exist. The model can be iteratively trained with new image data as inbound pallets are imaged and processed during runtime and using the disclosed techniques. As a result, the model can be continuously improved, thereby improving accuracy of the model in detecting, quantifying, and scoring gaps that may exist in layers on inbound pallets.

The computing system can determine whether any detected gaps meet threshold gap criteria in block 810. The threshold gap criteria can vary based on one or more factors. For example, the threshold gap criteria can be different based on a type of the pallet, a type of cases or items on the pallet, a size and/or dimensions of the pallet, a weight of the pallet, storage criteria for the pallet, criteria for transporting pallets throughout the warehouse, types of devices and/or vehicles that transport the pallets throughout the warehouse, and/or other information about the warehouse. In block 810, the computing system can make this determination for each identified gap in the pallet. In some implementations, the computing system can make this determination for the pallet's gaps in the aggregate. Sometimes, in block 810, the computing system can determine whether the pallet has at least a threshold quantity of identified gaps and/or a threshold quantity of identified gaps that meet the threshold gap criteria (e.g., where the threshold quantity of identified gaps have sizes and/or shapes that exceed threshold sizes and/or shapes for the pallet to be sound and/or safe for transport in the warehouse).

If the threshold gap criteria is met, the computing system can generate and transmit instructions to route the pallet to a checking station for manual review by a human worker (block 812). The instructions can include locations of the identified gaps on the pallet. The instructions can include other information about the identified gaps that can be used by the human worker to efficiently and quickly check the pallet. As a result, the human worker can use their time more efficiently to check only portions of the pallet having the identified gaps, rather than checking the entire pallet. This can improve warehouse efficiency and optimize human and automated operations in the warehouse.

If the threshold gap criteria is not met in block 810, the computing system can optionally determine whether there are more cases to compare (block 811). In other words, any of the identified gaps may not be large enough to warrant the pallet to be checked by the human worker. Rather, the pallet may be structurally and physically sound to be safely and efficiently transported throughout the warehouse.

In block 811, if there are more cases to compare, the computing system can return to block 808. The computing system can repeat blocks 808-810 to identify gaps between the one or more other adjacent cases that have been identified on the pallet.

If there are no more cases to compare, the computing system can proceed to block 814, in which the computing system can generate and transmit instructions to route the pallet to a long-term storage location in the warehouse. In some implementations, if the threshold gap criteria is not met in block 810, the computing system can simply proceed to block 814 instead of looping through block 811.

FIG. 8B illustrates example image data 850 of a pallet 852 having gaps 858A and 858B between cases 854A-N (e.g., chimney stacks) and image data 860 of a pallet 862 without gaps between cases 864A-N. Using the disclosed techniques, a computing system described herein can perform image processing techniques to identify each of the cases 854A-N on a top layer of the pallet 852. Once the cases 854A-N are identified, the computing system can generate bounding boxes 856A-N around each of the respective cases 854A-N. The bounding boxes 856A-N can indicate expected structural shapes of the cases 854A-N. In the example of the image data 850, the bounding boxes 856A-N are rectangular shapes that the cases 854A-N are expected to have upon arrival at the warehouse. However, as shown in the image data 850, one or more of the cases 854A-N do not align with the expected rectangular shapes as shown by the bounding boxes 856A-N. The computing system can also identify the gap 858A between the cases 854B and 854C and the gap 858B between the cases 854C and 854D using the disclosed gap detection process. The gaps 858A and 858B can be identified based on comparing the bounding boxes 856A-N to the actual shape of the cases 854A-N as identified in the image data 850. Since the pallet 852 has the gaps 858A and 858B, if the gaps 858A and 858B satisfy the threshold gap criteria, the pallet 852 can be routed to a checking station in the warehouse to be manually checked by a warehouse worker.

On the other hand, the image data 860 shows the pallet 862 with the cases 864A-N that are arranged on the pallet 862 without gaps. The pallet 862 can remain structurally and physically sound while transported to the warehouse and upon arrival at the warehouse. The cases 864A-N might not have shifted during transport and/or the cases 864A-N might have shifted less than a threshold amount during transport. Because the pallet 862 is structurally sound, as shown in the image data 860, the pallet 862 can be routed to a long-term storage location.

FIG. 8C illustrates example image data 870 and 880. The image data 870 is a top-down view of a pallet having cases stacked thereon but with a gap or hole in the middle of the pallet. The image data 880 is a side-view of another pallet having cases stacked thereon where the cases are stacked without interlocking. In other words, the cases in the image data 880 are not aligned to be stacked straight on top of each other. Such features of the pallet can be identified from the image data 870 and 880 using the techniques described herein.

FIGS. 9A-B is a flowchart of a process 900 for detecting damage to cases on a pallet based on processing image data of the pallet. Sometimes, damage at a top layer of the pallet cannot be detected by the human eye, especially if the pallet is very tall. That type of damage may go unseen when the pallet is routed into a warehouse and throughout the warehouse for storage (e.g., long-term storage). Identifying this type of damage is important to determine whether damaged cases or items are being delivered to customers, whether the damage already existed before the pallet entered the warehouse, and/or whether the damage occurred once the pallet entered the warehouse. In some implementations, the process 900 can also be performed to determine damage to the pallet itself. When the pallet is damaged as such, pallet safety and structural integrity can be compromised and therefore cause risks to warehouse workers and vehicles in the warehouse.

The process 900 can be performed by any of the computing systems, edge computing devices, or other devices described herein. For illustrative purposes, the process 900 is described from the perspective of a computing system.

Referring to the process 900 in both FIGS. 9A-B, the computing system can receive a set of image data of pallets taken from different viewpoints in block 902. For example, image data from different sides, a top, and/or bottom of the pallet can be captured and received in block 902. Refer to description of the block 702 in the process 700 for further discussion. Sometimes, in block 902, the computing system can retrieve image data pallets that have been previously imaged and/or profiled using the disclosed techniques. The computing system can retrieve the image data from a database (e.g., data store, data repository) storing pallet profile information and historic data about pallets that have previously been ingested into the warehouse.

The computing system can annotate a subset of the set of image data with damaged cases (block 904). For example, the computing system can automatically identify and label damage in the image data, or more particularly, the subset of the set of image data. The computing system can annotate different types of damage, such as broken corners, ripped exterior layers of the case, dented cases, etc. In some implementations, the subset of the set of image data can be annotated with human-inputted labels and/or annotations.

The subset of the set of image data can include images of a top down view of the pallet. Therefore, a top layer of cases on the pallet can be identified in the subset of the set of image data. The computing system can employ any of the object detection and/or machine learning techniques described herein to identify each of the cases on the top layer of the pallet and then identify whether any of those cases are damaged. In some implementations, the computing system may simply identify any damage rather than first identifying the cases on the top layer of the pallet and then processing a portion of the subset of the image data that corresponds to the particular case.

As another example, the subset of the set of image data can include images of a side view of the pallet. Therefore, multiple layers of cases on the pallet can be identified along a vertical height of the pallet in the subset of the set of image data. The computing system can use any of the object detection and/or machine learning techniques described herein to identify each of the cases on the layers represented in the subset and then identify whether any of those cases are damaged. In some implementations, the computing system may simply identify any damage rather than first identifying the cases on the layers and then processing a portion of the subset of the image data that corresponds to the particular case.

The computing system can then train one or more models to identify instances of damaged cases in the image data of pallets from different viewpoints and using the annotated subset (block 906). The model(s) can be trained with real images of the pallets having damage. The model(s) can be fed annotated images of pallets having damage and images of pallets that do not have damage.

The model(s) can also be trained to generate one or more score values or confidence values for any of the detected damage. The score or confidence value can indicate a likelihood that the damage may be harmful to the structural and/or physical integrity/safety of the pallet. A higher score value can, for example, indicate that the pallet is less safe as a result of the damage. A lower score value can indicate that the safety of the pallet is less compromised by the detected damage. The score or confidence value can additionally or alternatively indicate a likelihood that the case is in fact damaged. A higher value can indicate a higher likelihood that the case is actually damaged while a lower value can indicate less certainty by the computing system that the case is actually damaged. Moreover, the model(s) can be trained to generate an aggregate score or aggregate confidence value for the pallet. The aggregate value can be a summation and/or average of the values determine for each of the detected damage. The aggregate value can indicate an overall likelihood that the damage to the entire pallet is harmful to the structural and/or physical integrity/safety of the pallet. The higher the aggregate value, the less structurally safe the entire pallet may be while the lower the aggregate value, the more structurally safe the entire pallet may be. Sometimes, the aggregate value can indicate confidence that all of the damage on the pallet has been identified with sufficient certainty. Any of the score values described herein can be used during runtime use of the disclosed techniques to determine whether to route an inbound pallet to a long-term storage location or a checking station for manual review by a human worker.

The model(s) can also be continuously improved by feeding additional images of pallets that are profiled during runtime use of the disclosed technology. Once the model(s) is trained, the model(s) can be stored (e.g., in a data store, data repository, and/or database). The model(s) can also be stored in local memory for quick and efficient execution during runtime pallet profiling. Sometimes, the model(s) can be transmitted to another computing system on the edge or an edge computing device for quick and efficient deployment during runtime pallet profiling.

Blocks 902-906 can be performed before runtime. Blocks 902-906 can be performed using remote computing systems. The blocks 902-906 can be performed to train the model(s) before the model(s) are deployed during runtime. Once the model(s) are trained, the model(s) can be transmitted to the computing system, which can on the edge. The model(s) can then be executed on the edge during runtime to detect damage of inbound pallets. As a result, compute resources and processing power can be efficiently used.

During runtime, the computing system can receive image data of an inbound pallet taken from different viewpoints in block 910. Refer to description of the block 702 in the process 700 for further discussion. The image data can capture one or more sides, a top, and a bottom of the pallet using the disclosed techniques.

The computing system can apply the trained model(s) to the image data taken from each of the different viewpoints in order to identify one or more damaged cases on the pallet (block 912). For example, the computing system can identify at least one image or a best image of a first side of the pallet. The computing system can then apply the model(s) to the identified image(s) to detect whether damage exists on the first side of the pallet. The computing system can additionally or alternatively identify at least one image or a best image of a second side of the pallet, and repeat block 912 for the second side of the pallet. The computing system can perform block 912 for each side of the pallet that is identified in the image data. In some implementations, the computing system may perform block 912 for only certain sides of the pallet, such as a top layer or top view of the pallet and/or a bottom layer or bottom view of the pallet.

Then, the computing system can determine whether the identified damaged cases satisfy threshold damage criteria in block 914. The threshold damage criteria can vary based on one or more factors, such as a type of identified damage (e.g., damage to particular types of cases, damage to boards of the pallet, other types of damage), criteria for routing pallets throughout the warehouse to storage locations, pallet supplier information, customer information, a type of the pallet, height, size, or other dimensions of the pallet, etc. The computing system can determine whether each identified damaged case satisfies the threshold damage criteria. A case can satisfy the threshold damage criteria if, for example, its identified damage covers at least a threshold percentage of an area of the case (e.g., more than 80% of the case is caved in). As another example, a case can satisfy the threshold damage criteria if, for example, the case is damaged and is located on a corner or edge of a layer on the pallet (and therefore causes a greater risk of falling off the layer while being moved around the warehouse).

In some implementations, the computing system can determine whether all of the identified damage in the aggregate satisfies the threshold damage criteria. For example, the pallet as a whole can satisfy the threshold damage criteria if damage has been identified on at least a threshold quantity of a total number of cases on the pallet (e.g., at least 30% of cases on the pallet have been identified as having damage). One or more other criteria can be used to determine whether the pallet as a whole satisfies the criteria in block 914.

If the threshold damage criteria is satisfied, the computing system can generate and transmit instructions to route the pallet to a checking station for manual review by a human worker (block 916). In other words, the pallet, and/or one or more cases and/or layers on the pallet may have sufficient damage to be checked by the human worker. The pallet may not be safe to transport around the warehouse, to a long-term storage location, as-is. The instructions can include location information about each of the cases that have been identified as having damage. As a result, the warehouse worker can use their time more efficiently to identify and inspect only those cases that have been identified with their respective location information. The warehouse worker may not be required to take apart all the layers on the pallet and inspect every case in the layers in order to assess and/or address any damage.

The computing system can then optionally proceed to block 920, in which the computing system can iteratively train the model(s) based on the damage identification.

Referring back to block 914, if the threshold damage criteria is not met, then the computing system can generate and transmit instructions to route the pallet to a long-term storage location in the warehouse (block 918). In other words, the pallet's structure may be sufficiently sound for the pallet to be transported safely throughout the warehouse. Sometimes, even if a pallet has some identified damage, the threshold damage criteria may not be met and the pallet can be routed safely to the respective long-term storage location in the warehouse. The computing system can then optionally proceed to block 920.

FIG. 9C illustrates example image data 950 of a pallet 952 having damaged cases 954B. The image data 950 shows a top layer of the pallet 952. Cases 954A-N can be identified on the top layer of the pallet 952 using the techniques described in reference to the process 900 in FIGS. 9A-B. As part of identifying the cases 954A-N, a computing system described herein can also identify whether any of the cases 954A-N have damage. Using the machine learning models described in the process 900, the computing system can identify the case 954B as being damaged. As shown in the image data 950, the case 954B is crushed in a bottom left corner. This damage may not be visible to a warehouse worker because the pallet 952 may have many layers that cause the pallet 952 to have a height at which the warehouse worker cannot simply inspect the top layer of the pallet 952. Moreover, since the damaged case 954B is interior to other cases on the layer, such as the case 954A, the damaged case 954B cannot simply be seen by the warehouse worker without requiring the warehouse worker to climb a ladder or otherwise get to a height that is higher than the height of the pallet 952. Therefore, the disclosed techniques allow for parts of the pallet 952 that may be hard to visually inspect to be quickly, efficiently, and accurately imaged and assessed for purposes of profiling the pallet 952.

FIG. 10A is a system diagram depicting system components that perform the techniques described herein. The system can include the computing system 152, the WMS 154, the user device 156, the pallet profiles data store 158, and pallet profiling controllers 1002A-N in data communication via the network(s) 150. In some implementations, one or more of such system components can be one computer, computing system, server, remote server, node of servers, and/or device. For example, the computing system 152 and the WMS 154 can be part of a same computing system. As another example, one or more of the pallet profiling controllers 1002A-N can be part of the computing system 152.

The pallet profiling controllers 1002A-N can be configured to control operation of components that are used for routing the pallet and capturing images of the pallet. In some implementations, each component that is used for routing the pallet and/or capturing images of the pallet can be controller by a different controller 1002A-N. As shown in FIG. 10A, the controllers 1002A-N can include one or more cameras 1016 (e.g., the cameras 110A-N depicted throughout), controllers 1018A-N, a turntable 1020, one or more conveyor belts 1024 (e.g., the on conveyor belt 102 and the off conveyor belt 106 depicted throughout), one or more lights 1026 (e.g., the lights 112A-N depicted throughout), a communication interface 1028, a pallet centering module 1030, and a turntable rotator module 1032. The communication interface 1028 can provide for the controllers 1002A-N to communicate with one or more of the systems, devices, and components described herein. In some implementations, one or more of the camera(s) 1016, turntable 1020, conveyor belts 1024, and lights 1026 can be separate from the pallet profiling controllers 1002A-N. The controllers 1002A-N can be in communication (e.g., over the network(s) 150) with the components 1016, 1020, 1024, and 1026 in order to control these components.

Instructions for controlling the components 1016, 1020, 1024, and 1026 can be executed by the controllers 1018A-N. In some implementations, the pallet profiling controllers 1002A-N can include multiple controllers 1018A-N (e.g., computing devices, software, computing systems) that are each configured to control a different one of the components 1016, 1020, 1024, and 1026. Instructions executed by the controllers 1018A-N can cause automatic rotation of the turntable 1020, turning on/off the light(s) 1026, slowing down/speeding up the conveyor belt(s) 1024, and prompting the camera(s) 1016 to capture images of the pallet as it is rotated on the turntable 1020. As an illustrative example, the controllers 1002A-N can selectively turn on or off one or more of the camera(s) 1016. This determination can be based on whether features of the pallet can be clearly identified from one or more images of the pallet. As another illustrative example, the controllers 1002A-N can turn of an overhead light 1026 and/or increase brightness of lights 1026 that illuminate sides of the pallet instead of the top of the pallet. The controllers 1002A-N can also turn on and off red lights, which may or may not be used for every pallet that is profiled (e.g., the red lights can be used for pallets that are wrapped in cellophane or another material that can cause a glare in the camera 1016 lens). As yet another illustrative example, the controllers 1002A-N can control the conveyor belts 1024 to route the pallet to an organized storage location or a temporary storage location.

Still referring to the controllers 1002A-N, the pallet centering module 1030 can be configured to center the pallet at a midpoint of the turntable 1020, as described throughout this disclosure. The pallet centering module 1030 can also be configured to instruct alignment device(s) of the on conveyor belt 1024 to align and adjust the pallet while the pallet is on the belt 1024 being automatically moved to the turntable 1020.

The turntable rotator module 1032 can be configured to determine a degree of rotation, a speed of rotation, and/or a direction of rotation of the turntable 1020, as described herein. The module 1032 can determine when to begin rotation of the turntable 1020. For example, the module 1032 can determine that the turntable 1020 can remain stationary until the pallet is detected to be centered and/or otherwise on the turntable 1020. One or more sensors positioned on a surface of the turntable 1020 can sense when weight of the pallet to identify when the pallet is on the turntable 1020. In some implementations, the module 1032 can determine that the turntable 1020 can be continuously rotating, regardless of whether the pallet is on the turntable 1020. The module 1032 can send instructions to the controllers 1018A-N to adjust movement/rotation of the turntable 1020.

The module 1032 can also determine a degree of rotation based at least in part on a size of the pallet and any pre-identified information about the pallet. For example, the module 1032 can determine that the turntable 1020 should rotate at a smaller degree of rotation (e.g., slower rotation) such that the cameras 1016 can more accurately capture images of an entire surface area of a large pallet. A larger degree of rotation (e.g., faster rotation) can be used, for example, for a pallet having less surface area.

The module 1032 can modulate the speed of rotation of the turntable 1020 based at least in part on receiving indications from one or more sensors of a weight of the pallet, the size of the pallet, and pre-identified information. For example, a large pallet may require the turntable 1020 to move at a slower speed than a pallet that is half the size of the large pallet because there is more surface area to be captured by the cameras 1016. In some implementations, rotating the pallet at a slower speed can be advantageous to capture more images of the pallet that can be stitched together. When the cameras 1016 are low resolution cameras, the slower speed can be advantageous to ensure that the images are not blurry. When the cameras 1016 are high resolution cameras, the module 1032 can determine a faster speed at which to rotate the turntable 1020. After all, the higher resolution cameras 1016 can capture sharper images despite the speed. The faster speed of rotation can also be advantageous to increase efficiency and reduce time needed in profiling pallets that enter the warehouse.

The computing system 152 can be configured to profile pallets as they enter the warehouse, as described throughout this disclosure. The computing system 152 can include an image analysis module 1004, pallet routing determiner 1006, pallet matching determiner 1008, pallet profile verification module 1010, communication interface 1012, a pallet profiler 1014, and a storage location determination engine 1074. In some implementations, the computing system 152 can be a combination of one or more other components and/or systems, such as the WMS 154, a warehouse control system (WCS) 1080, and/or a cloud computing system 1082. In some implementations, one or more of the components of the computing system 152 can be part of other systems, such as the WMS 154, the WCS 1080, and/or the cloud computing system 1082. As an example, the pallet profiler 1014 can be part of the cloud computing system 1082. The cloud computing system 1082 can be configured to perform processing of image data to determine information about a scanned pallet.

Referring to the computing system 152, the image analysis module 1004 can be configured to receive image data that is captured by the cameras 1016. The module 1004 can perform image analysis techniques on such image data to identify information about the pallet. As described herein, during a profiling process, the module 1004 can at least detect a product label or other unique identifier from the image data. The module 1004 can be trained using one or more machine learning models to identify different types of labels from the image data. The module 1004 can also be configured to perform object detection techniques and optical character recognition (OCR) to not only detect the label but also to determine information associated with the label. Using similar techniques, the module 1004 can determine text on the pallet and any other identifying characteristics about the pallet. For example, as described herein, the module 1004 can use machine learning trained models to detect different features of the pallet from the image data. One or more of such models can be used for detecting damage to contents, lean, height, weight, dimensions, contents, damage to the pallet, temperature of contents, text, etc. Information identified by the image analysis module 1004 can be transmitted to the pallet profiles data store 158 and stored in a profile associated with the pallet, as described further below.

The pallet routing determiner 1006 can determine where the pallet can be moved after images are captured. The determiner 1006 can receive identified information from the image analysis module 1004. Using that information, the determiner 1006 can determine whether the pallet should be moved to an organized storage location or temporary storage. If the pallet should be moved to organized storage, the determiner 1006 can determine a particular location in organized storage based on the information from the image analysis module 1004. The determiner 1006 can also access pre-identified information about the pallet from the pallet profiles data store 158 to determine where to store the pallet in organized storage. Once the determiner 1006 identifies where to store the pallet, the determiner 1006 can generate instructions for routing the pallet. The instructions can then be transmitted to the pallet profiling controllers 1002A-N and executed by the controllers 1018A-N.

The pallet matching determiner 1008 can be configured to match information identified by the image analysis module 1004 with pre-identified information associated with the pallet. For example, the determiner 1008 can receive information from a vendor indicating characteristics about the pallet before the pallet arrived at the warehouse. The determiner 1008 can associate this information with the pallet's profile in the pallet profiles data store 158. The determiner 1008 can also associate this information with the information determined by the image analysis module 1004.

In some implementations, the determiner 1008 can use information identified by the module 1004 to identify a profile for the pallet that is already stored in the pallet profiles data store 158. Once the profile is identified, the determiner 1008 can update any of the information in the profile with the information identified by the image analysis module 1004.

In some implementations, the determiner 1008 can identify that no profile currently exists for the pallet or that a profile cannot be matched to the pallet. In such situations, the determiner 1008 can generate a profile for the pallet and store the identified information therein (e.g., refer to the placeholder label described throughout this disclosure, FIGS. 5-8).

The pallet profile verification module 1010 can be configured to determine an accuracy of the information identified by the image analysis module 1004. The pallet profile verification module 1010 can receive pre-identified pallet information (e.g., received from an owner, vendor, or other relevant stakeholder in the supply chain), information identified by warehouse workers during manual inspection of the pallet, and the information identified by the image analysis module 1004. Using such information, the module 1010 can determine whether accurate/up-to-date information is stored in the profile associated with the pallet. The module 1010 can compare the information and determine and assign accuracy confidence values to the information. If the pallet profile contains information whose accuracy confidence value is below a predetermined threshold value (e.g., vendor information indicated no damage but the image analysis module 1004 identified damage), the module 1010 can flag the pallet to be reviewed by a warehouse worker.

The communication interface 1012 can be configured to provide for communication of the computing system 152 with other systems, devices, and components via the network(s) 150.

Still referring to the computing system 152, the pallet profiler 1014 can be configured to determine one or more characteristics about the pallet that can impact storage of the pallet. The pallet profiler 1014 can make such determinations using the image data that is captured by the cameras 1016. Moreover, the pallet profiler 1014 can make such determinations using machine learning trained models as described throughout this disclosure. The profiler 1014 can include a damage detector 1034, a configuration detector 1036, and a content detector 1038.

The damage detector 1034 can be configured to identify any indications of damage from the image data using the techniques, methods, and processes described throughout this disclosure. The detector 1034 can also be configured to identify any gaps and/or voids where boxes, containers, or other items are expected to be on the pallet. Such gaps/voids can indicate missing and/or damaged items. Damage can occur to the pallet or its contents while in transit to the warehouse. Damage can occur to the pallet itself (e.g., a broken deck board, warped wooden frame, etc.). Damage can also occur to one or more items stacked on the pallet. The detector 1034 can be trained to identify features in the image data indicative of different types of damage. Such detection techniques can be advantageous to reduce human error since it can be challenging and/or time consuming for a human to accurately identify all types of damage that can occur to the pallet and/or its contents.

The configuration detector 1036 can be configured to determine configuration information about the pallet from the image data and/or the information determined by the image analysis module 1004. The detector 1036 can determine a size of the pallet (e.g., length, height, and width) using the techniques described herein. The detector 1036 can also be trained to determine a lean of the pallet, a number of layers or rows of items on the pallet, and a quantity of items on the pallet. The detector 1036 can apply machine learning trained models to make each of these determinations.

The content detector 1038 can be configured to determine content information about the pallet from the image data and/or the information determined by the image analysis module 1004. In some implementations, the detector 1038 can determine how many boxes or items are on the pallet (e.g., box count). The detector 1038 can make such a determination based at least in part on information identified by the damage detector 1034 and/or the configuration detector 1036. In some implementations, the content generator 1038 can determine what items/objects are stored on the pallet. The generator 1038 can also use the identified information from the module 1004 and pre-identified information about the pallet to confirm, verify, or otherwise determine what items are on the pallet and/or what items should be on the pallet. In some implementations, the content generator 1038 can also identify and translate text, barcodes, QR codes, and/or other unique identifiers that are associated with the pallet and/or individual items on the pallet.

The storage location determination engine 1074 can be configured to determine where to store the pallet in the warehouse. The engine 1074 can automatically make such a determination, using the techniques described herein. The determined storage location can then be transmitted to the WMS 154. In some implementations, the computing system 152 may not have the storage location determination engine 1074. Instead, the storage location can be determined by the WMS 154, as described below.

Pallet information that is determined and/or identified by the computing system 152 can then be stored in the pallet profiles data store 158. The data store 158 can include data records for each of the pallets 1040A-N that enter the warehouse.

An example pallet profile 1040A-N can include image data 1042, damage 1044, box count 1046, lean 1048, size 1050, layers 1052, content 1054, text 1056, and label 1058. Each of the information 1042-1058 can be determined by one or more components of the computing system 152. One or more of the information 1042-1058 can also be determined by a warehouse worker at the user device 156, the WMS 154, and/or any other relevant stakeholders in the supply chain (e.g., vendor, owner, customer, etc.).

In some implementations, the computing system 152 can store less than all of the images that were captured by the cameras 1016 in the pallet profile 1040A-N. For example, an image that clearly captures a label of the pallet can be stored in the image data 1042. Other images for that pallet can be discarded. Sometimes, images of the pallet can be captured by one or more stakeholders in the supply chain. Such images can be stored in the image data 1042. The image analysis module 1004 of the computing system 152 can then access such images and perform image analysis techniques to identify information about the pallet. When the label of the pallet may not be clearly identified from the image data 1042, all the captured images can be stored in the image data 1042 so that the warehouse worker can analyze the images to identify information about the pallet. If the worker can accurately identify information about the pallet from the images, one or more of the images can be saved in the image data 1042 and other images (e.g., blurry images) can be discarded. In some implementations, if the worker cannot identify information from the images but can identify information via a manual inspection of the pallet, all of the images can be discarded from the image data 1042.

The WMS 154 can include a storage location determiner 1060 and a communication interface 1062. The WMS 154 can be configured to manage information about and operation of the warehouse and the warehouse's components. In some implementations, the WMS 154 can be part of the computing system 152, the WCS 1080, and/or the cloud computing system 1082, as mentioned above. In some implementations, the WMS 154 can include the WCS 1080, the cloud computing system 1082, and/or automation application programming interfaces (APIs) 1061. The communication interface 1062 can be configured to provide for communication between the components described herein.

The storage location determiner 1060 can be configured to identify a storage location for the pallet. As described throughout this disclosure, the determiner 1060 can identify whether the pallet can be stored in temporary storage or an organized storage location. The determiner 1060 can also identify which storage location in organized storage location to store the pallet. In some implementations, the determiner 1060 can also generate instructions for routing the pallet to the identified storage location. The determiner 1060 can communicate the identified storage location and/or the instructions to the pallet profiling controllers 1002A-N for execution by the controllers 1018A-N.

The determiner 1060 can receive pallet information 1046A-N, which can be used to determine the optimal storage location for the pallet. The received pallet information 1046A-N can include a storage location 1066, label 1068, and owner 1070.

The pallet profile 1040A-N can sometimes indicate where pallets of a particular type and/or owner should be stored (e.g., the storage location 1066). The determiner 1060 can use this information to designate or assign the pallet a particular organized storage location in the warehouse. The determiner 1060 can also update the storage location 1066 to the organized storage location that is selected for the pallet. Moreover, the label 1068 and/or the owner 1070 can include requirements or other specifications for storing the particular pallet. This information can also be used to select a particular organized storage location in the warehouse for the pallet.

The user device 156 can be used by a warehouse worker to review identified information about the pallet and/or to identify information about the pallet. The user device 156 can be a computing system, a computing device, a computer, laptop, tablet, smartphone, mobile phone, or other similar mobile device. Using the user device 156, the user can view information about the pallet that was identified by the computing system 152. Using the user device 156, the warehouse worker can, for example, verify information that was identified by the computing system 152. The warehouse worker can also match information identified by the computing system 152 with information stored in the pallet profile 1040A-N. The warehouse worker can identify information that was not identified by the computing system 152 (e.g., the computing system 152 missed or otherwise did not try to identify damage or box count) and/or information that could not be identified by the computing system 152 (e.g., the computing system 152 attempted but failed to identify the label of the pallet because the image data was blurry).

The user device 156 can include a pallet image data analysis interface 1072 and a communication interface 1076. The communication interface 1076 can provide for communication between any of the components described herein.

The pallet image data analysis interface 1072 can be configured to present the image data captured by the cameras 1016. The interface 1072 can also present information about the pallet that was identified by the computing system 152 and/or any information that is known about the pallet (e.g., information that is stored in pallet profiles data store 158 and/or determined by the WMS 154, the WCS 1080, and/or the cloud computing system 1082). The warehouse worker can review the image data and try to identify information about the pallet from such data. For example, the warehouse worker can provide input to the interface 1072 that includes visual observations that the warehouse worker made when manually investigating the pallet and/or from viewing the image data presented in the interface 1072.

In some implementations, the interface 1072 can include tags or flags on the image data to assist the warehouse worker in more efficiently inspecting the pallet (e.g., via manual inspection of the pallet). For example, the interface 1072 can present a flag on a blurry image of a side of the pallet where the label is located. The warehouse worker can then more quickly determine which side of the pallet to manually inspect based on the flagged image.

FIG. 10B is a conceptual diagram of a system 1099 for performing some pallet profiling techniques on the edge as well as some pallet profiling techniques remotely. As described herein, some pallet profiling techniques can be performed onsite using edge processing while other pallet profiling techniques may utilize remote cloud computing to efficiently use available compute resources in the system 1099. By efficiently using the available compute resources, the disclosed technology provides for making quick determinations about where to route pallets in a warehouse environment to optimize warehouse throughput.

For example, onsite edge computing can be used for processing image data of inbound/ingested pallets and identifying labels on the pallets and their respective cases. Performing this processing on the fly can help make necessary and quick decisions in physical and information flows in the warehouse to optimize the warehouse throughput. It is important to know whether an appropriate GS1 label (a logistic label that allows relevant users to identify logistic units uniquely so that they can be tracked and traced throughout a supply chain) is on a pallet before being able to identify, profile, and/or route the pallet in the warehouse. If the pallet does not have an appropriate GS1 label (or does now have the label at all, for example), then the disclosed technology can determine using onsite edge processing that a label should be generated, printed, and attached to the pallet before further profiling the pallet and/or moving the pallet throughout the warehouse. Other decision flows that may not require immediate determinations can be pushed to the cloud for remote processing, where processing can be scaled accordingly. The processes executed in the cloud can include, as illustrative non-limiting examples, case quantity and case detection, case catch weight determinations, damage detection, and chimney stack (e.g., gaps) identification. Sometimes, one or more of these processes can be performed onsite with edge processing when these processes may be required to determine whether to route the pallet to long-term storage and/or a manual human checking station.

Referring to the system 1099, local sensors 1092A-N and a local computing system 1093 can operate locally or otherwise on the edge in a warehouse environment 1090. A cloud-based system 1094 can be in communication with the local sensors 1092A-N and/or the local computing system 1093 via the network(s) 150 described herein. The local sensors 1092A-N can include any of the devices described herein that may be used for profiling pallets or other items that are ingested into the warehouse 1090. For example, the local sensors 1092A-N can include but are not limited to components described in FIG. 10A, including but not limited to the camera(s) 1016, turntable 1020, and/or light(s) 1026. The local sensors 1092A-N may also include additional or other imaging devices/sensors, scales, weight sensors, etc.

The local computing system 1093 can be any type of edge processing device and/or computing device, as described herein. In some implementations, the local computing system 1093 can be the computing system 152 described in reference to FIGS. 1A-C. The local computing system 1093 can also be part of the pallet profiling controller 1002 (e.g., the controller 1018), one of the user devices 156, the warehouse control system 1080, and/or the warehouse management system 154. Refer to FIG. 10A for further description about these components.

The cloud-based system 1094 can be any cloud-based computing system described herein. For example, the cloud-based system 1094 can include the cloud computing system 1082 described in FIG. 10A. Sometimes, the cloud-based system 1094 can include the computing system 152 (or a sub-component thereof), the warehouse control system 1080, and/or the warehouse management system 154. Refer to FIG. 10A for further description about these components.

As shown in FIG. 10B, the local sensors 1092A-N can locally process image data of at least one pallet to perform pallet profiling operations 1095 that may be required for pallet ingestion into long-term storage (block A, 1001). The local computing system 1093 can also locally maintain at least some of the raw image data and processing results (block B, 1003). As a result, the raw image data and/or processing results, which may be large in size, may not all be transmitted over the network(s) 150 to the cloud-based system 1094 or other systems/data stores, thereby reducing network traffic and avoiding clogging network bandwidth. Available network resources and computing/processing power can therefore be saved and used for other lighter weight processes, such as real-time profiling operations needed to determine whether the pallet(s) can be ingested into long-term storage.

The pallet profiling operations 1095 performed on the edge in block A (e.g., when the pallet is ingested into the warehouse 1090 and first imaged by the local sensors 1092A-N, such as the cameras described herein) may be a bare minimum of operations necessary to be able to route the pallet(s) to long-term storage both efficiently and safely. Such operations can include, for example and as described throughout this disclosure, determine what the pallet is (e.g., pallet identification), whether the pallet has any identifiable labels or other encoded information (e.g., label identification), and/or whether the pallet is unsafe to be routed throughout the warehouse 1090 in its current physical state/structure (e.g., pallet safety). Determining whether the pallet is safe can include one or more sub-operations, such as determining whether the pallet has damage, lean, chimney stacks (e.g., gaps), and/or requires repacking. Any of the determinations from these pallet profiling operations 1095 can be locally maintained at the local computing system 1093 and used to make pallet routing decisions in the warehouse 1090.

In some implementations, one or more determinations from the operations 1095 can be transmitted to the cloud-based system 1094 for further processing/analysis. For example, if the local computing system 1093 determines that the pallet has a label that is identifiable in block A, then this determination/processing result(s) and at least some of the raw image data can be transmitted to the cloud-based system 1094 (block C, 1005) and used by the cloud-based system 1094 to determine the encoded information from the identified label (block D, 1007). In other words, the cloud-based system 1094 can remotely process the transmitted data to perform additional pallet profiling operations 1096 (block D, 1007). As an illustrative example, the cloud-based system 1094 can read the identified label to determine case information for the pallet, such as catch weight information.

The additional profiling operations 1096 can include, but are not limited to, performing additional and/or more thorough/extensive damage analysis, catch weight identification, case quantity information, and/or chimney stack identification. One or more other pallet profiling operations that may not be necessary at the point of pallet ingestion in the warehouse 1090 may also be performed remotely by the cloud-based system 1094 using the at least some of the raw image data and/or processing results that are received from the local computing system 1093 that performs the profiling operations 1095 on the edge, in real-time. The additional profiling operations 1096 can therefore include additional processing that can be performed to determine additional information about the pallet and/or to complete a profile for the pallet. The additional profiling operations 1096 may not include operations that are necessary or required to ingest the pallet into long-term storage. By dividing the pallet profiling operations between those that are necessary and therefore should be performed in real-time on the edge and those that are nice/good to have but not necessary in real-time for pallet ingestion, compute resources, processing power, and network bandwidth can be more appropriately used/shared to improve efficiency and accuracy in profiling pallets and optimizing warehouse operations.

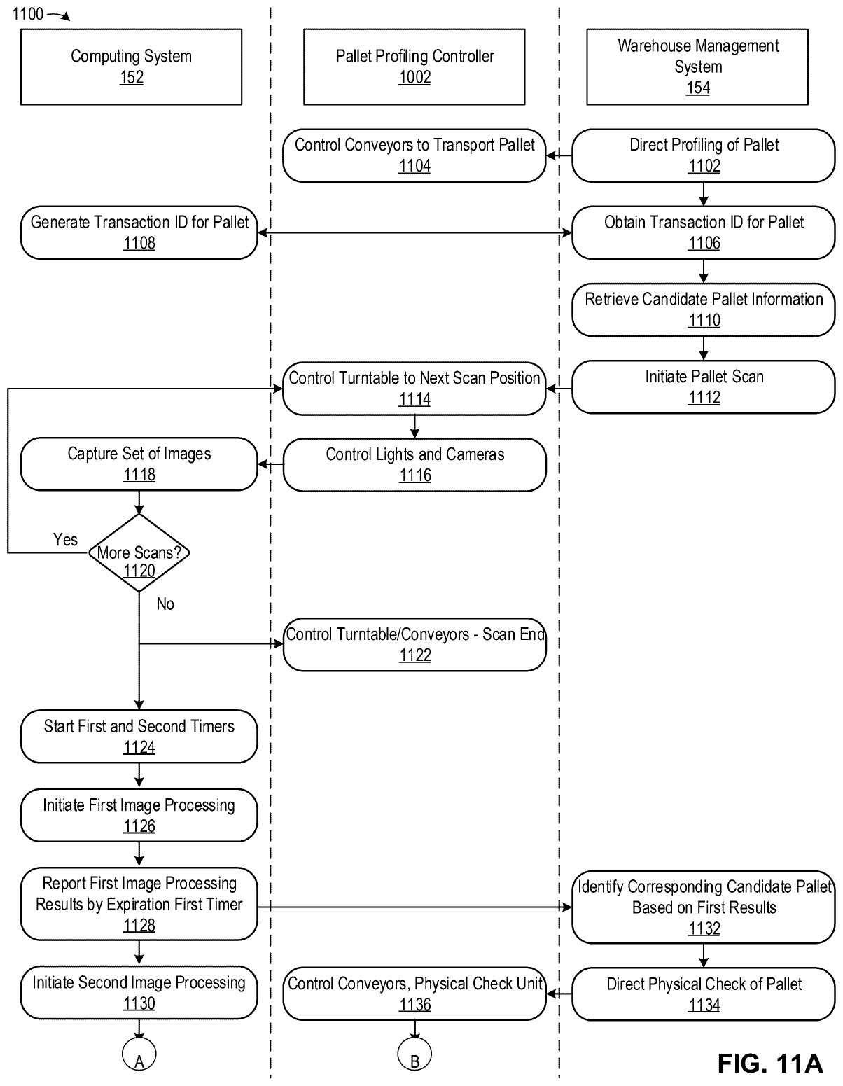

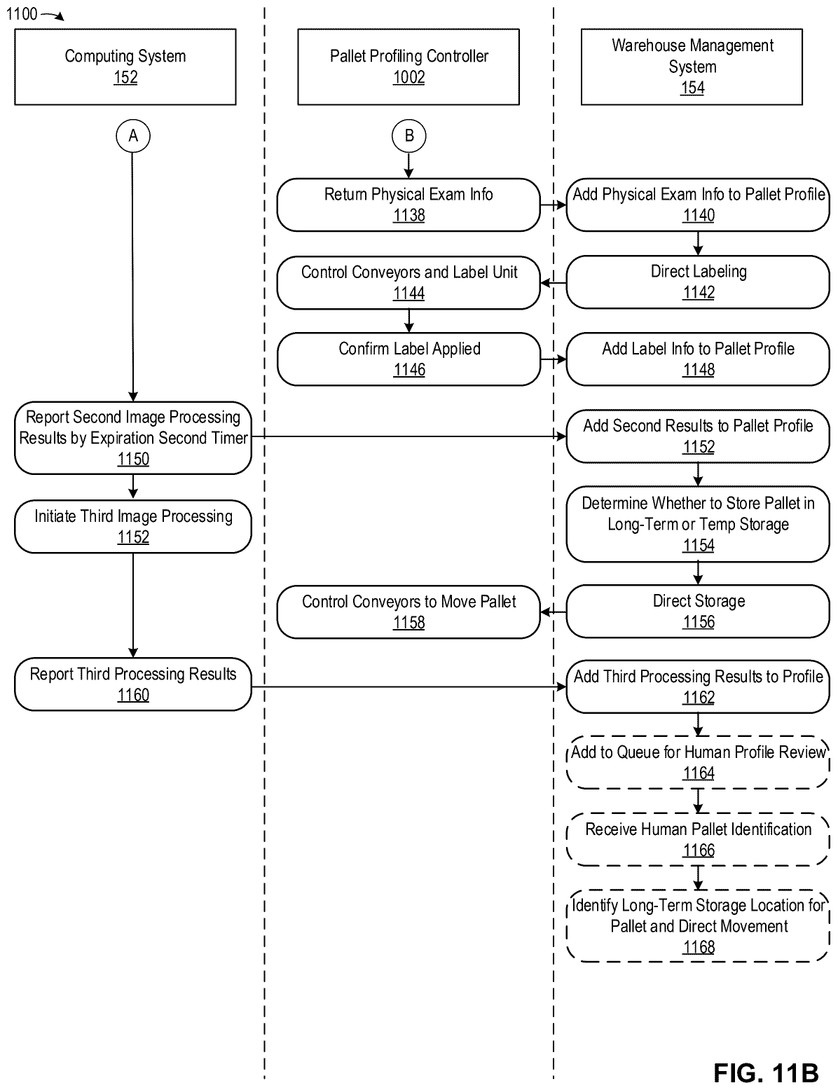

FIGS. 11A-B are swimlane diagrams of an example process 1100 for profiling a pallet. The process 1100 is described in reference to the systems described throughout this document, such as the system 100 described above with regard to FIG. 1 and the system 1000 described above with regard to FIG. 10. One or more blocks of the process 1100 can be performed by the computing system 152, the WMS 154, and pallet profiling controller(s) 1002A-N. One or more blocks of the process 1100 can be performed by other computing systems, servers, and/or computing devices, such as those described throughout this document.

Referring to FIG. 11A, the WMS 154 directs the profiling of a pallet (block 1102), such as a pallet that is received at warehouse and that has not yet been profiled. To do this, the WMS 154 can direct the pallet profiling controller 1002 to control conveyors to transport the pallet to the pallet profiler (block 1104), which can include centering pallet on the conveyors, moving the pallet onto the turntable, and centering the pallet on the turntable in preparation for performing a scan. The WMS 154 can obtain a transaction ID for the pallet (block 1106) that is generated by the computing system 152 (block 1108), which the computing system 152 can use to temporarily identify the pallet and information determined for the pallet that the WMS 154 can use to ultimately identify and profile the pallet. The WMS 154 can retrieve candidate pallet information (1110 block), such as a manifest of pallets from an inbound truck that has been unloaded at a warehouse. The information provided on a manifest for a pallet can vary significantly across different providers and carriers, ranging from simply listing the number of pallets provided at for individual labels (e.g., identifying labels, unique identifiers, SKUs, encoded information) to more detailed information with unique identifiers associated with each pallet, identification of the specific items or cases contained on the pallet (e.g., list of the number of cases of each SKU included in pallet, a caseweight of each case on the pallet), date information for the contents of the pallet (e.g., date for each case, date for lot of cases included pallet), and/or other details. The pallet profiling can attempt to pair individual pallets with preexisting information for the pallets (e.g., manifest information), to supplement or further flesh out the preexisting information (e.g., fill in unknown details, such as expiration information for cases included in pallet), and to correct any inaccurate or otherwise incorrect information included in the preexisting pallet information.

The WMS 145 can initiate a pallet scan for the pallet (block 1112), which can include directing the pallet profiling controller 1002 to initiate the scan. The pallet profiling controller 1002 can control the turntable to position and orient the pallet for the first scan (block 1114). As discussed throughout this disclosure, that may include centering the pallet on the turntable 104 and positioning it so that a first side face of the pallet is perpendicular to the orientation of the cameras 110A-D attached the vertical pole 108. Other initial orientations are also possible, such as having the first side face at some degree of rotation askew from perpendicular, such as 15°, 20°, 30°, 45°, 60°, 85°, and/or other degrees of rotation. With the pallet positioned, the controller 1002 can control operation of the lights and cameras (block 1116), such as sending coordinated and synchronous control instructions to both the lights and the cameras to initiate capturing of a first set of images. The first set of images can include, for example, multiple images of the front side of the pallet captured by the cameras 110A-D and one or more images of the top surface of the pallet captured by the overhead camera(s) 110N. The images can be captured by the cameras and received by the computing system 152 (block 1118), which can then determine whether more scans are needed (block 1120). The determination about more scans can be a static determination, which can involve progressing through a static number of pallet positions and image set captures (e.g., one set of images for each of the four sides of the pallet and one set of images for the top of the pallet). With static determinations, the determination can involve simply determining whether each of the predetermined pallet positions have been imaged (e.g., one set of images for each side, one set of images of pallet at intervals of every 45 degrees of rotation) and, if not all positions have been imaged, the next position in the progression can be directed to the controller 1002, which can then cause blocks 1114-1120 to be repeated.

In some instances, the determination (block 1120) about more scans can be dynamic, which can involve, for example, performing an initial and quick assessment of the most recently captured images to determine whether they are usable for image analysis. In the event that the images are not of at least a threshold quality along one or more image quality metrics, the computing system 152 can direct one or more modifications for reimaging that portion of the pallet, such as adjusting the lighting configurations (e.g., strobe duration, light intensity, light wavelength, position and/or angles of lights), camera settings (e.g., adjusting aperture, shutter speed, focal length, camera position), and/or pallet positions (e.g., rotating forward or backward by small increment, such as 5°, 10°, 15°, and/or other amounts). Such modifications can be transmitted to the controller 1002, which can prompt the performance of blocks 1114-1120 with the modified settings. Further modifications can be performed up until a threshold number (e.g., 2, 3, 4, or more), after which the best set of images for a portion of the pallet may be selected and the process 1100 can proceed to imaging other portions of the pallet.

Once all images of the pallet have been captured (no more scans to be performed at step 1120), the controller 1002 can be informed that the scans are complete, which can prompt the controller 1002 to control the turntable and conveyors to further move the pallet (block 1122), such as transitioning the pallet from the turntable 104 to the conveyor 106 and moving the pallet out of the photo booth 126. Once the scans are complete, the computing system 152 can also initialize first and second timers for performing particular image processing operations on the captured images that can impact the physical movement, processing, and labeling of pallet. Instead of simply performing these operations until their completion, timers can be set to require performance within a threshold amount of time to ensure that the physical handling the of pallet is not delayed by the image processing operations (i.e., physical progression of pallet is halted while waiting for image processing to be completed), which can increase the throughput of pallets through the profiler and system.

The first image progressing operation can be initiated by the computing system 152 (block 1126), which can correspond to the first timer. The first image processing operation can be a first pass through the captured images of the pallet to quickly determine whether a pallet identifier for the pallet can be detected (e.g. barcode, QR code, alphanumeric code) from the images. Such a pallet identifier can be used to identify corresponding pallet information from the preexisting pallet information. If a pallet identifier is detected (and/or a pallet identifier detected with at least a threshold level of confidence) before expiration of the first timer, the first image processing operation can end and the results (e.g., pallet identifier) can be reported to the WMS 154 (block 1128). If the first timer expires before completion of the first image processing operation, then results indicating that no pallet identifier was detected and/or one or more candidate pallet identifiers with a threshold level of confidence can be returned. The first timer can be a static value (e.g., 0.5 seconds, 1 second, 5 seconds, 10 seconds, 20 seconds, and/or others) and/or a dynamic value (e.g., time from scan being completed until pallet passes/reaches one or more physical target locations, such as fully exiting the photo booth). After completing the first image processing operation, the computing system 152 can initiate the second image processing operation (block 1130).

The WMS 154 can use the results to identify a corresponding candidate pallet from the preexisting candidate pallets (block 1132). The identifier for the candidate pallet can be used as, correlated with, and/or used to generate a unique warehouse identifier for the pallet within the warehouse, which the WMS 154 can use to track, manage, and/or process warehousing operations with regard to the pallet. The unique warehouse identifier can be associated with a variety of details about the pallet, such as the contents of the pallet (e.g., product SKUs, number of cases of each SKU, dates for each of the cases, caseweight for each of the cases, size of the pallet, weight of the pallet), which can be used to select long-term storage locations for the pallet and for selecting particular pallets to fulfill orders. If no identifier is identified and/or a candidate pallet is not identified, a new unique warehouse identifier can be generated for the pallet.

The WMS 154 can direct a physical check of the pallet (block 1134), which can be performed by, for example, one or more apparatus (that are configured to perform safety checks on the pallet (e.g., determine size, detect lean of pallet). Examples are described above with regard to 512 and 536 in FIGS. 5A-B. The controller 1002 can receive instructions from the WMS 154, and can control movement of the pallet via conveyors and/or other pallet movement components to the physical check unit (block 1136).

As described in reference to FIG. 10B, blocks such as blocks 1126-1136 can be performed on the edge by the computing system 152. On the edge, the computing system 152 may determine only pallet profiling information needed to determine whether to route the pallet to a long-term storage location or whether to route the pallet to a human checking station to be physically checked by a warehouse worker.

Referring to FIG. 11B, the controller returns the physical examination information (e.g., height, width, safety information) (block 1138) to the WMS 154, which adds the physical exam information to a profile for the pallet (block 1140). The WMS 154 directs labelling of the pallet (block 1142), and the controller 1002 can control the conveyors to move the pallet to the automatic labeler (block 1144), which can apply a label using the unique warehouse identifier for the pallet. The controller 1002 can verify that the label applied to the pallet is readable and located in one or more specific locations on the pallet (block 1146), and can return confirmation to the WMS 154 which can add the label information and confirmation to the profile for the pallet (block 1148).

At either expiration of the second timer or completion of the second image processing operation, whichever occurs first, the computing system 152 can return the results of the second image processing operation (block 1150) to the WMS 154, which can add those results to the pallet profile (block 1152). The second image processing operation can include, for example, identifying details on the contents and cases included on the pallet, such as text, markings, codes, and/or other labeling on the cases. The second image processing operations can aim to identify, specifically, what is included in the pallet, such as the specific SKUs that are contained in the pallet, the number of cases of each SKU, date information associated with each case, and/or other salient information to better understand and track the contents contained in the warehouse. The second image processing operation can process all images, or a subset of all the images, captured of the pallet for a second time, but with using differing image processing techniques, such as using OCR and/or machine learning models, and/or other text/object detection algorithms. The second timer can be a static value (e.g., 0.5 seconds, 1 second, 5 seconds, 10 seconds, 20 seconds, and/or others) that is either started at the same time as the first timer or after completion of the first operation/timer. The second timer can, alternatively, be a dynamic value (e.g., time until pallet completes labeling confirmation).

In some implementations, the second image processing operation can occur on the edge and can be used to determine information needed to route the pallet to a long-term storage location, such as whether the pallet is structurally sound to move around the warehouse as the pallet is currently packed (e.g., identifying lean, gaps, damage, and/or chimney stacks). In some implementations, the second image processing can be performed remotely at a later time and can be used to determine additional information about the pallet to fill out the profile associated with the pallet. Sometimes, one or more processes in the second image processing operation can be performed on the edge by the computing system 152 and also remotely at a later time by the WMS 154 or another cloud-computing-based system.

The WMS 154 can analyze the accumulated pallet information and determine, for any contradictory or inconsistent information (e.g., conflict between preexisting pallet information from manifest and detected pallet information), which information to keep and use for the pallet. In some instances, the detected information can be selected over preexisting information. In other instances, a conflict can result in the pallet being flagged for human review and placed into temporary storage. The WMS 154 can use the pallet information to determine whether to route the pallet into long-term storage and/or temporary storage (block 1154). Sometimes, the computing system 152 can determine where to route the pallet for storage. If the accumulated pallet information does not include sufficient details and/or confidence associated therewith to determine the contents of the pallet, it can be flagged for temporary storage. The WMS 154 can direct the storage determination (block 1156), which the controller 1002 can use to control the conveyors to route the pallet along a path to either long-term storage or temporary storage (block 1158).

After completing the second image process operation, the computing system 152 can initiate a third image processing operation (block 1152), which can perform additional processing of the images to determine and/or detect other details about the pallet that were either cut off via the timers for the first and second image processing operations, and/or performing additional/alternate image processing (e.g., processing of images using one or more machine learning models to more accurately and/or consistently detect pallet contents, performing image manipulation/modification operations to improve image quality that can then be used to reprocess the first and/or second image processing operations). The third image processing operation may not be time limited, and may be permitted to process until it reaches its conclusions. The third image processing results can be returned (block 1160) and added to the profile for the pallet (block 1162).

As described above, the third image processing operation can be performed remotely at a cloud-based computing system. Sometimes, the third image processing operation can be performed by the WMS 154. The third image processing operation may also be performed at a later time, such as while the pallet is being routed to temporary storage and/or long-term storage. As described in reference to FIG. 10B, the third image processing operation may include, but is not limited to, further damage analysis, catch weight identifications, case quantity, and/or chimney stack identifications. The third image processing operation may include any other processing operations that may be used to determine additional information about the pallet and/or the contents thereon.

In instances where the pallet is routed to temporary storage, the pallet can be added to queue for the accumulated pallet profile, including the captured images, to undergo a human review (block 1164), which can result in human identification and/or correction of the pallet information (block 1166) and can permit for a long-term storage location to be determined and used for storing the pallet (block 1168).

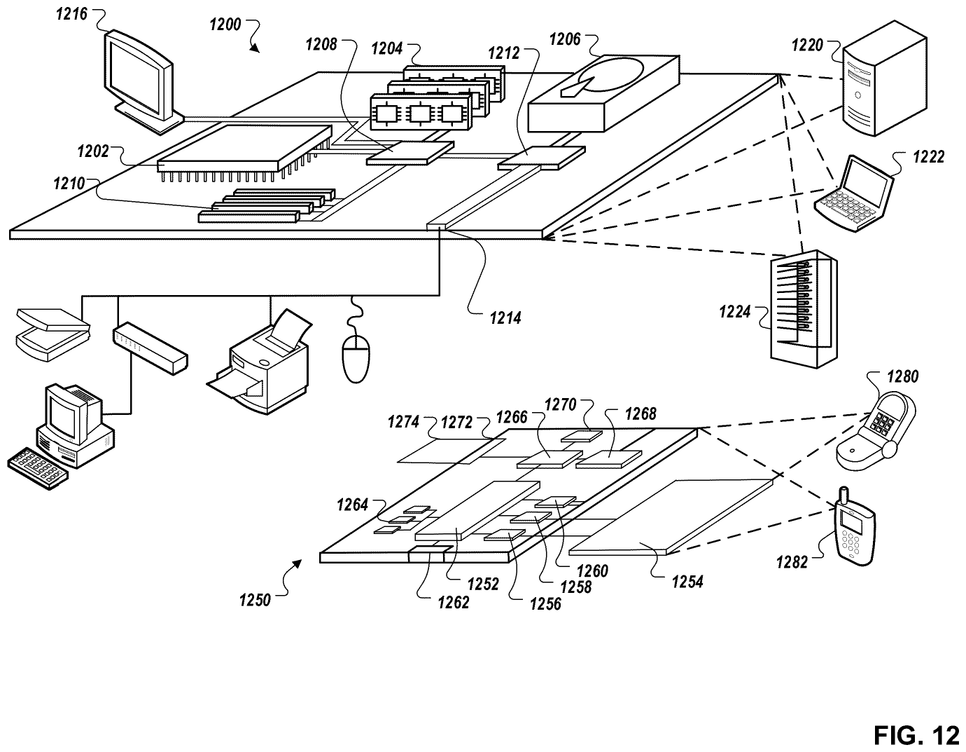

FIG. 12 is a block diagram of computing devices 1200, 1250 that may be used to implement the systems and methods described in this document, as either a client or as a server or plurality of servers. Computing device 1200 is intended to represent various forms of digital computers, such as laptops, desktops, workstations, personal digital assistants, servers, blade servers, mainframes, and other appropriate computers. Computing device 1250 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

The Computing device 1200 includes a processor 1202, memory 1204, a storage device 1206, a high-speed interface 1208 connecting to memory 1204 and high-speed expansion ports 1210, and a low speed interface 1212 connecting to low speed bus 1214 and storage device 1206. Each of the components 1202, 1204, 1206, 1208, 1210, and 1212, are interconnected using various busses, and may be mounted on a common motherboard or in other manners as appropriate. The processor 1202 can process instructions for execution within the computing device 1200, including instructions stored in the memory 1204 or on the storage device 1206 to display graphical information for a GUI on an external input/output device, such as display 1216 coupled to high speed interface 1208. In other implementations, multiple processors and/or multiple buses may be used, as appropriate, along with multiple memories and types of memory. Also, multiple computing devices 1200 may be connected, with each device providing portions of the necessary operations (e.g., as a server bank, a group of blade servers, or a multi-processor system).

The memory 1204 stores information within the computing device 1200. In one implementation, the memory 1204 is a computer-readable medium. In one implementation, the memory 1204 is a volatile memory unit or units. In another implementation, the memory 1204 is a non-volatile memory unit or units.

The storage device 1206 is capable of providing mass storage for the computing device 1200. In one implementation, the storage device 1206 is a computer-readable medium. In various different implementations, the storage device 1206 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 1204, the storage device 1206, or memory on processor 1202.

The high speed controller 1208 manages bandwidth-intensive operations for the computing device 1200, while the low speed controller 1212 manages lower bandwidth-intensive operations. Such allocation of duties is exemplary only. In one implementation, the high-speed controller 1208 is coupled to memory 1204, display 1216 (e.g., through a graphics processor or accelerator), and to high-speed expansion ports 1210, which may accept various expansion cards (not shown). In the implementation, low-speed controller 1212 is coupled to storage device 1206 and low-speed expansion port 1214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1220, or multiple times in a group of such servers. It may also be implemented as part of a rack server system 1224. In addition, it may be implemented in a personal computer such as a laptop computer 1222. Alternatively, components from computing device 1200 may be combined with other components in a mobile device (not shown), such as device 1250. Each of such devices may contain one or more of computing device 1200, 1250, and an entire system may be made up of multiple computing devices 1200, 1250 communicating with each other.

Computing device 1250 includes a processor 1252, memory 1264, an input/output device such as a display 1254, a communication interface 1266, and a transceiver 1268, among other components. The device 1250 may also be provided with a storage device, such as a microdrive or other device, to provide additional storage. Each of the components 1250, 1252, 1264, 1254, 1266, and 1268, are interconnected using various buses, and several of the components may be mounted on a common motherboard or in other manners as appropriate.

The processor 1252 can process instructions for execution within the computing device 850, including instructions stored in the memory 1264. The processor may also include separate analog and digital processors. The processor may provide, for example, for coordination of the other components of the device 1250, such as control of user interfaces, applications run by device 1250, and wireless communication by device 1250.

Processor 1252 may communicate with a user through control interface 1258 and display interface 1256 coupled to a display 1254. The display 1254 may be, for example, a TFT LCD display or an OLED display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may be provide in communication with processor 1252, so as to enable near area communication of device 1250 with other devices. External interface 1262 may provide, for example, for wired communication (e.g., via a docking procedure) or for wireless communication (e.g., via Bluetooth or other such technologies).

The memory 1264 stores information within the computing device 1250. In one implementation, the memory 1264 is a computer-readable medium. In one implementation, the memory 1264 is a volatile memory unit or units. In another implementation, the memory 1264 is a non-volatile memory unit or units. Expansion memory 12174 may also be provided and connected to device 1250 through expansion interface 1272, which may include, for example, a SIMM card interface. Such expansion memory 1274 may provide extra storage space for device 1250, or may also store applications or other information for device 1250. Specifically, expansion memory 1274 may include instructions to carry out or supplement the processes described above, and may include secure information also. Thus, for example, expansion memory 1274 may be provide as a security module for device 1250, and may be programmed with instructions that permit secure use of device 1250. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1264, expansion memory 1274, or memory on processor 1252.

Device 1250 may communicate wirelessly through communication interface 1266, which may include digital signal processing circuitry where necessary. Communication interface 1266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1268. In addition, short-range communication may occur, such as using a Bluetooth, WiFi, or other such transceiver (not shown). In addition, GPS receiver module 1270 may provide additional wireless data to device 1250, which may be used as appropriate by applications running on device 1250.

Device 1250 may also communicate audibly using audio codec 1260, which may receive spoken information from a user and convert it to usable digital information. Audio codec 1260 may likewise generate audible sound for a user, such as through a speaker, e.g., in a handset of device 1250. Such sound may include sound from voice telephone calls, may include recorded sound (e.g., voice messages, music files, etc.) and may also include sound generated by applications operating on device 1250.

The computing device 1250 may be implemented in a number of different forms, as shown in the figure. For example, it may be implemented as a cellular telephone 1280. It may also be implemented as part of a smartphone 1282, personal digital assistant, or other similar mobile device.

The disclosed technology can be used to perform various techniques described herein. For example, a system for profiling a pallet in a warehouse can include: a computing system that can be configured to identify information about a pallet, the computing system being configured to: receive, from at least one imaging device, image data of the pallet once the pallet is ingested into a warehouse, locally process a first subset of the image data to perform pallet profiling operations required for ingesting the pallet into a long-term storage location in the warehouse, generate, based at least in part on the results from the pallet profiling operations, identifying information about the pallet, and return the identifying information about the pallet. The system can also include an automation computing system that can be configured to control one or more components in the warehouse, the automation computing system being configured to: receive, from the computing system, the identifying information about the pallet, determine, based at least in part on the identifying information, whether to route the pallet to (i) the long-term storage location in the warehouse or (ii) a manual checking station in the warehouse, and based on a determination to route the pallet to the long-term storage location, return instructions to automatically route the pallet to the long-term storage location, where executing the instructions can cause at least one component in the warehouse to automatically route the pallet to the long-term storage location.

The system can optionally include one or more of the following features. For example, the pallet profiling operations can include at least one of: identifying a label on the pallet, determining whether a physical structure of the pallet satisfies safety criteria to move the pallet in the warehouse, and identifying the pallet based at least in part on the identified label. The computing system can also be configured to: locally maintain at least some of the image data and results from the pallet profiling operations, and transmit, to a remote computing system, a second subset of the image data and the results, where the remote computing system can be configured to process the second subset of the image data and the results to perform additional pallet profiling operations. The additional pallet profiling operations can include at least one of: identifying damage to the pallet or cases thereon, identifying a catch weight for each case on the pallet, determining a quantity of the cases on the pallet, and identifying gaps between one or more of the cases on the pallet. The pallet profiling operations can be performed at a first time and the additional pallet profiling operations can be performed at a second time. The second time can occur while the pallet may be automatically routed to the long-term storage location by the at least one component in the warehouse. Determining, by the automation computing system, whether to route the pallet to (i) the long-term storage location in the warehouse or (ii) the manual checking station can further be based on results from the additional pallet profiling operations.

As another example, locally processing, by the computing system, the first subset of the image data to perform pallet profiling operations required for ingesting the pallet into the long-term storage location in the warehouse can include: processing the first subset of the image data to identify, for each case on the pallet, encoded case information, determining a count indicating a number of cases on the pallet, determining whether the encoded case information, for each case, is identifiable with sufficient certainty, and responsive to determining that the encoded case information is identifiable with sufficient certainty, determining a catch weight for each case based on the encoded case information. Sometimes, locally processing, by the computing system, the first subset of the image data to perform pallet profiling operations required for ingesting the pallet into the long-term storage location in the warehouse further can include: determining a quantity of the cases having determined catch weight information and a quantity of the cases having undetermined catch weight information, determining whether the quantity of cases having determined catch weight information satisfies a threshold quantity of cases on the pallet, and returning information based on determining that the quantity of cases having determined catch weight information satisfies the threshold quantity of cases on the pallet to the automation computing system. The automated computing system can also be configured to generate instructions to route the pallet to the long-terms storage location in the warehouse based at least in part on the returned information. Sometimes, locally processing, by the computing system, the first subset of the image data to perform pallet profiling operations required for ingesting the pallet into the long-term storage location in the warehouse further can include: responsive to determining that the encoded case information is not identifiable with sufficient certainty, flagging the case for manual checking and indicating a location of the case on the pallet, and returning a notification to check the flagged case at the indicated location on the pallet to the automation computing system. The automation computing system can also be configured to generate and execute instructions to route the pallet to the manual checking station based at least in part on the notification. Sometimes, the computing system can also receive user input, from a computing device at the manual checking station based on user assessment of the pallet at the indicated location, the user input including identified catch weight information, update a profile associated with the pallet based on the user input, mark the pallet profiling operations as complete, and return instructions to the automation computing system to cause the automation computing system to route the pallet from the manual checking station to the long-term storage location in the warehouse.

In some implementations, locally processing, by the computing system, the first subset of the image data to perform pallet profiling operations required for ingesting the pallet into the long-term storage location in the warehouse can include: selecting an image from the first subset that represents a top-down view of the pallet, processing the selected image to identify each case at the top of the pallet, performing a gap detection process between one or more of the identified cases to identify at least one gap, the gap detection process including applying a model to the selected image of the top of the pallet that was trained to identify gaps between cases, determining whether the at least one gap exceeds threshold size criteria, and responsive to determining that the at least one gap exceeds the threshold size criteria, returning instructions to the automation computing system to cause the automation computing system to route the pallet to the manual checking station in the warehouse. The computing system can also, responsive to determining that a quantity of identified gaps exceeds a threshold quantity, return instructions to the automation computing system to cause the automation computing system to route the pallet to the manual checking station in the warehouse. The computing system can also, responsive to determining that the at least one gap does not exceed the threshold size criteria, return instructions to the automation computing system to cause the automation computing system to route the pallet to the long-term storage location in the warehouse.

As another example, the computing system can also apply a model to the image data of the pallet to identify at least one damaged case on the pallet, determine whether the identified at least one damaged case satisfies threshold damage criteria, and responsive to determining that the identified at least one damaged case satisfies the threshold damage criteria, return instructions to the automation computing system to cause the automation computing system to route the pallet to the manual checking station in the warehouse. The computing system can also, responsive to determining that the identified at least one damaged case does not satisfy the threshold damage criteria, return instructions to the automation computing system to cause the automation computing system to route the pallet to the long-term storage location in the warehouse. The computing system can iteratively train the model based on the identified at least one damaged case. The computing system can, before applying the model to the image data: receive sets of image data of pallets taken from different viewpoints, annotate a subset of the sets of image data with labels indicating damaged cases on the pallets, train the model to identify instances of the damaged cases on the pallets in the sets of image data from the different viewpoints using the annotated subset, and return the model for runtime use.

Sometimes, the computing system can be configured to: retrieve, from a data store, image-based models of the pallet, the image-based models having been trained using images of pallets having unique identifiers, determine, based on applying the image-based models of the pallet to the captured image data of the pallet, whether a unique identifier on the pallet is identifiable, and generate and return a notification indicating whether the unique identifier on the pallet is identifiable or unidentifiable to the automation computing system, the notification causing the automation computing system to generate instructions to route the pallet into different storage locations based on identification of the unique identifier. The automation computing system can also be configured to: instruct a first conveyor belt to automatically route the pallet onto a turntable when the pallet is ingested into the warehouse, instruct the turntable to rotate the pallet according to pallet profiling settings, and instruct the at least one imaging device to capture the image data of the pallet as the turntable rotates the pallet. The at least one imaging device can include a group of cameras mounted to a vertical profiling structure at a group of different locations, where the vertical profiling structure can be in a stationary position proximate to a side of the turntable. The image data captured by the group of cameras can provide multiple different views of the pallet from a group of different vantage points provided by the group of cameras being mounted to the vertical profiling structure at the group of different locations. The group of cameras can be arranged along a same vertical plane along the vertical profiling structure with each camera having a substantially horizontal angle.

Sometimes, the vertical profiling structure can be a pole, the vertical profiling structure can be laterally spaced apart from the first conveyor belt, the second conveyor belt, and the turntable such that the vertical profiling structure does not hang over any of the first conveyor belt, the second conveyor belt, and the turntable, and the vertical profiling structure can be positioned a working distance between 1.7 meters and 1.9 meters from the turntable. The vertical profiling structure can include at least one light source vertically aligned with and offset from each of the group of cameras. The system can also include a photo booth that can be configured to enclose an area that may include the turntable and the vertical profiling structure. The photo booth can include (i) sides and a top that can prevent ambient light from entering the enclosed area and (ii) a light source to cast light on the pallet as the pallet rotates on the turntable. Sometimes, the photo booth can include (i) a first opening on a first side of the photo booth through which the pallet can be received from the first conveyor belt onto the turntable and (ii) a second opening on a second side of the photo booth opposite the first side through which the pallet can be moved from the turntable to a second conveyor belt, the second conveyor belt being configured to automatically route the pallet to different storage locations in the warehouse.

In some implementations, the computing system can stitch together the image data of sides, top, and bottom surfaces of the pallet, and determine, based on locally processing the stitched-together image data of the pallet, a height of the pallet, damage to the pallet, lean of the pallet, contents of the pallet, number of rows on the pallet, and quantity of items on the pallet.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

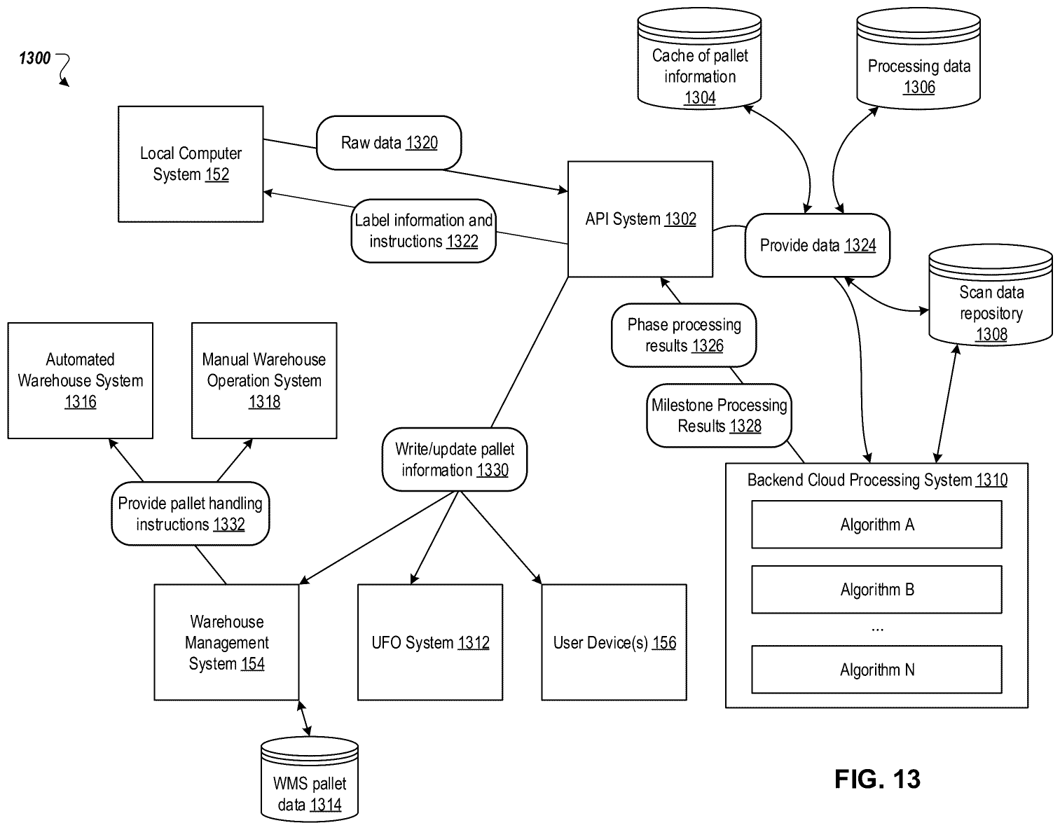

FIG. 13 is a conceptual diagram of a system 1300 for continuous, real-time processing of data for pallet identification. The system 1300 may advantageously be scalable, allowing any quantity of services to be added to the system 1300 without causing processes to slow down or turn around less accurate results. Processing data about a pallet can be distributed across components of the system 1300, which can allow for efficient and accurate processing of the data and identification of information about the pallet. The processing techniques can span across multiple CPUs and/or GPUs, thereby allowing for significantly more processing power to be allocated to real-time pallet identification techniques described herein.

The system 1300 can be used in combination with any other system components described throughout this disclosure. For example, the system 1300 can be combined with the system 100 of FIG. 1A to (i) determine information about a pallet as it is ingested into and routed throughout a facility or warehouse and (ii) determine whether enough information is identified about the pallet to route the pallet to storage or whether the pallet should be checked by a human worker before being routed to storage. The system 1300 can include the local computer system 152, the warehouse management system (WMS) 154, the user device(s) 156, an API system 1302, a UFO system 1312, a backend cloud processing system 1310, a cache of pallet information 1304, a processing data repository 1306, a scan data repository 1308, and/or a WMS pallet data repository 1314. The components of the system 1300 can communicate with each other (e.g., wired and/or wireless) via the network(s) 150 described herein. The API system 1302, the UFO system 1312, and/or the backend cloud processing system 1310 may be part of one or more of the computer systems described throughout this disclosure. The data stores 1304, 1306, 1308, and/or 1314 may be part of a same data repository and/or any of the data repositories described herein.

In brief, the API system 1302 can be configured to provide communication, processing, storage, and other operations between the local computer system 152, the backend cloud processing system 1310, the WMS 154, the UFO system 1312, and/or the user device(s) 156. The API system 1302 can be configured to provide reference information to the local computer system 152 about customers and items to be expected on pallets in one or more incoming loads. Such information can be provided to the local computer system 152 before any of the following processing techniques are performed by at least the API system 1302. The local computer system 152 can be configured to use the reference information from the API system 1302 in order to analyze the pallets once they are ingested into the facility and identify relevant information about the pallets for purposes of their identification.

The backend cloud processing system 1310 can be separate from the local computer system 152 and can be configured to execute one or more algorithms A-N to process data received about ingested pallets in real-time or near real-time. In some implementations, the backend cloud processing system 1310 can apply machine learning techniques to determine which of the algorithms A-N should be executed and/or during which phases to execute the algorithms A-N. Sometimes, the backend cloud processing system 1310 can be remote from a facility and/or warehouse. The local computer system 152 can be a computing system that is on the edge at the facility or warehouse, such as at an ingesting station in the facility where a pallet is initially received and imaged as part of identifying the pallet and information about the pallet.

The UFO system 1312 is a computer system that can be configured to determine information about pallets that may not be fully identifiable or identifiable at all during the ingestion process. The UFO system 1312 can provide instructions to relevant users (e.g., warehouse workers) in the facility to perform manual checks of the unidentifiable pallet. In some implementations, the UFO system 1312 can provide images and any information about the pallet that was identified by the local computer system 152 using the disclosed techniques to one or more of the user device(s) 156. The images and information can be provided to the user device(s) 156 with instructions indicating aspects of the pallet that the relevant user(s) should check.

As shown in the system 1300, the local computer system 152 can provide raw data to the API system 1302 (block 1320). The raw data can include images, such as high resolution images, captured by cameras in the facility as the pallet is ingested into the facility. As described herein, the images can be taken of the pallet from one or more different sides and/or angles. Sometimes, the local computer system 152 can perform initial processing of the image data before sending the image data to the API system 1302. For example, the local computer system 152 can select best images (e.g., sharpest, clearest, best angle, most information visible, visibility of barcode or other identifiers) and provide those images to the API system 1302.

In some implementations, the local computer system 152 can process the image data locally to identify a barcode on the pallet. The barcode can be identified using one or more machine learning models and techniques described herein. A value that is determined for the barcode by the local computer system 152 can then be transmitted to the API system 1302 in block 1320. The value for the barcode can be used for additional processing and analysis performed by the backend cloud processing system 1310. Sometimes, the value for the barcode can be used to retrieve relevant pallet information, such as scan data, images, or other pallet data that is stored in the processing data repository 1306 and/or the scan data repository 1308. The retrieved data can then be used, alone or in combination with the value for the barcode, in processing performed by the system 1310.

In some implementations, the local computer system 152 can process the image data using machine learning techniques to make one or more other initial determinations. Results from those determinations can then be transmitted to the API system 1302 and used by the backend cloud processing system 1310 to perform further processing and analysis. The one or more other determinations can include, but are not limited to, determining pallet count, stack gross weight, stack length, stack width, stack height, customer pallet identifier, pallet gross weight, pallet length, pallet width, pallet height, pallet net weight, pallet type, item quantity, item product code customer code, code date, item best before date, lot information, customer lot information, establishment number, item slaughter date, etc. For any one or more of these determinations, the local computer system 152 can also generate a confidence value, which may indicate likelihood that the local computer system 152 believes the determination is an accurate value for the particular pallet. As an illustrative example, a confidence value of 0 can indicate least likely that the determined value is accurate and a confidence value of 1 can indicate most likely that the determined value is accurate. The determined values and their corresponding confidence values (as well as the raw image data, in some implementations) can be transmitted to the API system 1302 (block 1320) and then used by the backend cloud processing system 1310 to perform further processing and analysis (blocks 13240-1328).

The API system 1302 can provide the raw data to the cache of pallet information 1304, the processing data repository 1306, the scan data repository 1308, and/or the backend cloud processing system 1310 (block 1324). The scan data repository 1308 can be shared with the backend cloud processing system 1310. The cache of pallet information 1304 can be configured to maintain some information about the ingested pallet, which can be easily, efficiently, and quickly retrieved for processing and identification of the pallet. Processing results that are generated by the API system 1302 and/or the backend cloud processing system 1310 can be maintained in the cache of pallet information 1304. In some implementations, the API system 1302 can perform one or more heuristics tests to identify best and/or optimal results from the processing performed by the backend cloud processing system 1310. The identified best and/or optimal results can be stored in the cache of pallet information 1304. In other words, the API system 1302 can reconcile the data and results for the ingested pallet in the cache of pallet information 1304. Such results can therefore be retrieved and used by the API system 1302 to make determinations, such as whether or not to move the pallet to storage and/or a human worker for manual review. The processing data repository 1306 can be configured to maintain the raw data from the local computer system 152 and/or data that is being or will be processed by the backend cloud processing system 1310. In some implementations, the processing data repository 1306 can be configured to maintain processing results. The scan data repository 1308 can be configured to maintain the data that is received from the local computer system 152, such as the raw data. Such data can then be retrieved by the API system 1302 and/or the backend cloud processing system 1310 for use in profiling and identifying the ingested pallet.

The API system 1302 can also transmit label information, reference information for customers associated with the ingested pallet and items on the ingested pallet, and/or instructions back to the local computer system 152 (block 1322). In some implementations, the local computer system 152 can use any of the information transmitted by the API system 1302 to retrain and/or improve its techniques for identifying information about pallets as they are ingested into the facility. The label information and/or instructions can be determined by the API system 1302 and/or by the backend cloud processing system 1310 using one or more of the algorithms A-N. The label information can be provided back to the local computer system 152 after a first phase of processing is completed. In some implementations, milestones and phases may be similar and/or the same. Sometimes, milestones and phases can line up and occur at a same time.

During each phase, one or more processing algorithms A-N may be executed to provide results. A phase can be identified as complete once the results are provided from the algorithms A-N that are executed during that phase. Any number of phases may be used for the facility, and may vary based on requirements or other information associated with the facility. As an illustrative example, two phases can be implemented in a particular facility. Another facility can implement more than two phases. One or more milestones can also be assigned to or otherwise associated with one or more the phases. In the illustrative example of executing two phases, three milestones can be designated: label, ingest, and complete, as described throughout this document. All three milestones can be completed in one of the two phases, or any combination of the milestones can be completed across the two phases (or across less or more than two phases).

Performing and completing different phases can allow the system 1300 to be extendible, thereby permitting for many different analyses to be performed and various information to be determined over time, as the pallet is ingested and moved throughout the facility. In some implementations, once a phase is complete, the API system 1302 can check results that are generated by executing the algorithms A-N and/or determinations made by the local computer system 152 to determine whether such results are appropriate values. For example, the API system 1302 can reconcile multiple results for a same identification (e.g., pallet height) and identify a most accurate result for that identification. The most accurate result can be identified as the result having a highest assigned confidence value.

In some implementations, the API system 1302 can reconcile multiple results for the same identification by checking the results against expected values for that identification. For example, if during one phase, algorithm A outputs a quantity of 5 cases for the pallet and during another phase algorithm B outputs a quantity of 10 cases for the pallet, the API system 1302 can assess the corresponding confidence values to determine which confidence value is higher. The algorithm output with the higher confidence value can be selected, stored in association with the pallet (e.g., in a pallet record created by the WMS, in cache), and used to determine additional pallet identifications and/or pallet movement instructions in the facility.

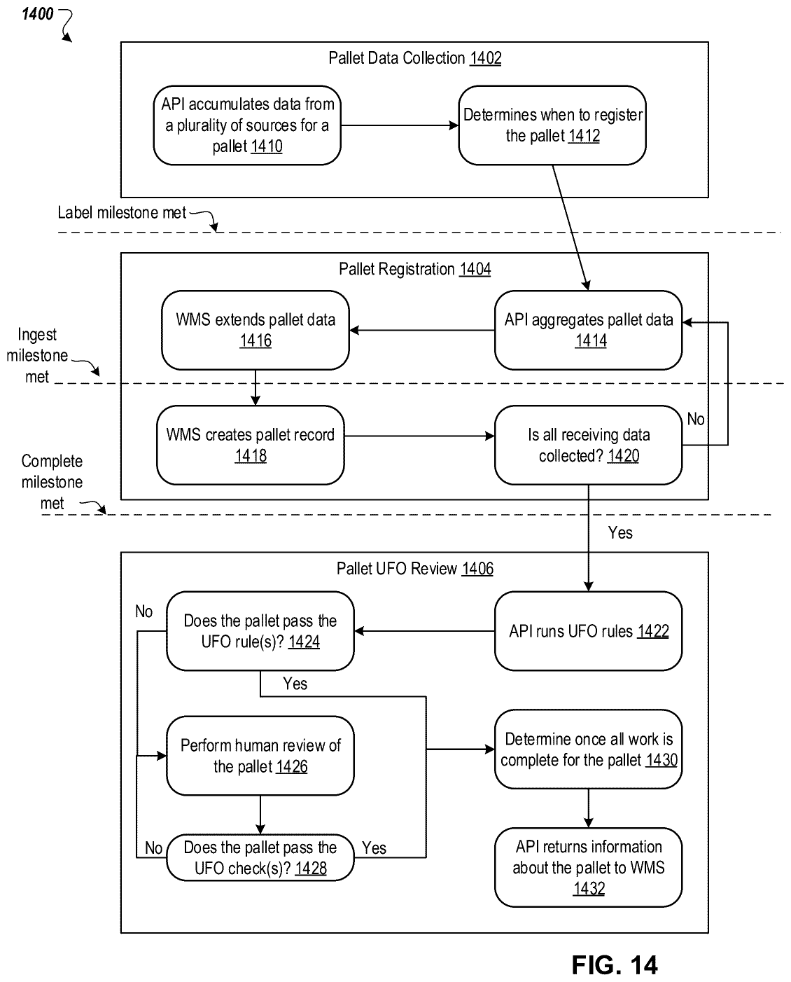

Milestones, as shown and described further in reference to FIG. 14, can indicate when enough information has been collected and/or determined about the pallet to positively perform some action. For example, a label milestone indicates that sufficient information is known/determined about the pallet to create a new label for the pallet and attach the label to the pallet. An ingest milestone indicates that enough information is known about the pallet contents to determine where to move the pallet in the facility (e.g., to storage, to a review station). A complete milestone indicates that information that is needed for the pallet is known and the pallet is or can be placed in storage in the facility—in other words, no more processing or identification of the pallet is needed. The complete milestone can also indicate that the local computer system has extracted all relevant information it can about the pallet. The API system 1302 can then analyze the extracted information to determine whether enough information was identified by the local computer system in order to identify the pallet. The API system 1302 can make this determination based on a set of rules that can be specific to the particular facility and/or customer associated with the pallet or items thereon. If the API system 1302 determines that the local computer system was unable to extract a sufficient amount of information needed to properly identify the pallet, the API system 1302 can transmit information about the pallet, including images of the pallet, to a device of a relevant user. The relevant user can then review the information presented at their device to identify and provide missing information needed to identify the pallet.

As an illustrative example of the phases and milestones, during a label phase, one or more of the algorithms A-N can be executed to determine whether the pallet has a sufficient label (e.g., information on the label can be read accurately, the label is positioned correctly on the pallet, the label is not covered by frost, wrap, or other information). Results from those algorithms A-N can be uploaded as pallet records in the WMS and/or stored in cache. Once the algorithms A-N are executed and results are returned, the label phase may be complete and a determination of whether a new label is needed can be determined and returned as part of completing a label milestone.

The data can be continuously provided, via the API system 1302, to the backend cloud processing system 1310 (block 1324). Using the data, the backend cloud processing system 1310 can perform additional processing operations to identify the pallet and/or information about the pallet that is represented in the raw data. As soon as raw data is received (block 1320), the backend cloud processing system 1310 can run any one or more processing models and/or algorithms A-N on the data. The models and/or algorithms A-N can be run concurrently and efficiently using the data received by the API system 1302 and from the local computer system 152 (e.g., the initial determination values and their confidence values, the raw image data) as the local computer system 152 is also performing initial determinations. For example, the API system 1302 can transmit multiple payloads (at the same time or at different times) to the local computer system 152, each of the payloads being provided by the local computer system 152 and containing processing determinations and their confidence values as those determinations are made. One or more processing models can be spread out and executed across the backend cloud processing system 1310.

Accordingly, the backend cloud processing system 1310 can execute one or more of the algorithms A-N. At least one of the algorithms A-N can determine and/or count cases of items on the ingested pallet. At least one of the algorithms A-N can detect damage to one or more cases of items on the ingested pallet and/or to the pallet itself. At least one of the algorithms A-N can determine type of items (e.g., products) on the pallet. Sometimes, at least one of the algorithms A-N can determine whether a label is needed for the pallet. In some implementations, the local computer system 152 can perform analytics that can be tied to a label milestone, such as identifying a customer pallet identifier. As a result of such fast, lightweight processing on the edge, pallets can keep moving on conveyor lanes in the facility, allowing for continuous and/or improve efficiencies in the facility. One or more of the backend cloud algorithms A-N may be performed only once images captured of the pallet are uploaded to the system 1310, and therefore can be linked to milestones that may not require immediate, real-time or near real-time determinations to be made in order to maintain a steady flow of activity in the facility (e.g., movement of the pallets on the conveyor lanes).

As the system 1310 processes the data and makes determinations by executing the algorithms A-N, the system 1310 can transmit phase processing results (block 1326) and/or milestone processing results (block 1328) back to the API system 1302. Sometimes phase and/or milestone processes and/or results may be the same processes and/or results.

The API system 1302 can store the phase and/or milestone processing results in one or more of the cache of pallet information 1304 and/or processing data repository 1306. Such results can be stored in association with a message received from the backend cloud processing system 1310 and that which provided the results to the API system 1302. Whenever the results are received, the results can be processed by the API system 1302 to determine whether to perform an update to information that is stored in association with the pallet by the WMS 154 in the WMS pallet data repository 1314 (refer to block 1330). The API system 1302 may determine to update the information stored by the WMS 154 in the data repository 1314 (block 1330) when the results from the backend cloud processing system 1310 contradict information stored by the WMS 154 for that pallet (e.g., the results from the backend cloud processing system 1310 have higher confidence values than information already stored by the WMS 154). As a result of making the determination before updating the information stored by the WMS 154, the API system 1302 may not overburden the WMS with write/update comments, which can improve efficiency of operations performed by the WMS 154 and use of available processing power/compute resources. Rather, the information stored by the WMS 154 may only be updated/adjusted as appropriate and/or needed.

The API system 1302 can asynchronously ingest data and/or information about the pallet while keeping track of milestones and/or phases for performing pallet identification processes as the pallet is physically moving through the facility. As a result, the system 1300 can accurately and efficiently make identification determinations about the pallet (e.g., pallet profiling) while the pallet is being moved through the facility. Sometimes, the API system 1302 can poll the backend cloud processing system 1310 for processing results at predetermined time intervals and/or continuously, while the system 1310 is processing the data about the pallet. Using processing results from the system 1310, the API system 1302 can make real-time determinations such as whether a label should be printed and, if so where to place the label on the pallet (block 1322). The API system 1302 may also poll the backend cloud processing system 1310 for indications of whether all the system processing is complete (blocks 1326 and/or 1328). Once the API system 1302 receives such an indication, the API system 1302 can make a determination of whether there is sufficient information about the pallet to send the pallet into storage or whether the pallet should be manually reviewed by a human worker in the facility. The determination made by the API system 1302 can be returned in block 1330, as described below.

The milestones can include label, ingest, and complete. Each of the milestones may be met if all operations leading up to that milestone have been completed. For example, the ingest milestone may only be met if the label milestone is first completed. Sometimes, the complete milestone may only be met if the label and the ingest milestones are completed. The label milestone indicates whether a label needs to be printed and added to the pallet or if the pallet already has a label attached thereto (block 1322). Operations to complete the label milestone can be performed while the pallet is being imaged. Once the label milestone is determined to be completed, the pallet can be moved out from an imaging station and route through the facility (e.g., to a next station). The complete milestone can indicate whether necessary and sufficient information for identifying the pallet has been collected and/or extracted (e.g., by the local computer system 152 processing images of the pallet). The ingest milestone may indicate that a decision can be made about where to put the pallet in storage, based on processing a sufficient amount of data about the pallet. Refer to FIG. 14 for further discussion about the milestones.

The API system 1302 can communicate with the WMS 154, the UFO system 1312, and/or the user device(s) 156 to write and/or update pallet information based on the processing results (block 1330). In some implementations, the API system 1302 may write and/or update pallet information to the WMS 154, the UFO system 1312, and/or the user device(s) 156 only when one or more milestones and/or phases are met. In some implementations, the UFO system 1312 can interface with the user device(s) 156. For example, the UFO system 1312 can provide some of the results and/or data from the cache of pallet information 1304 to the user device(s) 156 to be manually checked by the relevant user(s). The user can then determine whether the pallet has been appropriately identified and safe to be moved into storage. The user can provide relevant input at their user device(s) 156.

Accordingly, the WMS 154 can update data entries in the WMS pallet data repository 1314 with the pallet information received in block 1330.

The WMS 154 can also provide pallet handling instructions (block 1332) to an automated warehouse system 1316 and/or a manual warehouse operation system 1318. Such instructions can include tasks and/or operations for routing the pallet to a designated storage location in the facility. The automated warehouse system 1316 can be configured to generate schedules, operations, tasks, and/or instructions for activities to be performed by one or more autonomous vehicles in the facility (e.g., forklifts, autonomous guided vehicles, robots, cranes, drones). The manual warehouse operation system 1318 can be configured to generate schedules, operations, tasks, and/or instructions for activities to be performed by human workers in the facility. Sometimes, the system 1318 may also generate instructions for performing the activities by facility vehicles that are manually operated by the human workers and/or autonomous.

FIG. 14 is a conceptual diagram of a process 1400 for collecting and processing data to perform pallet identification. The process 1400 can be performed by system components described in reference to FIG. 13. The process 1400 can include three sub-processes: pallet data collection (block 1402), pallet registration (block 1404), and pallet UFO review (block 1406). Sometimes, the sub-processes of blocks 1402, 1404, and 1406 can be performed based on completion of milestones. For example, the pallet data collection in block 1402 may correspond to a label milestone. Checking whether all data has been collected for the pallet in block 1420 can correspond to a complete milestone. Accordingly, an affirmative response to the check in block 1420 can correspond to a complete milestone. The pallet UFO review in block 1406 can then be performed once the milestones have been met for the particular pallet.

During the pallet data collection (block 1402), the API system 1302 can accumulate data from a plurality of sources for a pallet (block 1410). A human worker at the facility can enter data about the pallet as input at their user device, which is then provided to the API system 1302. A local computer system as described herein can process image data of the pallet, extract data from those images via the processing, and provide the extracted data to the API system 1302. A WMS and/or warehouse control system of the facility can generate information about the pallet as it is imaged and/or ingested at the facility, such as pallet measurements, and provide that information to the API system 1302. Sometimes, the API system 1302 can accumulate and/or receive data from one or more data repositories described herein. The data repositories may maintain information such as item (e.g., product) information, customer requirements, facility configuration information, customer configuration information, and/or other customer load information indicating what items are included in the load, which can be sent or otherwise received from a customer computer system before the load arrives. The scope and/or accuracy of the customer load information can vary based on the customer.

During the pallet data collection (block 1402), the pallet can be removed from a truck and placed at a drop point where the pallet begins to be scanned using the techniques and components described herein (e.g., refer to FIG. 1A). For example, the pallet can be placed on a turntable, turned, and imaged during the pallet data collection in block 1402. The pallet can be held at the drop point/turntable until the label milestone is met. As described in reference to FIG. 13, the API system 1302 can generate instructions to print a label for the pallet and attach the label thereto. Once the label is printed and applied to the pallet (e.g., by an automated machine, by a human worker in the facility, by a combination thereof), the pallet can be moved to an ingestion or identification point in the facility. The ingestion or identification point can be a gateway into storage at the facility. The pallet may not be held at the ingestion or identification point, and instead can be routed towards storage, especially since the label has been printed and applied to the pallet. In some implementations, the pallet can be held at the ingestion or identification point, such as until the API system 1302 determines whether to move the pallet to storage or to a station for human review.

The API system 1302 can determine when to register the pallet (block 1412). Determining when to register the pallet can be based on applying one or more heuristics tests to the data that is accumulated for the pallet in block 1410. For example, the API system 1302 can compile results that are determined by the local computer system and identify best results amongst the compiled results. The best results can include decisions and/or identifications made by the local computer system that have a highest confidence value and/or a confidence value that exceeds some threshold level. A higher confidence value may indicate that the decision and/or identification is more likely accurate than not. The best results can then be maintained in a cache, such as the cache of pallet information 1304 described in FIG. 13. The cached best results may then be used for the pallet registration sub-process of block 1404. As another example, the API system 1302 can determine when to register the pallet based on whether one or more milestones have been met. A milestone may be met when a sufficient amount of data has been accumulated for the pallet, such as a sufficient amount of data to determine whether a label should be created, printed, and applied to the pallet.

If the API system 1302 determines that it is not yet time to register (or re-register) the pallet, the pallet data collection in block 1402 can continue to be performed (e.g., the API system 1302 can continue to accumulate pallet data in block 1410). This indicates that the API system 1302 may not have enough information about the pallet to determine whether a new label should be created, printed, and applied to the pallet.

Once the API system 1302 determines that it is time to register the pallet, a label milestone may be met and the pallet registration process (block 1404) can be performed. Thus, the API system 1302 may have sufficient information about whether the pallet requires a new label. The API system 1302 can generate the label and/or printing/application instructions. The printing instructions can be executed by another computer system, such as the WMS 154. Moreover, once the label milestone is met, information that is generated, collected, and/or identified can be provided to multiple different computing systems (e.g., the WMS 154) so that the pallet can be registered and known across the systems associated with the facility.

During the pallet registration process, the API system 1302 can aggregate pallet data for transmission to the different computing systems associated with the facility (block 1414). The API system 1302 can apply one or more heuristic tests to cull the accumulated data and identify best results for one or more fields of required information. The API system 1302 can continuously collect data about the pallet as the data is generated, collected, and/or identified as described herein. The continuously collected data may also be provided to the different computing systems associated with the facility to ensure that those systems maintain the most recent/up-to-date information about the pallet. Sometimes, the API system 1302 can continuously collect the pallet data and share amongst the different computing systems until a complete milestone is met. The complete milestone, as described herein, can indicate that all necessary data has been collected for the pallet and the API system 1302 can then decide whether the pallet has been fully identified or needs further review by the UFO system described herein (refer to block 1420).

The WMS 154 can extend the collected pallet data (block 1416). Extending the collected pallet data can include retrieving information from one or more of the data repositories described in reference to block 1410 and aggregating that data with the collected pallet data from the API system 1302. The ingest milestone can be completed during the pallet registration in block 1404, such as once blocks 1414 and 1416 are performed.

The WMS 154 can create at least one pallet record for the pallet (block 1418). The at least one pallet record can include the collected pallet data and/or data that is retrieved to extend the pallet data. The pallet record can include determinations and/or identifications that are made by the local computer system and/or the API system 1302, including but not limited to a determination of whether a label should be created, printed, and applied to the pallet at the label milestone.

The WMS 154 may determine whether all receiving data for the pallet has been collected in block 1420. Sometimes, the API system 1302 can determine in block 1420 whether information needed to properly identify the pallet has been identified/extracted by the local computer system 152. If all the receiving data has not been collected to identify the pallet, the process 1400 can return to block 1414, in which the API collects the pallet data. The blocks 1414-1418 can be repeated until it is determine that all the receiving data has been collected in block 1420. Once all the data has been collected, the complete milestone can be met and the pallet UFO review process (block 1406) can begin. As described herein, the pallet UFO review process of block 1406 can be performed once all the milestones, label, ingest, and complete, are competed.

During the pallet UFO review process (block 1406), the API system 1302 can run one or more UFO rules (block 1422). In some implementations, the rules can be asynchronously executed as the image data of the pallet is captured and processed by the local computer system. The rules can be retrieved from one or more of the data repositories described in reference to the process 1400. The rules can be used to determine whether the pallet is sufficiently identified (and/or a sufficient amount of information is identified with high confidence about the pallet) to move the pallet to storage or whether additional review of the pallet is required. The additional review may be performed by one or more human workers in the facility. For example, the human workers can review images of the pallet that have been captured since the pallet was ingested into the facility to determine whether they can determine information about the pallet from those images and/or confirm determinations/identifications that have been made by the local computer system and/or the API system 1302. The human workers can review the images in mobile applications presented in graphical user interface (GUI) displays at user computing devices. Sometimes, the human workers can manually review the physical pallet in a UFO pallet review station, then provide input at their user computing devices about their manual review. In some implementations, most UFO pallets can still go into storage since the images collected by the local computer system 152 can be sufficient for a human worker to then identify the pallet at their respective device without requiring to physically view and interact with the pallet. One or more of the UFO rules may, however, trigger a rejection of a pallet and therefore require the pallet to be physically inspected by the worker.

The API system 1302 can determine whether the pallet passes the UFO rule(s), using the pallet record (block 1424). If the rule(s) do not pass, the API system 1302 can communicate with the UFO system 1312 to provide instructions for a human review of the pallet (block 1426). One or more of the rules may not be passed if, as an illustrative example, the local computer system was unable to identify a required field from the images of the pallet for routing the pallet to storage (and/or the local computer system identified the required field but with a low level of confidence). As another example, the rule(s) may not be passed if a confidence value is low or below some threshold level for one or more determinations or identifications that were made by the API system 1302 and/or the local computer system. As yet another example, the rule(s) may not be passed if a determination made by the local computer system indicates that the pallet has not been sufficiently wrapped, the wrapping is falling off, and/or the wrapping is obscuring one or more barcodes and/or labels that are required for pallet identification. As another example, the rule(s) may not be passed if the API system 1302 determines that a customer provided information indicating an expected product type by the local computer system identified a different product type during initial imaging and processing. As another example, the rule(s) may not be passed if the API system 1302 determines that one or more determinations or identifications have a same confidence value but different values. Therefore, the human worker reviewing the pallet can be a tie breaker, and determine which value for the determination or identification is in fact accurate. In such scenarios, the human worker can be the tie breaker.

If the rule(s) pass, the API system 1302 can wait until it determines that all work regarding identification (and/or movement) of the pallet has been completed (block 1430). The rule(s) may pass if, for example, the API system 1302 determines that measured/determined values for one or more pallet features match or are within a threshold range of expected values for those features. The features may include but are not limited to weight and/or height of the pallet. The expected values can sometimes be provided by the customer. In some implementations, the expected values can be stored by the WMS and/or in one or more data repositories described herein, in association with the customer, the pallet, and/or similar types of pallets.

In some implementations, the API system 1302 can assume that all pallets are UFOs (and thus require human review) at the time of the pallet registration sub-process in block 1404 until the pallet passes the UFO rules in block 1424. Therefore, the UFO rules can be run in block 1422 to determine whether the pallet passes all the rules or a subset of the rules to be identified as not being a UFO subject to human review.

The human review can be performed in block 1426, as mentioned above. The API system 1302 can receive results from the human review and determine whether the pallet passes the UFO check(s) in block 1428. If the pallet does not pass the check(s), then block 1426 can be performed again (performing human review). If the pallet does pass the UFO check(s) in block 1428, then the API system 1302 can perform block 1430, in which the API system 1302 determines once all the work is completed for the pallet.

Once the API system 1302 determines that the work is completed, the API system 1302 can return information about the pallet to the WMS 154 (block 1432). As described in reference to FIG. 13, the WMS 154 can provide information to one or more computer systems indicating actions/tasks that can be performed by human workers in the facility regarding the pallet. The WMS 154 can also provide information to computer systems that automate actions/tasks that can be performed by machines in the facility.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

What is claimed is:

1. A system for automatically and optically determining structural integrity and catch weight information for a pallet in a facility, the system comprising:
a conveyor belt configured to route a pallet having a plurality of cases in a facility once the pallet is ingested into the facility;
a turntable configured to receive the pallet from the conveyor belt and to rotate the pallet;
at least one imaging device positioned proximate the turntable and configured to capture optical data of the pallet as the turntable rotates the pallet;
a partial enclosure configured to enclose the turntable, the at least one imaging device, and at least a portion of the conveyor belt; and
an edge computing device in network communication with the at least one imaging device, wherein the edge computing device is configured to:
receive the optical data from the at least one imaging device;
process the optical data to determine structural integrity information for the pallet;
process the optical data to determine catch weight information for each of the plurality of cases on the pallet; and
determine, based on the structural integrity information and the catch weight information, routing or storage information for the pallet.

2. The system of claim 1, wherein processing the optical data to determine structural integrity information for the pallet comprises:
selecting an image from the optical data that represents a top-down view of the pallet;
processing the selected image to identify each case at the top of the pallet;
performing a gap detection process between one or more of the identified cases to identify at least one gap, wherein the gap detection process comprises applying a model to the selected image of the top of the pallet, the model having been trained to identify gaps between cases;
determining whether the at least one gap exceeds one or more threshold size criteria; and
responsive to determining that the at least one gap exceeds the one or more threshold size criteria, generating and returning instructions to cause an automation computing system to automatically route the pallet to a profile checking station in the facility using the conveyor belt.

3. The system of claim 1, wherein processing the optical data to determine catch weight information for each of the plurality of cases on the pallet comprises:
processing the optical data to identify, for each case on the pallet, encoded case information;
determining a count indicating a number of cases on the pallet;
determining whether the encoded case information, for each case, is identifiable with sufficient certainty; and
responsive to determining that the encoded case information is identifiable with sufficient certainty, determining a catch weight for each case based on the encoded case information.

4. The system of claim 3, further comprising:
determining a quantity of the plurality of cases having determined catch weight information and a quantity of the plurality of cases having undetermined catch weight information;
determining whether the quantity of the plurality of cases having determined catch weight information satisfies a threshold quantity of cases on the pallet; and
generating and returning the routing information, based on a determination that the quantity of the plurality of cases having determined catch weight information satisfies the threshold quantity, to an automated computing system that is configured to automatically control the conveyor belt to route the pallet to a predetermined storage location in the facility.

5. The system of claim 3, further comprising:
responsive to determining that the encoded case information is not identifiable with sufficient certainty, flagging at least one case for manual checking and indicating a location of the flagged at least one case on the pallet; and
generating and returning a notification to check the flagged at least one case at the indicated location on the pallet to an automation computing system that is configured to control the conveyor belt to automatically route the pallet to a pallet checking station in the facility.

6. The system of claim 1, wherein processing the optical data to determine structural integrity information for the pallet or catch weight information for the pallet comprises:
detecting a label on the pallet,
identifying the pallet based at least in part on processing the identified label, and
determining whether a physical structure of the pallet satisfies one or more safety criteria to move the pallet in the facility using the conveyor belt.

7. The system of claim 1, wherein the edge computing device is configured to:
locally maintain a first portion of the optical data and results from processing the optical data; and
transmit, to a remote computing system in network communication with the edge computing device, a second portion of the optical data and the results,
wherein the remote computing system is configured to process the second portion of the optical data and the results to perform pallet profiling operations while the pallet is routed, on the conveyor belt, to one or more locations in the facility.

8. The system of claim 1, wherein the edge computing device is further configured to:
apply a model to the optical data of the pallet to identify at least one damaged case on the pallet;
determine whether the identified at least one damaged case satisfies one or more threshold damage criteria; and
responsive to determining that the identified at least one damaged case satisfies the one or more threshold damage criteria, generate and return instructions to an automation computing system to control the conveyor belt to automatically route the pallet to a profile checking station in the facility.

9. The system of claim 8, wherein the model was trained by a remote computing system using a process comprising:
receiving sets of image data of pallets taken from different viewpoints;
annotating a subset of the sets of image data with labels indicating damaged cases on the pallets;
training the model to identify instances of the damaged cases on the pallets in the sets of image data from the different viewpoints using the annotated subset; and
returning the model for runtime use.

10. The system of claim 1, wherein:
the optical data comprises image data of sides, top, and bottom surfaces of the pallet, and
the edge computing device is further configured to:
apply one or more machine learning trained models to the image data to stitch together the image data of the sides, the top, and the bottom surfaces of the pallet; and
determine, based on processing the stitched-together image data of the pallet, at least one of: a height of the pallet, damage to the pallet, lean of the pallet, contents of the pallet, number of rows on the pallet, and quantity of items on the pallet.

11. The system of claim 1, further comprising:
an API system in network communication with the edge computing device, wherein the API system is configured to perform operations comprising:
continuously receiving, from the edge computing device, the optical data;
providing the continuously received data to a backend cloud processing system, wherein the backend cloud processing system is configured to execute one or more algorithms using the continuously received data to generate pallet information for the pallet; and
writing the generated pallet information to one or more of a warehouse management system and a pallet review system,
wherein the warehouse management system is configured to (i) update a data record in a data store for the pallet with the generated pallet information and (ii) provide pallet handling instructions, based on the generated pallet information, to an automated warehouse system or a manual warehouse operation system,
wherein the pallet review system is configured to, based on the generated pallet information, generate and provide instructions to a user at a user device to review the optical data and determine whether the pallet can be routed to a storage location in the facility.

12. The system of claim 11, wherein the operations further comprise:
reconciling the structural integrity information, the catch weight information, and the generated pallet information using one or more heuristics to identify pallet identification information; writing the pallet identification information to a cache data store; and
providing the pallet identification information from the cache data store to the edge computing device,
wherein the edge computing device is configured to determine the routing or storage information for the pallet based on at least the pallet identification information from the cache data store.

13. The system of claim 12, wherein the API system is configured to reconcile results generated by the edge computing device and the generated pallet information during each of a plurality of phases, wherein a next phase amongst the plurality of phases is executed in response to the API system reconciling the results and the generated pallet information.

14. The system of claim 11, wherein the API system is further configured to, during a pallet data collection process:
receive the optical data, the structural integrity information, and the catch weight information from at least the edge computing device;
identify pallet identification information for the pallet based on selecting results amongst the received optical data, the structural integrity information, and the catch weight information having highest corresponding confidence values;
cache the pallet identification information for the pallet; and
iteratively perform the receiving, the identifying, and the caching until a determination that a first milestone has been met for the pallet.

15. The system of claim 14, wherein in response to a determination that the first milestone has been met for the pallet, the API system is further configured to: generate and return instructions, to the edge computing device, for generating, printing, and applying a label for the pallet.

16. The system of claim 14, wherein in response to a determination that the first milestone has been met for the pallet,
the API system is further configured to transmit the cached pallet identification information for the pallet to the warehouse management system,
the warehouse management system is further configured to (i) receive the cached pallet identification information for the pallet, (ii) extend the received information for the pallet based on aggregating the received information for the pallet with other data associated with the pallet and stored in one or more data repositories, and (iii) create the data record for the pallet in the data store with the extended information for the pallet,
wherein the transmitting, the receiving, the extending, and the creating are performed until a determination that a second milestone for the pallet has been met.

17. The system of claim 16, wherein in response to a determination that the second milestone has been met for the pallet, the API system is further configured to:
determine whether the pallet is sufficiently identifiable based on information stored in the data record for the pallet; and
based on a determination that the pallet is insufficiently identifiable, return a notification to the pallet review system to cause the pallet review system to generate instructions for the user at the user device to review at least the optical data for the pallet.

18. The system of claim 17, wherein, based on a determination that the pallet is sufficiently identifiable, the API system is configured to generate and return a notification to the edge computing device to cause the edge computing device to determine the storage information for the pallet.

19. The system of claim 1, wherein the optical data comprises a plurality of images of the pallet that are captured at predetermined deltas of degree movement of the pallet as the pallet is rotated on the turntable, wherein processing the optical data comprises:
processing each of the plurality of images to determine a confidence level for reading a unique identifier on the pallet;
selecting an image amongst the plurality of images having the highest confidence level; and
determining the structural integrity information and the catch weight information for the pallet based on processing the selected image.

20. The system of claim 19, further comprising selecting the image amongst the plurality of images having checksums that satisfy one or more checksum rules.
